(19) United States
(12) Patent Application Publication
(10) Pub. No.: US 2025/0227799 A1
(43) Pub. Date: Jul. 10, 2025

(54) Tracking Area of Mobile Base Station Relay

(71) Applicant: Ofinno, LLC, Reston, VA (US)

(72) Inventors: SungDuck Chun, Fairfax, VA (US); Kyungmin Park, Vienna, VA (US); Esmael Hejazi Dinan, McLean, VA (US); Peyman Talebi Fard, Vienna, VA (US); Jian Xu, McLean, VA (US); Stanislav Filin, Chantilly, VA (US); Weihua Qiao, Herndon, VA (US)

(73) Assignee: Ofinno, LLC, Reston, VA (US)

(21) Appl. No.: 19/095,761

(22) Filed: Mar. 31, 2025

Related U.S. Application Data
(63) Continuation of application No. PCT/US2023/033960, filed on Sep. 28, 2023.
(60) Provisional application No. 63/411,598, filed on Sep. 29, 2022.

(51) Int. Cl. H04W 76/20; H04W 64/00; H04W 92/18

(52) U.S. Cl. CPC H04W 76/20; H04W 64/00; H04W 92/18

(57) ABSTRACT

A method can include sending, by a wireless device to a first base station (BS), a message indicating that the wireless device is a mobile integrated and backhaul node (mIAB) and receiving, from the first BS, a radio resource control message comprising an identifier of a second BS. The method can further include sending, to an operations administration and management (OAM), a first message that includes an identifier of a cell associated with the identifier of the second BS, and receiving, from the OAM and based on mobility of the wireless device to the second BS, a second message comprising a second TAC associated with a location of the wireless device. Based on the second message, the wireless device can send, to the second BS, an F1 setup message comprising the second TAC and can send, to the second wireless device, a SIB comprising the second TAC.

### CROSS-REFERENCE TO RELATED APPLICATIONS

This application is a continuation of International Application No. PCT/US2023/033960, filed Sep. 28, 2023, which claims the benefit of U.S. Provisional Application No. 63/411,598, filed Sep. 29, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example communication networks including an access network and a core network.

FIG. 2A, FIG. 2B, FIG. 2C, and FIG. 2D illustrate various examples of a framework for a service-based architecture within a core network.

FIG. 3 illustrates an example communication network including core network functions.

FIG. 4A and FIG. 4B illustrate example of core network architecture with multiple user plane functions and untrusted access.

FIG. 5 illustrates an example of a core network architecture for a roaming scenario.

FIG. 6 illustrates an example of network slicing.

FIG. 7A, FIG. 7B, and FIG. 7C illustrate a user plane protocol stack, a control plane protocol stack, and services provided between protocol layers of the user plane protocol stack.

FIG. 8 illustrates an example of a quality of service model for data exchange.

FIG. 9A, FIG. 9B, FIG. 9C, and FIG. 9D illustrate example states and state transitions of a wireless device.

FIG. 10 illustrates an example of a registration procedure for a wireless device.

FIG. 11 illustrates an example of a service request procedure for a wireless device.

FIG. 12 illustrates an example of a protocol data unit session establishment procedure for a wireless device.

FIG. 13 illustrates examples of components of the elements in a communications network.

FIG. 14A, FIG. 14B, FIG. 14C, and FIG. 14D illustrate various examples of physical core network deployments, each having one or more network functions or portions thereof.

FIG. 15 illustrates the concept of wireless device tracking areas (TAs) and the possibility of different supports and/or restrictions among different TAs.

FIG. 16 illustrates an example of integrated access and backhaul (IAB).

FIG. 17 illustrates an example of a mobile base station relay (MBSR).

FIG. 18 illustrates an example of registration of an MBSR and a wireless device.

FIG. 19 illustrates an example of allocation of a tracking area identifier and/or a cell identifier in accordance with aspects of the disclosure.

FIG. 20 illustrates an example of allocation of a tracking area identifier and/or a cell identifier in accordance with aspects of the disclosure.

FIG. 21 illustrates an example of allocation of a tracking area identifier and/or a cell identifier in accordance with aspects of the disclosure.

FIG. 22 illustrates an example of allocation of a tracking area identifier and/or a cell identifier in accordance with aspects of the disclosure.

FIG. 23 illustrates an example of allocation of a tracking area identifier and/or a cell identifier in accordance with aspects of the disclosure.

FIG. 24 illustrates an example of allocation of a tracking area identifier and/or a cell identifier in accordance with aspects of the disclosure.

FIG. 25 illustrates an example of allocation of a tracking area identifier and/or a cell identifier in accordance with aspects of the disclosure.

FIG. 26 illustrates an example of allocation and/or reallocation of a tracking area identifier and/or a cell identifier, in the context of MBSR handover, in accordance with aspects of the disclosure.

FIG. 27 illustrates an example of allocation and/or reallocation of a tracking area identifier and/or a cell identifier, in the context of MBSR handover, in accordance with aspects of the disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have one or more specific capabilities. When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases refer to a single instance of a particular element, but should not be interpreted to exclude other instances of that element. For example, a bicycle with two wheels may be described as having “a wheel”. Any term that ends with the suffix “(s)” is to be interpreted as “at least one” and/or “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described.

The phrases “based on”, “in response to”, “depending on”, “employing”, “using”, and similar phrases indicate the presence and/or influence of a particular factor and/or condition on an event and/or action, but do not exclude unenumerated factors and/or conditions from also being present and/or influencing the event and/or action. For example, if action X is performed “based on” condition Y, this is to be interpreted as the action being performed “based at least on” condition Y. For example, if the performance of action X is performed when conditions Y and Z are both satisfied, then the performing of action X may be described as being “based on Y”.

The term “configured” may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, a parameter may comprise one or more information objects, and an information object may comprise one or more other objects. For example, if parameter J comprises parameter K, and parameter K comprises parameter L, and parameter L comprises parameter M, then J comprises L, and J comprises M. A parameter may be referred to as a field or information element. In an example embodiment, when one or more messages comprise a plurality of parameters, it implies that a parameter in the plurality of parameters is in at least one of the one or more messages, but does not have to be in each of the one or more messages.

This disclosure may refer to possible combinations of enumerated elements. For the sake of brevity and legibility, the present disclosure does not explicitly recite each and every permutation that may be obtained by choosing from a set of optional features. The present disclosure is to be interpreted as explicitly disclosing all such permutations. For example, the seven possible combinations of enumerated elements A, B, C consist of: (1) “A”; (2) “B”; (3) “C”; (4) “A and B”; (5) “A and C”; (6) “B and C”; and (7) “A, B, and C”. For the sake of brevity and legibility, these seven possible combinations may be described using any of the following interchangeable formulations: “at least one of A, B, and C”; “at least one of A, B, or C”; “one or more of A, B, and C”; “one or more of A, B, or C”; “A, B, and/or C”. It will be understood that impossible combinations are excluded. For example, “X and/or not-X” should be interpreted as “X or not-X”. It will be further understood that these formulations may describe alternative phrasings of overlapping and/or synonymous concepts, for example, “identifier, identification, and/or ID number”.

This disclosure may refer to sets and/or subsets. As an example, set X may be a set of elements comprising one or more elements. If every element of X is also an element of Y, then X may be referred to as a subset of Y. In this disclosure, only non-empty sets and subsets are considered. For example, if Y consists of the elements Y1, Y2, and Y3, then the possible subsets of Y are {Y1, Y2, Y3}, {Y1, Y2}, {Y1, Y3}, {Y2, Y3}, {Y1}, {Y2}, and {Y3}.

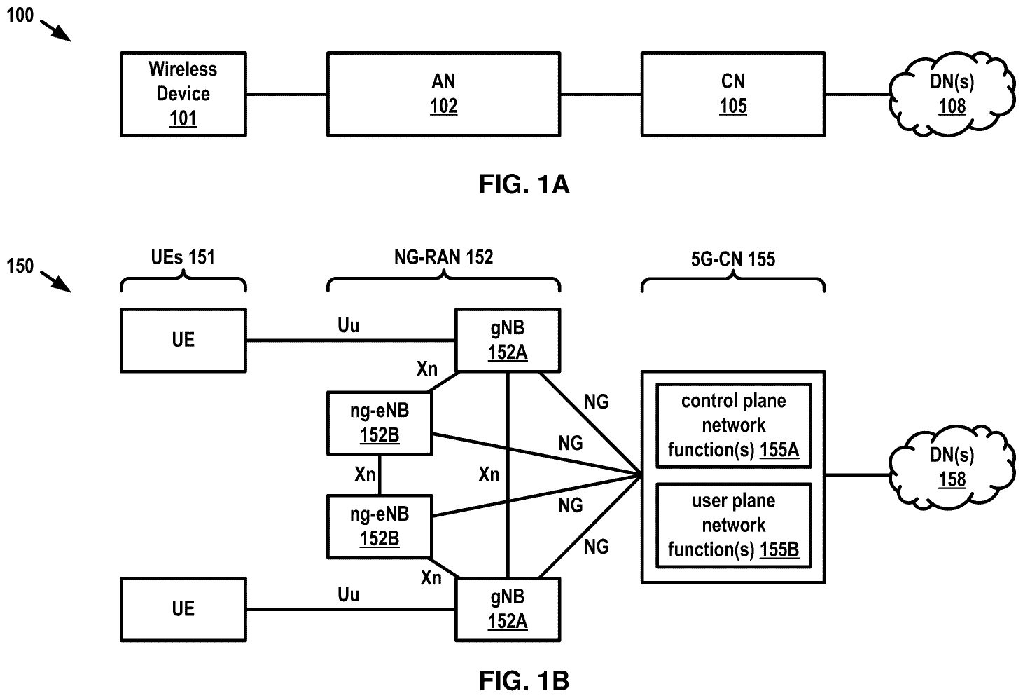

FIG. 1A illustrates an example of a communication network 100 in which embodiments of the present disclosure may be implemented. The communication network 100 may comprise, for example, a public land mobile network (PLMN) run by a network operator. As illustrated in FIG. 1A, the communication network 100 includes a wireless device 101, an access network (AN) 102, a core network (CN) 105, and one or more data network (DNs) 108.

The wireless device 101 may communicate with DNs 108 via AN 102 and CN 105. In the present disclosure, the term wireless device may refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, unmanned aerial vehicle, urban air mobility, and/or any combination thereof. The term wireless device encompasses other terminology, including user equipment (UE), user terminal (UT), access terminal (AT), mobile station, handset, wireless transmit and receive unit (WTRU), and/or wireless communication device.

The AN 102 may connect wireless device 101 to CN 105 in any suitable manner. The communication direction from the AN 102 to the wireless device 101 is known as the downlink and the communication direction from the wireless device 101 to AN 102 is known as the uplink. Downlink transmissions may be separated from uplink transmissions using frequency division duplexing (FDD), time-division duplexing (TDD), and/or some combination of the two duplexing techniques. The AN 102 may connect to wireless device 101 through radio communications over an air interface. An access network that at least partially operates over the air interface may be referred to as a radio access network (RAN). The CN 105 may set up one or more end-to-end connection between wireless device 101 and the one or more DNs 108. The CN 105 may authenticate wireless device 101 and provide charging functionality.

In the present disclosure, the term base station may refer to and encompass any element of AN 102 that facilitates communication between wireless device 101 and AN 102. Access networks and base stations have many different names and implementations. The base station may be a terrestrial base station fixed to the earth. The base station may be a mobile base station with a moving coverage area. The base station may be in space, for example, on board a satellite. For example, Wi-Fi and other standards may use the term access point. As another example, the Third-Generation Partnership Project (3GPP) has produced specifications for three generations of mobile networks, each of which uses different terminology. Third Generation (3G) and/or Universal Mobile Telecommunications System (UMTS) standards may use the term Node B. 4G, Long Term Evolution (LTE), and/or Evolved Universal Terrestrial Radio Access (E-UTRA) standards may use the term Evolved Node B (eNB). 5G and/or New Radio (NR) standards may describe AN 102 as a next-generation radio access network (NG-RAN) and may refer to base stations as Next Generation eNB (ng-eNB) and/or Generation Node B (gNB). Future standards (for example, 6G, 7G, 8G) may use new terminology to refer to the elements which implement the methods described in the present disclosure (e.g., wireless devices, base stations, ANs, CNs, and/or components thereof). A base station may be implemented as a repeater or relay node used to extend the coverage area of a donor node. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The AN 102 may include one or more base stations, each having one or more coverage areas. The geographical size and/or extent of a coverage area may be defined in terms of a range at which a receiver of AN 102 can successfully receive transmissions from a transmitter (e.g., wireless device 101) operating within the coverage area (and/or vice-versa). The coverage areas may be referred to as sectors or cells (although in some contexts, the term cell refers to the carrier frequency used in a particular coverage area, rather than the coverage area itself). Base stations with large coverage areas may be referred to as macrocell base stations. Other base stations cover smaller areas, for example, to provide coverage in areas with weak macrocell coverage, or to provide additional coverage in areas with high traffic (sometimes referred to as hotspots). Examples of small cell base stations include, in order of decreasing coverage area, microcell base stations, picocell base stations, and femtocell base stations or home base stations. Together, the coverage areas of the base stations may provide radio coverage to wireless device 101 over a wide geographic area to support wireless device mobility.

A base station may include one or more sets of antennas for communicating with the wireless device 101 over the air interface. Each set of antennas may be separately controlled by the base station. Each set of antennas may have a corresponding coverage area. As an example, a base station may include three sets of antennas to respectively control three coverage areas on three different sides of the base station. The entirety of the base station (and its corresponding antennas) may be deployed at a single location. Alternatively, a controller at a central location may control one or more sets of antennas at one or more distributed locations. The controller may be, for example, a baseband processing unit that is part of a centralized or cloud RAN architecture. The baseband processing unit may be either centralized in a pool of baseband processing units or virtualized. A set of antennas at a distributed location may be referred to as a remote radio head (RRH).

FIG. 1B illustrates another example communication network 150 in which embodiments of the present disclosure may be implemented. The communication network 150 may comprise, for example, a PLMN run by a network operator. As illustrated in FIG. 1B, communication network 150 includes UEs 151, a next generation radio access network (NG-RAN) 152, a 5G core network (5G-CN) 155, and one or more DNs 158. The NG-RAN 152 includes one or more base stations, illustrated as generation node Bs (gNBs) 152A and next generation evolved Node Bs (ng eNBs) 152B. The 5G-CN 155 includes one or more network functions (NFs), including control plane functions 155A and user plane functions 155B. The one or more DNs 158 may comprise public DNs (e.g., the Internet), private DNs, and/or intra-operator DNs. Relative to corresponding components illustrated in FIG. 1A, these components may represent specific implementations and/or terminology.

The base stations of the NG-RAN 152 may be connected to the UEs 151 via Uu interfaces. The base stations of the NG-RAN 152 may be connected to each other via Xn interfaces. The base stations of the NG-RAN 152 may be connected to 5G CN 155 via NG interfaces. The Uu interface may include an air interface. The NG and Xn interfaces may include an air interface, or may consist of direct physical connections and/or indirect connections over an underlying transport network (e.g., an internet protocol (IP) transport network).

Each of the Uu, Xn, and NG interfaces may be associated with a protocol stack. The protocol stacks may include a user plane (UP) and a control plane (CP). Generally, user plane data may include data pertaining to users of the UEs 151, for example, internet content downloaded via a web browser application, sensor data uploaded via a tracking application, or email data communicated to or from an email server. Control plane data, by contrast, may comprise signaling and messages that facilitate packaging and routing of user plane data so that it can be exchanged with the DN(s). The NG interface, for example, may be divided into an NG user plane interface (NG-U) and an NG control plane interface (NG-C). The NG-U interface may provide delivery of user plane data between the base stations and the one or more user plane network functions 155B. The NG-C interface may be used for control signaling between the base stations and the one or more control plane network functions 155A. The NG-C interface may provide, for example, NG interface management, UE context management, UE mobility management, transport of NAS messages, paging, PDU session management, and configuration transfer and/or warning message transmission. In some cases, the NG-C interface may support transmission of user data (for example, a small data transmission for an IoT device).

One or more of the base stations of the NG-RAN 152 may be split into a central unit (CU) and one or more distributed units (DUs). A CU may be coupled to one or more DUs via an F1 interface. The CU may handle one or more upper layers in the protocol stack and the DU may handle one or more lower layers in the protocol stack. For example, the CU may handle RRC, PDCP, and SDAP, and the DU may handle RLC, MAC, and PHY. The one or more DUs may be in geographically diverse locations relative to the CU and/or each other. Accordingly, the CU/DU split architecture may permit increased coverage and/or better coordination.

The gNBs 152A and ng-eNBs 152B may provide different user plane and control plane protocol termination towards the UEs 151. For example, the gNB 154A may provide new radio (NR) protocol terminations over a Uu interface associated with a first protocol stack. The ng-eNBs 152B may provide Evolved UMTS Terrestrial Radio Access (E-UTRA) protocol terminations over a Uu interface associated with a second protocol stack.

The 5G-CN 155 may authenticate UEs 151, set up end-to-end connections between UEs 151 and the one or more DNs 158, and provide charging functionality. The 5G-CN 155 may be based on a service-based architecture, in which the NFs making up the 5G-CN 155 offer services to each other and to other elements of the communication network 150 via interfaces. The 5G-CN 155 may include any number of other NFs and any number of instances of each NF.

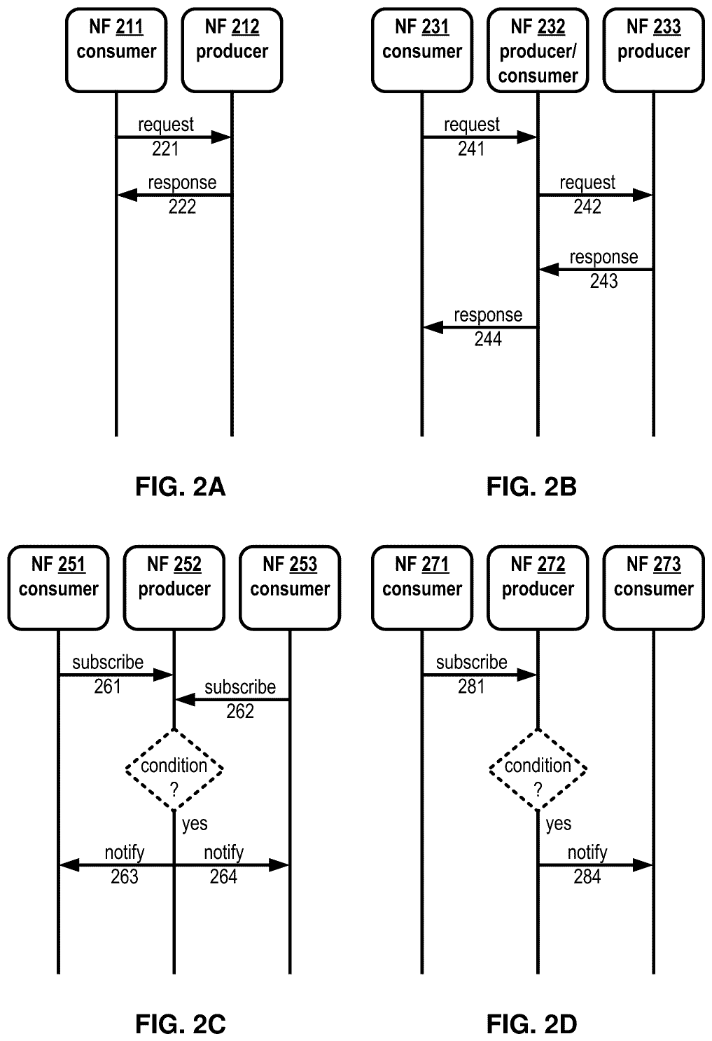

FIG. 2A, FIG. 2B, FIG. 2C, and FIG. 2D illustrate various examples of a framework for a service-based architecture within a core network. In a service-based architecture, a service may be sought by a service consumer and provided by a service producer. Prior to obtaining a particular service, an NF may determine where such a service can be obtained. To discover a service, the NF may communicate with a network repository function (NRF). As an example, an NF that provides one or more services may register with a network repository function (NRF). The NRF may store data relating to the one or more services that the NF is prepared to provide to other NFs in the service-based architecture. A consumer NF may query the NRF to discover a producer NF (for example, by obtaining from the NRF a list of NF instances that provide a particular service).

In the example of FIG. 2A, an NF 211 (a consumer NF in this example) may send a request 231 to an NF 212 (a producer NF). The request 231 may be a request for a particular service and may be sent based on a discovery that NF 212 is a producer of that service. The request 231 may comprise data relating to NF 211 and/or the requested service. The NF 212 may receive request 231, perform one or more actions associated with the requested service (e.g., retrieving data), and provide a response 231. The one or more actions performed by the NF 212 may be based on request data included in the request 231, data stored by NF 212, and/or data retrieved by NF 212. The response 232 may notify NF 211 that the one or more actions have been completed. The response 232 may comprise response data relating to NF 212, the one or more actions, and/or the requested service.

In the example of FIG. 2B, an NF 241 sends a request 221 to an NF 242. In this example, part of the service produced by NF 242 is to send a request 222 to an NF 243. The NF 243 may perform one or more actions and provide a response 223 to NF 242. Based on response 223, NF 242 may send a response 224 to NF 241. It will be understood from FIG. 2B that a single NF may perform the role of producer of services, consumer of services, or both. A particular NF service may include any number of nested NF services produced by one or more other NFs.

FIG. 2C illustrates examples of subscribe-notify interactions between a consumer NF and a producer NF. In FIG. 2C, an NF 251 sends a subscription 261 to an NF 252. An NF 253 sends a subscription 262 to the NF 252. Two NFs are shown in FIG. 2C for illustrative purposes (to demonstrate that the NF 252 may provide multiple subscription services to different NFs), but it will be understood that a subscribe-notify interaction only requires one subscriber. The NFs 251, 253 may be independent from one another. For example, the NFs 251, 253 may independently discover NF 252 and/or independently determine to subscribe to the service offered by NF 252. In response to receipt of a subscription, the NF 252 may provide a notification to the subscribing NF. For example, NF 252 may send a notification 263 to NF 251 based on subscription 261 and may send a notification 264 to NF 253 based on subscription 262.

As shown in the example illustration of FIG. 2C, the sending of the notifications 263, 264 may be based on a determination that a condition has occurred. For example, the notifications 263, 264 may be based on a determination that a particular event has occurred, a determination that a particular condition is outstanding, and/or a determination that a duration of time associated with the subscription has elapsed (for example, a period associated with a subscription for periodic notifications). As shown in the example illustration of FIG. 2C, NF 252 may send notifications 263, 264 to NFs 251, 253 simultaneously and/or in response to the same condition. However, it will be understood that the NF 252 may provide notifications at different times and/or in response to different notification conditions. In an example, the NF 251 may request a notification when a certain parameter, as measured by the NF 252, exceeds a first threshold, and the NF 252 may request a notification when the parameter exceeds a second threshold different from the first threshold. In an example, a parameter of interest and/or a corresponding threshold may be indicated in the subscriptions 261, 262.

FIG. 2D illustrates another example of a subscribe-notify interaction. In FIG. 2D, an NF 271 sends a subscription 281 to an NF 272. In response to receipt of subscription 281 and/or a determination that a notification condition has occurred, NF 272 may send a notification 284. The notification 284 may be sent to an NF 273. Unlike the example in FIG. 2C (in which a notification is sent to the subscribing NF), FIG. 2D demonstrates that a subscription and its corresponding notification may be associated with different NFs. For example, NF 271 may subscribe to the service provided by NF 272 on behalf of NF 273.

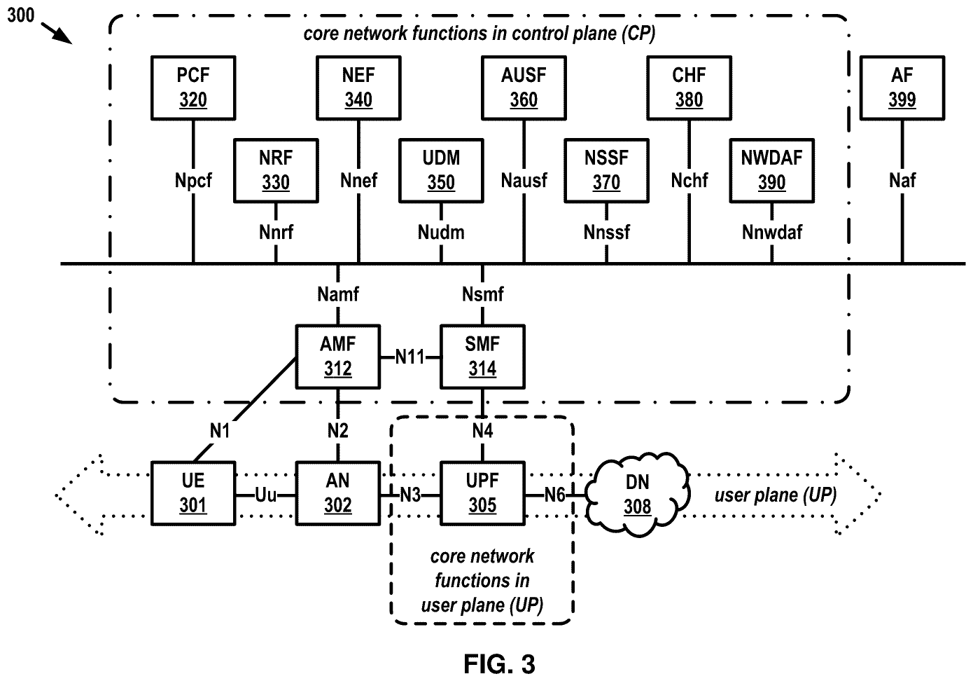

FIG. 3 illustrates another example communication network 300 in which embodiments of the present disclosure may be implemented. Communication network 300 includes a user equipment (UE) 301, an access network (AN) 302, and a data network (DN) 308. The remaining elements depicted in FIG. 3 may be included in and/or associated with a core network. Each element of the core network may be referred to as a network function (NF).

The NFs depicted in FIG. 3 include a user plane function (UPF) 305, an access and mobility management function (AMF) 312, a session management function (SMF) 314, a policy control function (PCF) 320, a network repository function (NRF) 330, a network exposure function (NEF) 340, a unified data management (UDM) 350, an authentication server function (AUSF) 360, a network slice selection function (NSSF) 370, a charging function (CHF) 380, a network data analytics function (NWDAF) 390, and an application function (AF) 399. The UPF 305 may be a user-plane core network function, whereas the NFs 312, 314, and 320-390 may be control-plane core network functions. Although not shown in the example of FIG. 3, the core network may include additional instances of any of the NFs depicted and/or one or more different NF types that provide different services. Other examples of NF type include a gateway mobile location center (GMLC), a location management function (LMF), an operations, administration, and maintenance function (OAM), a public warning system (PWS), a short message service function (SMSF), a unified data repository (UDR), and an unstructured data storage function (UDSF).

Each element depicted in FIG. 3 has an interface with at least one other element. The interface may be a logical connection rather than, for example, a direct physical connection. Any interface may be identified using a reference point representation and/or a service-based representation. In a reference point representation, the letter ‘N’ is followed by a numeral, indicating an interface between two specific elements. For example, as shown in FIG. 3, AN 302 and UPF 305 interface via N3′, whereas UPF 305 and DN 308 interface via N6′. By contrast, in a service-based representation, the letter ‘N’ is followed by letters. The letters identify an NF that provides services to the core network. For example, PCF 320 may provide services via interface ‘Npcf’. The PCF 320 may provide services to any NF in the core network via ‘Npcf’. Accordingly, a service-based representation may correspond to a bundle of reference point representations. For example, the Npcf interface between PCF 320 and the core network generally may correspond to an N7 interface between PCF 320 and SMF 314, an N30 interface between PCF 320 and NEF 340, etc.

The UPF 305 may serve as a gateway for user plane traffic between AN 302 and DN 308. The UE 301 may connect to UPF 305 via a Uu interface and an N3 interface (also described as NG-U interface). The UPF 305 may connect to DN 308 via an N6 interface. The UPF 305 may connect to one or more other UPFs (not shown) via an N9 interface. The UE 301 may be configured to receive services through a protocol data unit (PDU) session, which is a logical connection between UE 301 and DN 308. The UPF 305 (or a plurality of UPFs if desired) may be selected by SMF 314 to handle a particular PDU session between UE 301 and DN 308. The SMF 314 may control the functions of UPF 305 with respect to the PDU session. The SMF 314 may connect to UPF 305 via an N4 interface. The UPF 305 may handle any number of PDU sessions associated with any number of UEs (via any number of ANs). For purposes of handling the one or more PDU sessions, UPF 305 may be controlled by any number of SMFs via any number of corresponding N4 interfaces.

The AMF 312 depicted in FIG. 3 may control UE access to the core network. The UE 301 may register with the network via AMF 312. It may be necessary for UE 301 to register prior to establishing a PDU session. The AMF 312 may manage a registration area of UE 301, enabling the network to track the physical location of UE 301 within the network. For a UE in connected mode, AMF 312 may manage UE mobility, for example, handovers from one AN or portion thereof to another. For a UE in idle mode, AMF 312 may perform registration updates and/or page the UE to transition the UE to connected mode.

The AMF 312 may receive, from UE 301, non-access stratum (NAS) messages transmitted in accordance with NAS protocol. NAS messages relate to communications between UE 301 and the core network. Although NAS messages may be relayed to AMF 312 via AN 302, they may be described as communications via the N1 interface. NAS messages may facilitate UE registration and mobility management, for example, by authenticating, identifying, configuring, and/or managing a connection of UE 301. NAS messages may support session management procedures for maintaining user plane connectivity and quality of service (QoS) of a session between UE 301 and DN 309. If the NAS message involves session management, AMF 312 may send the NAS message to SMF 314. NAS messages may be used to transport messages between UE 301 and other components of the core network (e.g., core network components other than AMF 312 and SMF 314). The AMF 312 may act on a particular NAS message itself, or alternatively, forward the NAS message to an appropriate core network function (e.g., SMF 314, etc.)

The SMF 314 depicted in FIG. 3 may establish, modify, and/or release a PDU session based on messaging received UE 301. The SMF 314 may allocate, manage, and/or assign an IP address to UE 301, for example, upon establishment of a PDU session. There may be multiple SMFs in the network, each of which may be associated with a respective group of wireless devices, base stations, and/or UPFs. A UE with multiple PDU sessions may be associated with a different SMF for each PDU session. As noted above, SMF 314 may select one or more UPFs to handle a PDU session and may control the handling of the PDU session by the selected UPF by providing rules for packet handling (PDR, FAR, QER, etc.). Rules relating to QoS and/or charging for a particular PDU session may be obtained from PCF 320 and provided to UPF 305.

The PCF 320 may provide, to other NFs, services relating to policy rules. The PCF 320 may use subscription data and information about network conditions to determine policy rules and then provide the policy rules to a particular NF which may be responsible for enforcement of those rules. Policy rules may relate to policy control for access and mobility, and may be enforced by the AMF. Policy rules may relate to session management, and may be enforced by the SMF 314. Policy rules may be, for example, network-specific, wireless device-specific, session-specific, or data flow-specific.

The NRF 330 may provide service discovery. The NRF 330 may belong to a particular PLMN. The NRF 330 may maintain NF profiles relating to other NFs in the communication network 300. The NF profile may include, for example, an address, PLMN, and/or type of the NF, a slice identifier, a list of the one or more services provided by the NF, and the authorization required to access the services.

The NEF 340 depicted in FIG. 3 may provide an interface to external domains, permitting external domains to selectively access the control plane of the communication network 300. The external domain may comprise, for example, third-party network functions, application functions, etc. The NEF 340 may act as a proxy between external elements and network functions such as AMF 312, SMF 314, PCF 320, UDM 350, etc. As an example, NEF 340 may determine a location or reachability status of UE 301 based on reports from AMF 312, and provide status information to an external element. As an example, an external element may provide, via NEF 340, information that facilitates the setting of parameters for establishment of a PDU session. The NEF 340 may determine which data and capabilities of the control plane are exposed to the external domain. The NEF 340 may provide secure exposure that authenticates and/or authorizes an external entity to which data or capabilities of the communication network 300 are exposed. The NEF 340 may selectively control the exposure such that the internal architecture of the core network is hidden from the external domain.

The UDM 350 may provide data storage for other NFs. The UDM 350 may permit a consolidated view of network information that may be used to ensure that the most relevant information can be made available to different NFs from a single resource. The UDM 350 may store and/or retrieve information from a unified data repository (UDR). For example, UDM 350 may obtain user subscription data relating to UE 301 from the UDR.

The AUSF 360 may support mutual authentication of UE 301 by the core network and authentication of the core network by UE 301. The AUSF 360 may perform key agreement procedures and provide keying material that can be used to improve security.

The NSSF 370 may select one or more network slices to be used by the UE 301. The NSSF 370 may select a slice based on slice selection information. For example, the NSSF 370 may receive Single Network Slice Selection Assistance Information (S-NSSAI) and map the S-NSSAI to a network slice instance identifier (NSI).

The CHF 380 may control billing-related tasks associated with UE 301. For example, UPF 305 may report traffic usage associated with UE 301 to SMF 314. The SMF 314 may collect usage data from UPF 305 and one or more other UPFs. The usage data may indicate how much data is exchanged, what DN the data is exchanged with, a network slice associated with the data, or any other information that may influence billing. The SMF 314 may share the collected usage data with the CHF. The CHF may use the collected usage data to perform billing-related tasks associated with UE 301. The CHF may, depending on the billing status of UE 301, instruct SMF 314 to limit or influence access of UE 301 and/or to provide billing-related notifications to UE 301.

The NWDAF 390 may collect and analyze data from other network functions and offer data analysis services to other network functions. As an example, NWDAF 390 may collect data relating to a load level for a particular network slice instance from UPF 305, AMF 312, and/or SMF 314. Based on the collected data, NWDAF 390 may provide load level data to the PCF 320 and/or NSSF 370, and/or notify the PC220 and/or NSSF 370 if load level for a slice reaches and/or exceeds a load level threshold.

The AF 399 may be outside the core network, but may interact with the core network to provide information relating to the QoS requirements or traffic routing preferences associated with a particular application. The AF 399 may access the core network based on the exposure constraints imposed by the NEF 340. However, an operator of the core network may consider the AF 399 to be a trusted domain that can access the network directly.

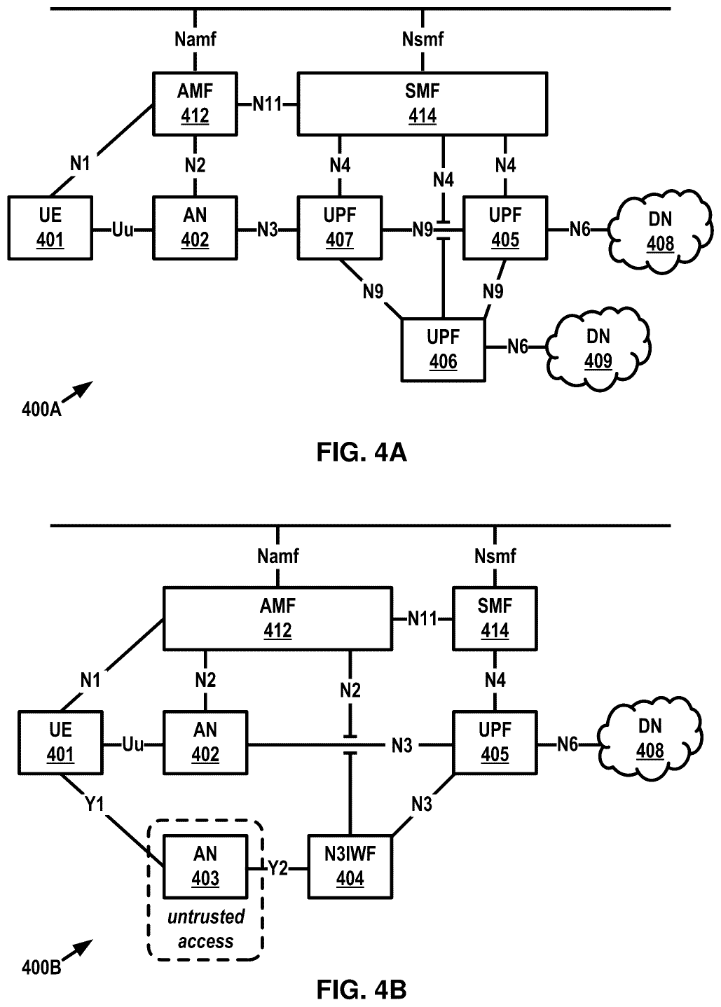

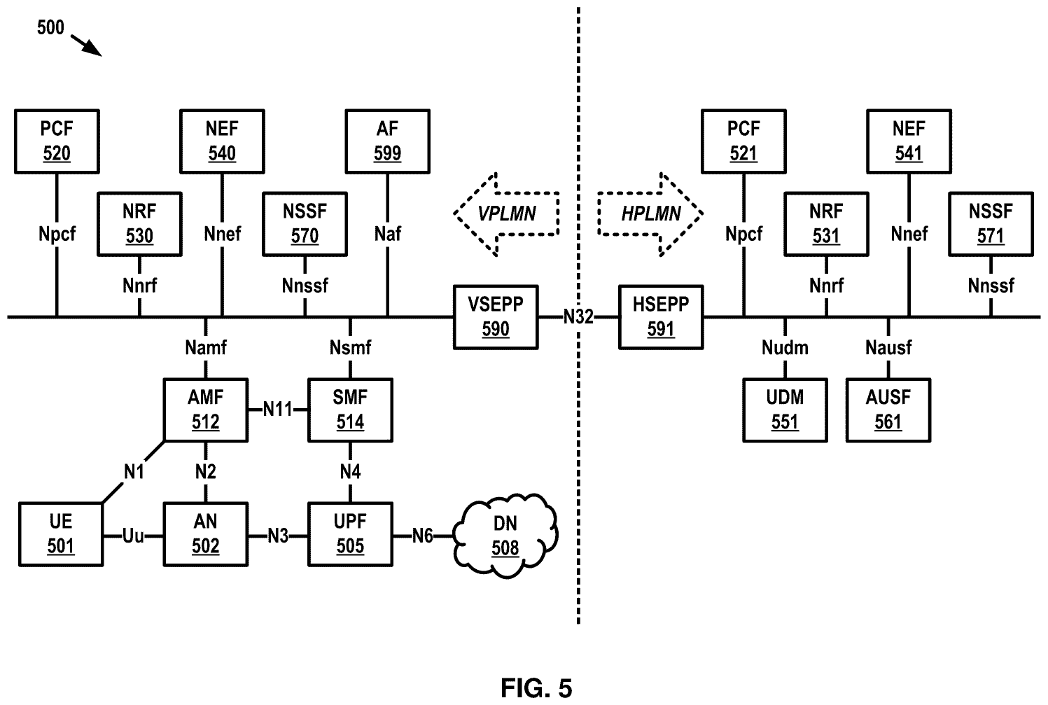

FIGS. 4A, 4B, and 5 illustrate other examples of core network architectures that are analogous in some respects to the core network architecture 300 depicted in FIG. 3. For conciseness, some of the core network elements depicted in FIG. 3 are omitted. Many of the elements depicted in FIGS. 4A, 4B, and 5 are analogous in some respects to elements depicted in FIG. 3. For conciseness, some of the details relating to their functions or operation are omitted.

FIG. 4A illustrates an example of a core network architecture 400A comprising an arrangement of multiple UPFs. Core network architecture 400A includes a UE 401, an AN 402, an AMF 412, and an SMF 414. Unlike previous examples of core network architectures described above, FIG. 4A depicts multiple UPFs, including a UPF 405, a UPF 406, and a UPF 407, and multiple DNs, including a DN 408 and a DN 409. Each of the multiple UPFs 405, 406, 407 may communicate with the SMF 414 via an N4 interface. The DNs 408, 409 communicate with the UPFs 405, 406, respectively, via N6 interfaces. As shown in FIG. 4A, the multiple UPFs 405, 406, 407 may communicate with one another via N9 interfaces.

The UPFs 405, 406, 407 may perform traffic detection, in which the UPFs identify and/or classify packets. Packet identification may be performed based on packet detection rules (PDR) provided by the SMF 414. A PDR may include packet detection information comprising one or more of: a source interface, a UE IP address, core network (CN) tunnel information (e.g., a CN address of an N3/N9 tunnel corresponding to a PDU session), a network instance identifier, a quality of service flow identifier (QFI), a filter set (for example, an IP packet filter set or an ethernet packet filter set), and/or an application identifier.

In addition to indicating how a particular packet is to be detected, a PDR may further indicate rules for handling the packet upon detection thereof. The rules may include, for example, forwarding action rules (FARs), multi-access rules (MARs), usage reporting rules (URRs), QoS enforcement rules (QERs), etc. For example, the PDR may comprise one or more FAR identifiers, MAR identifiers, URR identifiers, and/or QER identifiers. These identifiers may indicate the rules that are prescribed for the handling of a particular detected packet.

The UPF 405 may perform traffic forwarding in accordance with a FAR. For example, the FAR may indicate that a packet associated with a particular PDR is to be forwarded, duplicated, dropped, and/or buffered. The FAR may indicate a destination interface, for example, “access” for downlink or “core” for uplink. If a packet is to be buffered, the FAR may indicate a buffering action rule (BAR). As an example, UPF 405 may perform data buffering of a certain number downlink packets if a PDU session is deactivated.

The UPF 405 may perform QoS enforcement in accordance with a QER. For example, the QER may indicate a guaranteed bitrate that is authorized and/or a maximum bitrate to be enforced for a packet associated with a particular PDR. The QER may indicate that a particular guaranteed and/or maximum bitrate may be for uplink packets and/or downlink packets. The UPF 405 may mark packets belonging to a particular QoS flow with a corresponding QFI. The marking may enable a recipient of the packet to determine a QoS of the packet.

The UPF 405 may provide usage reports to the SMF 414 in accordance with a URR. The URR may indicate one or more triggering conditions for generation and reporting of the usage report, for example, immediate reporting, periodic reporting, a threshold for incoming uplink traffic, or any other suitable triggering condition. The URR may indicate a method for measuring usage of network resources, for example, data volume, duration, and/or event.

As noted above, the DNs 408, 409 may comprise public DNs (e.g., the Internet), private DNs (e.g., private, internal corporate-owned DNs), and/or intra-operator DNs. Each DN may provide an operator service and/or a third-party service. The service provided by a DN may be the Internet, an IP multimedia subsystem (IMS), an augmented or virtual reality network, an edge computing or mobile edge computing (MEC) network, etc. Each DN may be identified using a data network name (DNN). The UE 401 may be configured to establish a first logical connection with DN 408 (a first PDU session), a second logical connection with DN 409 (a second PDU session), or both simultaneously (first and second PDU sessions).

Each PDU session may be associated with at least one UPF configured to operate as a PDU session anchor (PSA, or “anchor”). The anchor may be a UPF that provides an N6 interface with a DN.

In the example of FIG. 4A, UPF 405 may be the anchor for the first PDU session between UE 401 and DN 408, whereas the UPF 406 may be the anchor for the second PDU session between UE 401 and DN 409. The core network may use the anchor to provide service continuity of a particular PDU session (for example, IP address continuity) as UE 401 moves from one access network to another. For example, suppose that UE 401 establishes a PDU session using a data path to the DN 408 using an access network other than AN 402. The data path may include UPF 405 acting as anchor. Suppose further that the UE 401 later moves into the coverage area of the AN 402. In such a scenario, SMF 414 may select a new UPF (UPF 407) to bridge the gap between the newly-entered access network (AN 402) and the anchor UPF (UPF 405). The continuity of the PDU session may be preserved as any number of UPFs are added or removed from the data path. When a UPF is added to a data path, as shown in FIG. 4A, it may be described as an intermediate UPF and/or a cascaded UPF.

As noted above, UPF 406 may be the anchor for the second PDU session between UE 401 and DN 409. Although the anchor for the first and second PDU sessions are associated with different UPFs in FIG. 4A, it will be understood that this is merely an example. It will also be understood that multiple PDU sessions with a single DN may correspond to any number of anchors. When there are multiple UPFs, a UPF at the branching point (UPF 407 in FIG. 4A) may operate as an uplink classifier (UL-CL). The UL-CL may divert uplink user plane traffic to different UPFs.

The SMF 414 may allocate, manage, and/or assign an IP address to UE 401, for example, upon establishment of a PDU session. The SMF 414 may maintain an internal pool of IP addresses to be assigned. The SMF 414 may, if necessary, assign an IP address provided by a dynamic host configuration protocol (DHCP) server or an authentication, authorization, and accounting (AAA) server. IP address management may be performed in accordance with a session and service continuity (SSC) mode. In SSC mode 1, an IP address of UE 401 may be maintained (and the same anchor UPF may be used) as the wireless device moves within the network. In SSC mode 2, the IP address of UE 401 changes as UE 401 moves within the network (e.g., the old IP address and UPF may be abandoned and a new IP address and anchor UPF may be established). In SSC mode 3, it may be possible to maintain an old IP address (similar to SSC mode 1) temporarily while establishing a new IP address (similar to SSC mode 2), thus combining features of SSC modes 1 and 2. Applications that are sensitive to IP address changes may operate in accordance with SSC mode 1.

UPF selection may be controlled by SMF 414. For example, upon establishment and/or modification of a PDU session between UE 401 and DN 408, SMF 414 may select UPF 405 as the anchor for the PDU session and/or UPF 407 as an intermediate UPF. Criteria for UPF selection include path efficiency and/or speed between AN 402 and DN 408. The reliability, load status, location, slice support and/or other capabilities of candidate UPFs may also be considered.

FIG. 4B illustrates an example of a core network architecture 400B that accommodates untrusted access. Similar to FIG. 4A, UE 401 as depicted in FIG. 4B connects to DN 408 via AN 402 and UPF 405. The AN 402 and UPF 405 constitute trusted (e.g., 3GPP) access to the DN 408. By contrast, UE 401 may also access DN 408 using an untrusted access network, AN 403, and a non-3GPP interworking function (N3IWF) 404.

The AN 403 may be, for example, a wireless land area network (WLAN) operating in accordance with the IEEE 802.11 standard. The UE 401 may connect to AN 403, via an interface Y1, in whatever manner is prescribed for AN 403. The connection to AN 403 may or may not involve authentication. The UE 401 may obtain an IP address from AN 403. The UE 401 may determine to connect to core network 400B and select untrusted access for that purpose. The AN 403 may communicate with N3IWF 404 via a Y2 interface. After selecting untrusted access, the UE 401 may provide N3IWF 404 with sufficient information to select an AMF. The selected AMF may be, for example, the same AMF that is used by UE 401 for 3GPP access (AMF 412 in the present example). The N3IWF 404 may communicate with AMF 412 via an N2 interface. The UPF 405 may be selected and N3IWF 404 may communicate with UPF 405 via an N3 interface. The UPF 405 may be a PDU session anchor (PSA) and may remain the anchor for the PDU session even as UE 401 shifts between trusted access and untrusted access.

FIG. 5 illustrates an example of a core network architecture 500 in which a UE 501 is in a roaming scenario. In a roaming scenario, UE 501 is a subscriber of a first PLMN (a home PLMN, or HPLMN) but attaches to a second PLMN (a visited PLMN, or VPLMN). Core network architecture 500 includes UE 501, an AN 502, a UPF 505, and a DN 508. The AN 502 and UPF 505 may be associated with a VPLMN. The VPLMN may manage the AN 502 and UPF 505 using core network elements associated with the VPLMN, including an AMF 512, an SMF 514, a PCF 520, an NRF 530, an NEF 540, and an NSSF 570. An AF 599 may be adjacent the core network of the VPLMN.

The UE 501 may not be a subscriber of the VPLMN. The AMF 512 may authorize UE 501 to access the network based on, for example, roaming restrictions that apply to UE 501. In order to obtain network services provided by the VPLMN, it may be necessary for the core network of the VPLMN to interact with core network elements of a HPLMN of UE 501, in particular, a PCF 521, an NRF 531, an NEF 541, a UDM 551, and/or an AUSF 561. The VPLMN and HPLMN may communicate using an N32 interface connecting respective security edge protection proxies (SEPPs). In FIG. 5, the respective SEPPs are depicted as a VSEPP 590 and an HSEPP 591.

The VSEPP 590 and the HSEPP 591 communicate via an N32 interface for defined purposes while concealing information about each PLMN from the other. The SEPPs may apply roaming policies based on communications via the N32 interface. The PCF 520 and PCF 521 may communicate via the SEPPs to exchange policy-related signaling. The NRF 530 and NRF 531 may communicate via the SEPPs to enable service discovery of NFs in the respective PLMNs. The VPLMN and HPLMN may independently maintain NEF 540 and NEF 541. The NSSF 570 and NSSF 571 may communicate via the SEPPs to coordinate slice selection for UE 501. The HPLMN may handle all authentication and subscription related signaling. For example, when the UE 501 registers or requests service via the VPLMN, the VPLMN may authenticate UE 501 and/or obtain subscription data of UE 501 by accessing, via the SEPPs, the UDM 551 and AUSF 561 of the HPLMN.

The core network architecture 500 depicted in FIG. 5 may be referred to as a local breakout configuration, in which UE 501 accesses DN 508 using one or more UPFs of the VPLMN (i.e., UPF 505). However, other configurations are possible. For example, in a home-routed configuration (not shown in FIG. 5), UE 501 may access a DN using one or more UPFs of the HPLMN. In the home-routed configuration, an N9 interface may run parallel to the N32 interface, crossing the frontier between the VPLMN and the HPLMN to carry user plane data. One or more SMFs of the respective PLMNs may communicate via the N32 interface to coordinate session management for UE 501. The SMFs may control their respective UPFs on either side of the frontier.

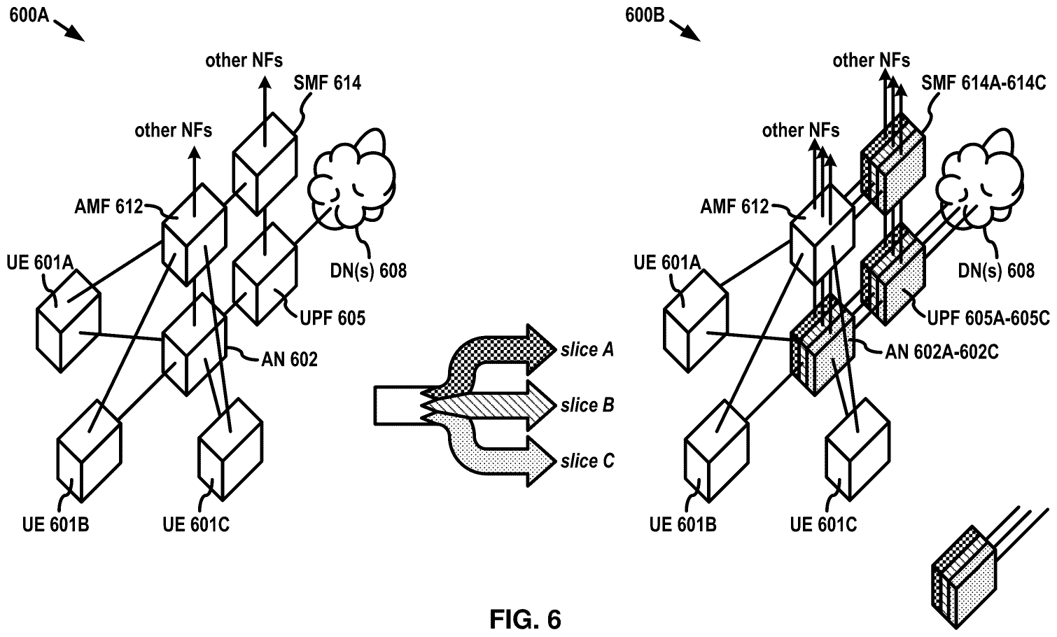

FIG. 6 illustrates an example of network slicing. Network slicing may refer to division of shared infrastructure (e.g., physical infrastructure) into distinct logical networks. These distinct logical networks may be independently controlled, isolated from one another, and/or associated with dedicated resources.

Network architecture 600A illustrates an un-sliced physical network corresponding to a single logical network. The network architecture 600A comprises a user plane wherein UEs 601A, 601B, 601C (collectively, UEs 601) have a physical and logical connection to a DN 608 via an AN 602 and a UPF 605. The network architecture 600A comprises a control plane wherein an AMF 612 and a SMF 614 control various aspects of the user plane.

The network architecture 600A may have a specific set of characteristics (e.g., relating to maximum bit rate, reliability, latency, bandwidth usage, power consumption, etc.). This set of characteristics may be affected by the nature of the network elements themselves (e.g., processing power, availability of free memory, proximity to other network elements, etc.) or the management thereof (e.g., optimized to maximize bit rate or reliability, reduce latency or power bandwidth usage, etc.). The characteristics of network architecture 600A may change over time, for example, by upgrading equipment or by modifying procedures to target a particular characteristic. However, at any given time, network architecture 600A will have a single set of characteristics that may or may not be optimized for a particular use case. For example, UEs 601A, 601B, 601C may have different requirements, but network architecture 600A can only be optimized for one of the three.

Network architecture 600B is an example of a sliced physical network divided into multiple logical networks. In FIG. 6, the physical network is divided into three logical networks, referred to as slice A, slice B, and slice C. For example, UE 601A may be served by AN 602A, UPF 605A, AMF 612, and SMF 614A. UE 601B may be served by AN 602B, UPF 605B, AMF 612, and SMF 614B. UE 601C may be served by AN 602C, UPF 605C, AMF 612, and SMF 614C. Although the respective UEs 601 communicate with different network elements from a logical perspective, these network elements may be deployed by a network operator using the same physical network elements.

Each network slice may be tailored to network services having different sets of characteristics. For example, slice A may correspond to enhanced mobile broadband (eMBB) service. Mobile broadband may refer to internet access by mobile users, commonly associated with smartphones. Slice B may correspond to ultra-reliable low-latency communication (URLLC), which focuses on reliability and speed. Relative to eMBB, URLLC may improve the feasibility of use cases such as autonomous driving and telesurgery. Slice C may correspond to massive machine type communication (mMTC), which focuses on low-power services delivered to a large number of users. For example, slice C may be optimized for a dense network of battery-powered sensors that provide small amounts of data at regular intervals. Many mMTC use cases would be prohibitively expensive if they operated using an eMBB or URLLC network.

If the service requirements for one of the UEs 601 changes, then the network slice serving that UE can be updated to provide better service. Moreover, the set of network characteristics corresponding to eMBB, URLLC, and mMTC may be varied, such that differentiated species of eMBB, URLLC, and mMTC are provided. Alternatively, network operators may provide entirely new services in response to, for example, customer demand.

In FIG. 6, each of the UEs 601 has its own network slice. However, it will be understood that a single slice may serve any number of UEs and a single UE may operate using any number of slices. Moreover, in the example network architecture 600B, the AN 602, UPF 605 and SMF 614 are separated into three separate slices, whereas the AMF 612 is unsliced. However, it will be understood that a network operator may deploy any architecture that selectively utilizes any mix of sliced and unsliced network elements, with different network elements divided into different numbers of slices. Although FIG. 6 only depicts three core network functions, it will be understood that other core network functions may be sliced as well. A PLMN that supports multiple network slices may maintain a separate network repository function (NFR) for each slice, enabling other NFs to discover network services associated with that slice.

Network slice selection may be controlled by an AMF, or alternatively, by a separate network slice selection function (NSSF). For example, a network operator may define and implement distinct network slice instances (NSIs). Each NSI may be associated with single network slice selection assistance information (S-NSSAI). The S-NSSAI may include a particular slice/service type (SST) indicator (indicating eMBB, URLLC, mMTC, etc.). As an example, a particular tracking area may be associated with one or more configured S-NSSAIs. UEs may identify one or more requested and/or subscribed S-NSSAIs (e.g., during registration). The network may indicate to the UE one or more allowed and/or rejected S-NSSAIs.

The S-NSSAI may further include a slice differentiator (SD) to distinguish between different tenants of a particular slice and/or service type. For example, a tenant may be a customer (e.g., vehicle manufacturer, service provider, etc.) of a network operator that obtains (for example, purchases) guaranteed network resources and/or specific policies for handling its subscribers. The network operator may configure different slices and/or slice types, and use the SD to determine which tenant is associated with a particular slice.

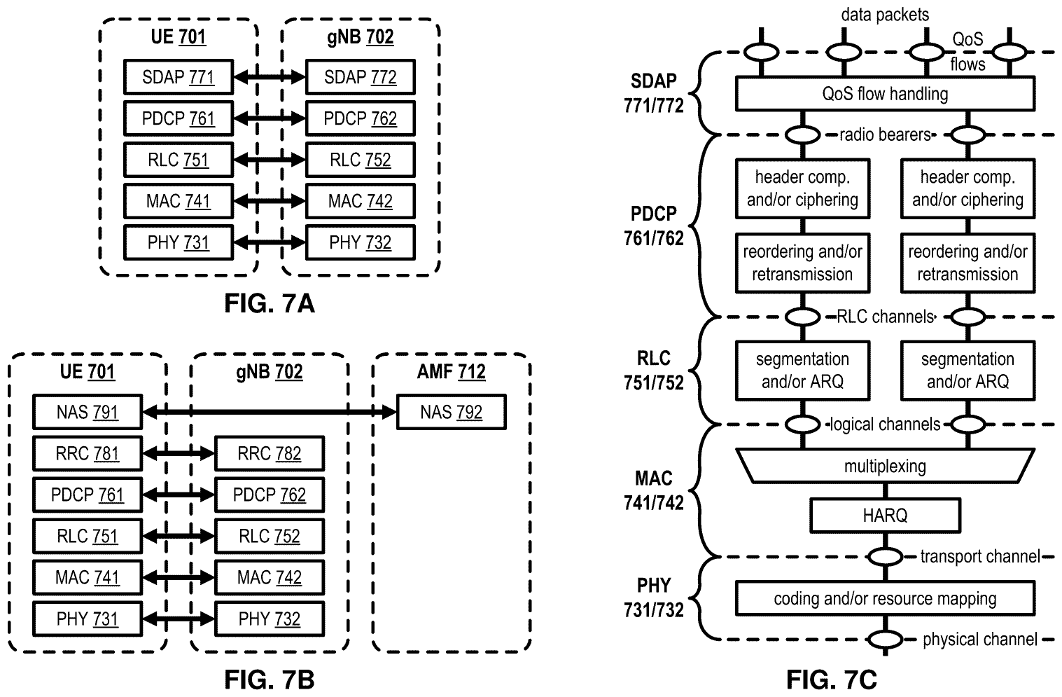

FIG. 7A, FIG. 7B, and FIG. 7C illustrate a user plane (UP) protocol stack, a control plane (CP) protocol stack, and services provided between protocol layers of the UP protocol stack.

The layers may be associated with an open system interconnection (OSI) model of computer networking functionality. In the OSI model, layer 1 may correspond to the bottom layer, with higher layers on top of the bottom layer. Layer 1 may correspond to a physical layer, which is concerned with the physical infrastructure used for transfer of signals (for example, cables, fiber optics, and/or radio frequency transceivers). In New Radio (NR), layer 1 may comprise a physical layer (PHY). Layer 2 may correspond to a data link layer. Layer 2 may be concerned with packaging of data (into, e.g., data frames) for transfer, between nodes of the network, using the physical infrastructure of layer 1. In NR, layer 2 may comprise a media access control layer (MAC), a radio link control layer (RLC), a packet data convergence layer (PDCP), and a service data application protocol layer (SDAP).

Layer 3 may correspond to a network layer. Layer 3 may be concerned with routing of the data which has been packaged in layer 2. Layer 3 may handle prioritization of data and traffic avoidance. In NR, layer 3 may comprise a radio resource control layer (RRC) and a non-access stratum layer (NAS). Layers 4 through 7 may correspond to a transport layer, a session layer, a presentation layer, and an application layer. The application layer interacts with an end user to provide data associated with an application. In an example, an end user implementing the application may generate data associated with the application and initiate sending of that information to a targeted data network (e.g., the Internet, an application server, etc.). Starting at the application layer, each layer in the OSI model may manipulate and/or repackage the information and deliver it to a lower layer. At the lowest layer, the manipulated and/or repackaged information may be exchanged via physical infrastructure (for example, electrically, optically, and/or electromagnetically). As it approaches the targeted data network, the information will be unpackaged and provided to higher and higher layers, until it once again reaches the application layer in a form that is usable by the targeted data network (e.g., the same form in which it was provided by the end user). To respond to the end user, the data network may perform this procedure in reverse.

FIG. 7A illustrates a user plane protocol stack. The user plane protocol stack may be a new radio (NR) protocol stack for a Uu interface between a UE 701 and a gNB 702. In layer 1 of the UP protocol stack, the UE 701 may implement PHY 731 and the gNB 702 may implement PHY 732. In layer 2 of the UP protocol stack, the UE 701 may implement MAC 741, RLC 751, PDCP 761, and SDAP 771. The gNB 702 may implement MAC 742, RLC 752, PDCP 762, and SDAP 772.

FIG. 7B illustrates a control plane protocol stack. The control plane protocol stack may be an NR protocol stack for the Uu interface between the UE 701 and the gNB 702 and/or an N1 interface between the UE 701 and an AMF 712. In layer 1 of the CP protocol stack, the UE 701 may implement PHY 731 and the gNB 702 may implement PHY 732. In layer 2 of the CP protocol stack, the UE 701 may implement MAC 741, RLC 751, PDCP 761, RRC 781, and NAS 791. The gNB 702 may implement MAC 742, RLC 752, PDCP 762, and RRC 782. The AMF 712 may implement NAS 792.

The NAS may be concerned with the non-access stratum, in particular, communication between the UE 701 and the core network (e.g., the AMF 712). Lower layers may be concerned with the access stratum, for example, communication between the UE 701 and the gNB 702. Messages sent between the UE 701 and the core network may be referred to as NAS messages. In an example, a NAS message may be relayed by the gNB 702, but the content of the NAS message (e.g., information elements of the NAS message) may not be visible to the gNB 702.

FIG. 7C illustrates an example of services provided between protocol layers of the NR user plane protocol stack illustrated in FIG. 7A. The UE 701 may receive services through a PDU session, which may be a logical connection between the UE 701 and a data network (DN). The UE 701 and the DN may exchange data packets associated with the PDU session. The PDU session may comprise one or more quality of service (QoS) flows. SDAP 771 and SDAP 772 may perform mapping and/or demapping between the one or more QoS flows of the PDU session and one or more radio bearers (e.g., data radio bearers). The mapping between the QoS flows and the data radio bearers may be determined in the SDAP 772 by the gNB 702, and the UE 701 may be notified of the mapping (e.g., based on control signaling and/or reflective mapping). For reflective mapping, the SDAP 772 of the gNB 230 may mark downlink packets with a QoS flow indicator (QFI) and deliver the downlink packets to the UE 701. The UE 701 may determine the mapping based on the QFI of the downlink packets.

PDCP 761 and PDCP 762 may perform header compression and/or decompression. Header compression may reduce the amount of data transmitted over the physical layer. The PDCP 761 and PDCP 762 may perform ciphering and/or deciphering. Ciphering may reduce unauthorized decoding of data transmitted over the physical layer (e.g., intercepted on an air interface), and protect data integrity (e.g., to ensure control messages originate from intended sources). The PDCP 761 and PDCP 762 may perform retransmissions of undelivered packets, in-sequence delivery and reordering of packets, duplication of packets, and/or identification and removal of duplicate packets. In a dual connectivity scenario, PDCP 761 and PDCP 762 may perform mapping between a split radio bearer and RLC channels.

RLC 751 and RLC 752 may perform segmentation, retransmission through Automatic Repeat Request (ARQ). The RLC 751 and RLC 752 may perform removal of duplicate data units received from MAC 741 and MAC 742, respectively. The RLCs 213 and 233 may provide RLC channels as a service to PDCPs 214 and 234, respectively.

MAC 741 and MAC 742 may perform multiplexing and/or demultiplexing of logical channels. MAC 741 and MAC 742 may map logical channels to transport channels. In an example, UE 701 may, in MAC 741, multiplex data units of one or more logical channels into a transport block. The UE 701 may transmit the transport block to the gNB 702 using PHY 731. The gNB 702 may receive the transport block using PHY 732 and demultiplex data units of the transport blocks back into logical channels. MAC 741 and MAC 742 may perform error correction through Hybrid Automatic Repeat Request (HARQ), logical channel prioritization, and/or padding.

PHY 731 and PHY 732 may perform mapping of transport channels to physical channels. PHY 731 and PHY 732 may perform digital and analog signal processing functions (e.g., coding/decoding and modulation/demodulation) for sending and receiving information (e.g., transmission via an air interface). PHY 731 and PHY 732 may perform multi-antenna mapping.

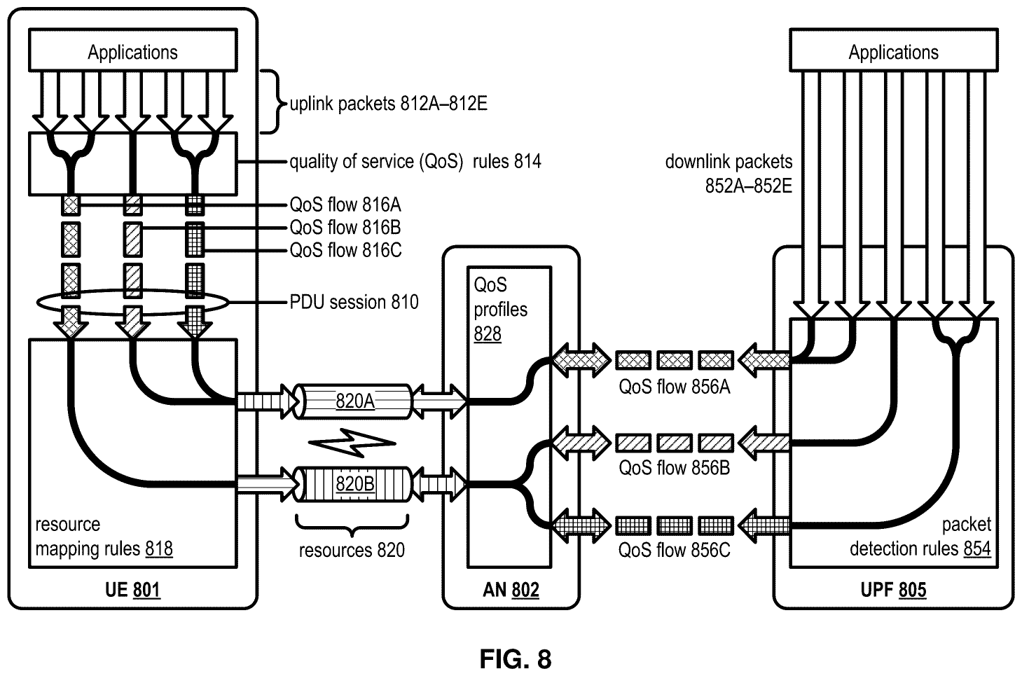

FIG. 8 illustrates an example of a quality of service (QoS) model for differentiated data exchange. In the QoS model of FIG. 8, there are a UE 801, an AN 802, and a UPF 805. The QoS model facilitates prioritization of certain packet or protocol data units (PDUs), also referred to as packets. For example, higher-priority packets may be exchanged faster and/or more reliably than lower-priority packets. The network may devote more resources to exchange of high-QoS packets.

In the example of FIG. 8, a PDU session 810 is established between UE 801 and UPF 805. The PDU session 810 may be a logical connection enabling the UE 801 to exchange data with a particular data network (for example, the Internet). The UE 801 may request establishment of the PDU session 810. At the time that the PDU session 810 is established, the UE 801 may, for example, identify the targeted data network based on its data network name (DNN). The PDU session 810 may be managed, for example, by a session management function (SMF, not shown). In order to facilitate exchange of data associated with the PDU session 810, between the UE 801 and the data network, the SMF may select the UPF 805 (and optionally, one or more other UPFs, not shown).

One or more applications associated with UE 801 may generate uplink packets 812A-812E associated with the PDU session 810. In order to work within the QoS model, UE 801 may apply QoS rules 814 to uplink packets 812A-812E. The QoS rules 814 may be associated with PDU session 810 and may be determined and/or provided to the UE 801 when PDU session 810 is established and/or modified. Based on QoS rules 814, UE 801 may classify uplink packets 812A-812E, map each of the uplink packets 812A-812E to a QoS flow, and/or mark uplink packets 812A-812E with a QoS flow indicator (QFI). As a packet travels through the network, and potentially mixes with other packets from other UEs having potentially different priorities, the QFI indicates how the packet should be handled in accordance with the QoS model. In the present illustration, uplink packets 812A, 812B are mapped to QoS flow 816A, uplink packet 812C is mapped to QoS flow 816B, and the remaining packets are mapped to QoS flow 816C.

The QoS flows may be the finest granularity of QoS differentiation in a PDU session. In the figure, three QoS flows 816A-816C are illustrated. However, it will be understood that there may be any number of QoS flows. Some QoS flows may be associated with a guaranteed bit rate (GBR QoS flows) and others may have bit rates that are not guaranteed (non-GBR QoS flows). QoS flows may also be subject to per-UE and per-session aggregate bit rates. One of the QoS flows may be a default QoS flow. The QoS flows may have different priorities. For example, QoS flow 816A may have a higher priority than QoS flow 816B, which may have a higher priority than QoS flow 816C. Different priorities may be reflected by different QoS flow characteristics. For example, QoS flows may be associated with flow bit rates. A particular QoS flow may be associated with a guaranteed flow bit rate (GFBR) and/or a maximum flow bit rate (MFBR). QoS flows may be associated with specific packet delay budgets (PDBs), packet error rates (PERs), and/or maximum packet loss rates. QoS flows may also be subject to per-UE and per-session aggregate bit rates.

In order to work within the QoS model, UE 801 may apply resource mapping rules 818 to the QoS flows 816A-816C. The air interface between UE 801 and AN 802 may be associated with resources 820. In the present illustration, QoS flow 816A is mapped to resource 820A, whereas QoS flows 816B, 816C are mapped to resource 820B. The resource mapping rules 818 may be provided by the AN 802. In order to meet QoS requirements, the resource mapping rules 818 may designate more resources for relatively high-priority QoS flows. With more resources, a high-priority QoS flow such as QoS flow 816A may be more likely to obtain the high flow bit rate, low packet delay budget, or other characteristic associated with QoS rules 814. The resources 820 may comprise, for example, radio bearers. The radio bearers (e.g., data radio bearers) may be established between the UE 801 and the AN 802. The radio bearers in 5G, between the UE 801 and the AN 802, may be distinct from bearers in LTE, for example, Evolved Packet System (EPS) bearers between a UE and a packet data network gateway (PGW), S1 bearers between an eNB and a serving gateway (SGW), and/or an S5/S8 bearer between an SGW and a PGW.

Once a packet associated with a particular QoS flow is received at AN 802 via resource 820A or resource 820B, AN 802 may separate packets into respective QoS flows 856A-856C based on QoS profiles 828. The QoS profiles 828 may be received from an SMF. Each QoS profile may correspond to a QFI, for example, the QFI marked on the uplink packets 812A-812E. Each QoS profile may include QoS parameters such as 5G QoS identifier (5QI) and an allocation and retention priority (ARP). The QoS profile for non-GBR QoS flows may further include additional QoS parameters such as a reflective QoS attribute (RQA). The QoS profile for GBR QoS flows may further include additional QoS parameters such as a guaranteed flow bit rate (GFBR), a maximum flow bit rate (MFBR), and/or a maximum packet loss rate. The 5QI may be a standardized 5QI which has one-to-one mapping to a standardized combination of 5G QoS characteristics per well-known services. The 5QI may be a dynamically assigned 5QI which the standardized 5QI values are not defined. The 5QI may represent 5G QoS characteristics. The 5QI may comprise a resource type, a default priority level, a packet delay budget (PDB), a packet error rate (PER), a maximum data burst volume, and/or an averaging window. The resource type may indicate a non-GBR QoS flow, a GBR QoS flow or a delay-critical GBR QoS flow. The averaging window may represent a duration over which the GFBR and/or MFBR is calculated. ARP may be a priority level comprising pre-emption capability and a pre-emption vulnerability. Based on the ARP, the AN 802 may apply admission control for the QoS flows in a case of resource limitations.

The AN 802 may select one or more N3 tunnels 850 for transmission of the QoS flows 856A-856C. After the packets are divided into QoS flows 856A-856C, the packet may be sent to UPF 805 (e.g., towards a DN) via the selected one or more N3 tunnels 850. The UPF 805 may verify that the QFIs of the uplink packets 812A-812E are aligned with the QoS rules 814 provided to the UE 801. The UPF 805 may measure and/or count packets and/or provide packet metrics to, for example, a PCF.

The figure also illustrates a process for downlink. In particular, one or more applications may generate downlink packets 852A-852E. The UPF 805 may receive downlink packets 852A-852E from one or more DNs and/or one or more other UPFs. As per the QoS model, UPF 805 may apply packet detection rules (PDRs) 854 to downlink packets 852A-852E. Based on PDRs 854, UPF 805 may map packets 852A-852E into QoS flows. In the present illustration, downlink packets 852A, 852B are mapped to QoS flow 856A, downlink packet 852C is mapped to QoS flow 856B, and the remaining packets are mapped to QoS flow 856C.

The QoS flows 856A-856C may be sent to AN 802. The AN 802 may apply resource mapping rules to the QoS flows 856A-856C. In the present illustration, QoS flow 856A is mapped to resource 820A, whereas QoS flows 856B, 856C are mapped to resource 820B. In order to meet QoS requirements, the resource mapping rules may designate more resources to high-priority QoS flows.

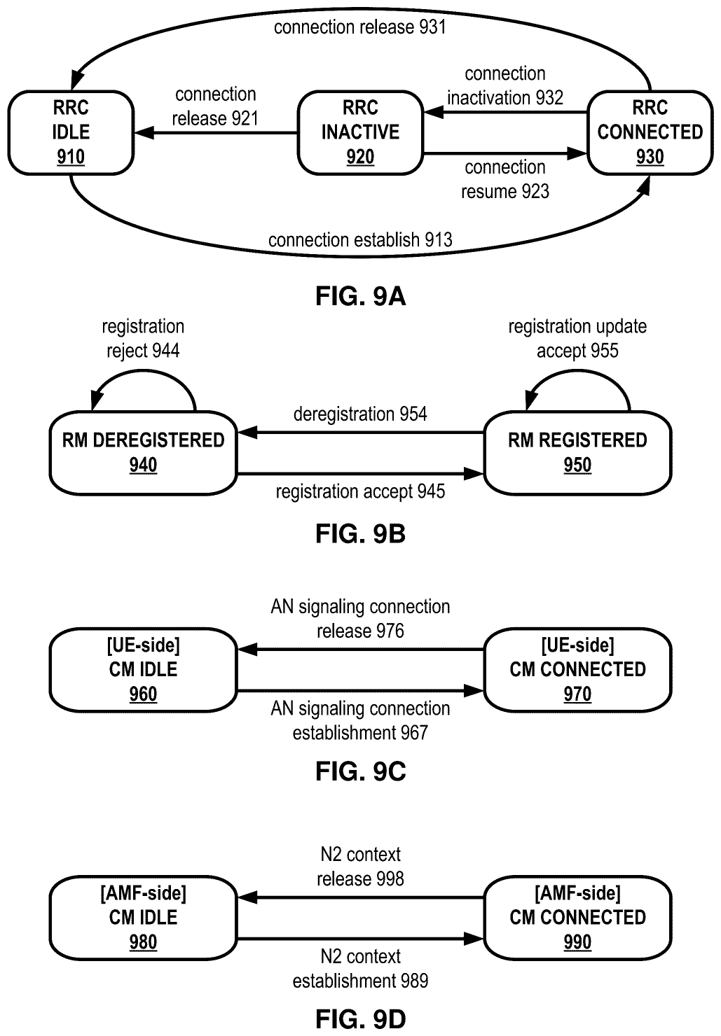

FIGS. 9A-9D illustrate example states and state transitions of a wireless device (e.g., a UE). At any given time, the wireless device may have a radio resource control (RRC) state, a registration management (RM) state, and a connection management (CM) state.

FIG. 9A is an example diagram showing RRC state transitions of a wireless device (e.g., a UE). The UE may be in one of three RRC states: RRC idle 910, (e.g., RRC_IDLE), RRC inactive 920 (e.g., RRC_INACTIVE), or RRC connected 930 (e.g., RRC_CONNECTED). The UE may implement different RAN-related control-plane procedures depending on its RRC state. Other elements of the network, for example, a base station, may track the RRC state of one or more UEs and implement RAN-related control-plane procedures appropriate to the RRC state of each.

In RRC connected 930, it may be possible for the UE to exchange data with the network (for example, the base station). The parameters necessary for exchange of data may be established and known to both the UE and the network. The parameters may be referred to and/or included in an RRC context of the UE (sometimes referred to as a UE context). These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. The base station with which the UE is connected may store the RRC context of the UE.

While in RRC connected 930, mobility of the UE may be managed by the access network, whereas the UE itself may manage mobility while in RRC idle 910 and/or RRC inactive 920. While in RRC connected 930, the UE may manage mobility by measuring signal levels (e.g., reference signal levels) from a serving cell and neighboring cells and reporting these measurements to the base station currently serving the UE. The network may initiate handover based on the reported measurements. The RRC state may transition from RRC connected 930 to RRC idle 910 through a connection release procedure 930 or to RRC inactive 920 through a connection inactivation procedure 932.

In RRC idle 910, an RRC context may not be established for the UE. In RRC idle 910, the UE may not have an RRC connection with a base station. While in RRC idle 910, the UE may be in a sleep state for a majority of the time (e.g., to conserve battery power). The UE may wake up periodically (e.g., once in every discontinuous reception cycle) to monitor for paging messages from the access network. Mobility of the UE may be managed by the UE through a procedure known as cell reselection. The RRC state may transition from RRC idle 910 to RRC connected 930 through a connection establishment procedure 913, which may involve a random access procedure, as discussed in greater detail below.

In RRC inactive 920, the RRC context previously established is maintained in the UE and the base station. This may allow for a fast transition to RRC connected 930 with reduced signaling overhead as compared to the transition from RRC idle 910 to RRC connected 930. The RRC state may transition to RRC connected 930 through a connection resume procedure 923. The RRC state may transition to RRC idle 910 though a connection release procedure 921 that may be the same as or similar to connection release procedure 931.

An RRC state may be associated with a mobility management mechanism. In RRC idle 910 and RRC inactive 920, mobility may be managed by the UE through cell reselection. The purpose of mobility management in RRC idle 910 and/or RRC inactive 920 is to allow the network to be able to notify the UE of an event via a paging message without having to broadcast the paging message over the entire mobile communications network. The mobility management mechanism used in RRC idle 910 and/or RRC inactive 920 may allow the network to track the UE on a cell-group level so that the paging message may be broadcast over the cells of the cell group that the UE currently resides within instead of the entire communication network. Tracking may be based on different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 920 state, the UE may be assigned a RAN notification area. A RAN notification area may comprise one or more cell identities, a list of RAIs, and/or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 920.

FIG. 9B is an example diagram showing registration management (RM) state transitions of a wireless device (e.g., a UE). The states are RM deregistered 940, (e.g., RM-DEREGISTERED) and RM registered 950 (e.g., RM-REGISTERED).

In RM deregistered 940, the UE is not registered with the network, and the UE is not reachable by the network. In order to be reachable by the network, the UE must perform an initial registration. As an example, the UE may register with an AMF of the network. If registration is rejected (registration reject 944), then the UE remains in RM deregistered 940. If registration is accepted (registration accept 945), then the UE transitions to RM registered 950. While the UE is RM registered 950, the network may store, keep, and/or maintain a UE context for the UE. The UE context may be referred to as wireless device context. The UE context corresponding to network registration (maintained by the core network) may be different from the RRC context corresponding to RRC state (maintained by an access network, .e.g., a base station). The UE context may comprise a UE identifier and a record of various information relating to the UE, for example, UE capability information, policy information for access and mobility management of the UE, lists of allowed or established slices or PDU sessions, and/or a registration area of the UE (i.e., a list of tracking areas covering the geographical area where the wireless device is likely to be found).

While the UE is RM registered 950, the network may store the UE context of the UE, and, if necessary, use the UE context to reach the UE. Moreover, some services may not be provided by the network unless the UE is registered. The UE may update its UE context while remaining in RM registered 950 (registration update accept 955). For example, if the UE leaves one tracking area and enters another tracking area, the UE may provide a tracking area identifier to the network. The network may deregister the UE, or the UE may deregister itself (deregistration 954). For example, the network may automatically deregister the wireless device if the wireless device is inactive for a certain amount of time. Upon deregistration, the UE may transition to RM deregistered 940.

FIG. 9C is an example diagram showing connection management (CM) state transitions of a wireless device (e.g., a UE), shown from a perspective of the wireless device. The UE may be in CM idle 960 (e.g., CM-IDLE) or CM connected 970 (e.g., CM-CONNECTED).

In CM idle 960, the UE does not have a non-access stratum (NAS) signaling connection with the network. As a result, the UE cannot communicate with core network functions. The UE may transition to CM connected 970 by establishing an AN signaling connection (AN signaling connection establishment 967). This transition may be initiated by sending an initial NAS message. The initial NAS message may be a registration request (e.g., if the UE is RM deregistered 940) or a service request (e.g., if the UE is RM registered 950). If the UE is RM registered 950, then the UE may initiate the AN signaling connection establishment by sending a service request, or the network may send a page, thereby triggering the UE to send the service request.

In CM connected 970, the UE can communicate with core network functions using NAS signaling. As an example, the UE may exchange NAS signaling with an AMF for registration management purposes, service request procedures, and/or authentication procedures. As another example, the UE may exchange NAS signaling, with an SMF, to establish and/or modify a PDU session. The network may disconnect the UE, or the UE may disconnect itself (AN signaling connection release 976). For example, if the UE transitions to RM deregistered 940, then the UE may also transition to CM idle 960. When the UE transitions to CM idle 960, the network may deactivate a user plane connection of a PDU session of the UE.

FIG. 9D is an example diagram showing CM state transitions of the wireless device (e.g., a UE), shown from a network perspective (e.g., an AMF). The CM state of the UE, as tracked by the AMF, may be in CM idle 980 (e.g., CM-IDLE) or CM connected 990 (e.g., CM-CONNECTED). When the UE transitions from CM idle 980 to CM connected 990, the AMF may establish an N2 context of the UE (N2 context establishment 989). When the UE transitions from CM connected 990 to CM idle 980, the AMF may release the N2 context of the UE (N2 context release 998).

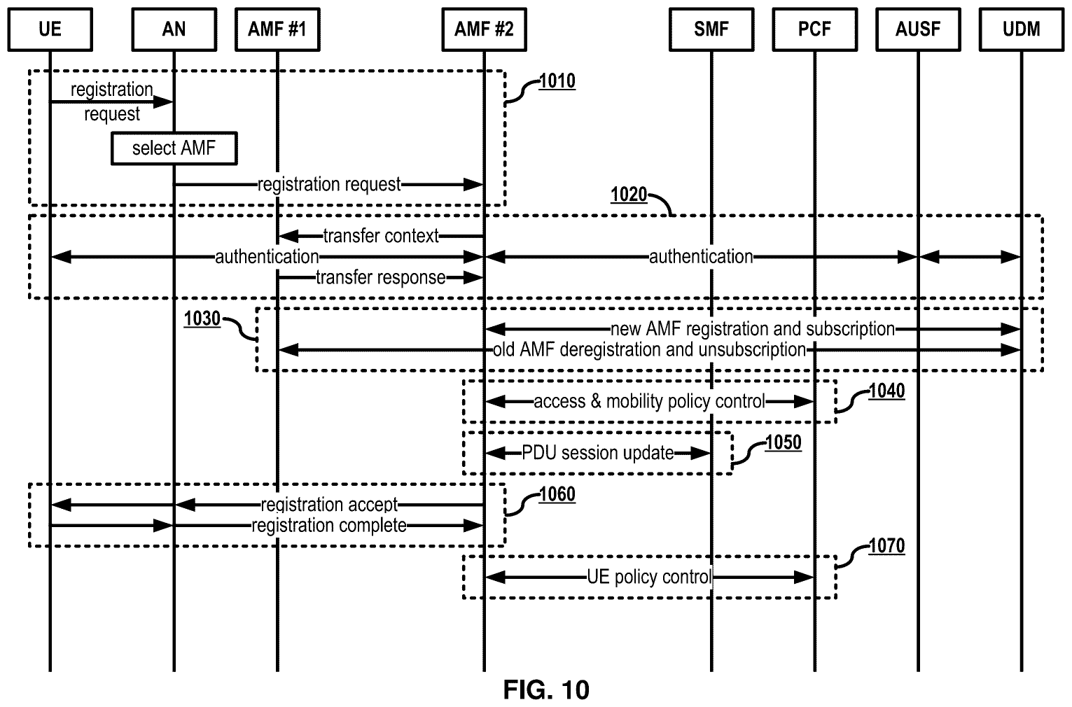

FIGS. 10-12 illustrate example procedures for registering, service request, and PDU session establishment ofaUE.

FIG. 10 illustrates an example of a registration procedure for a wireless device (e.g., a UE). Based on the registration procedure, the UE may transition from, for example, RM deregistered 940 to RM registered 950.

Registration may be initiated by a UE for the purposes of obtaining authorization to receive services, enabling mobility tracking, enabling reachability, or other purposes. The UE may perform an initial registration as a first step toward connection to the network (for example, if the UE is powered on, airplane mode is turned off, etc.). Registration may also be performed periodically to keep the network informed of the UE's presence (for example, while in CM-IDLE state), or in response to a change in UE capability or registration area. Deregistration (not shown in FIG. 10) may be performed to stop network access.

At 1010, the UE transmits a registration request to an AN. As an example, the UE may have moved from a coverage area of a previous AMF (illustrated as AMF #1) into a coverage area of a new AMF (illustrated as AMF #2). The registration request may be a NAS message. The registration request may include a UE identifier. The AN may select an AMF for registration of the UE. For example, the AN may select a default AMF. For example, the AN may select an AMF that is already mapped to the UE (e.g., a previous AMF). The NAS registration request may include a network slice identifier and the AN may select an AMF based on the requested slice. After the AMF is selected, the AN may send the registration request to the selected AMF.

At 1020, the AMF that receives the registration request (AMF #2) performs a context transfer. The context may be a UE context, for example, an RRC context for the UE. As an example, AMF #2 may send AMF #1 a message requesting a context of the UE. The message may include the UE identifier. The message may be a Namf_Communication_UEContextTransfer message. AMF #1 may send to AMF #2 a message that includes the requested UE context. This message may be a Namf_Communication_UEContextTransfer message. After the UE context is received, the AMF #2 may coordinate authentication of the UE. After authentication is complete, AMF #2 may send to AMF #1 a message indicating that the UE context transfer is complete. This message may be a Namf_Communication_UEContextTransfer Response message.

Authentication may require participation of the UE, an AUSF, a UDM and/or a UDR (not shown). For example, the AMF may request that the AUSF authenticate the UE. For example, the AUSF may execute authentication of the UE. For example, the AUSF may get authentication data from UDM. For example, the AUSF may send a subscription permanent identifier (SUPI) to the AMF based on the authentication being successful. For example, the AUSF may provide an intermediate key to the AMF. The intermediate key may be used to derive an access-specific security key for the UE, enabling the AMF to perform security context management (SCM). The AUSF may obtain subscription data from the UDM. The subscription data may be based on information obtained from the UDM (and/or the UDR). The subscription data may include subscription identifiers, security credentials, access and mobility related subscription data and/or session related data.

At 1030, the new AMF, AMF #2, registers and/or subscribes with the UDM. AMF #2 may perform registration using a UE context management service of the UDM (Nudm_UECM). AMF #2 may obtain subscription information of the UE using a subscriber data management service of the UDM (Nudm_SDM). AMF #2 may further request that the UDM notify AMF #2 if the subscription information of the UE changes. As the new AMF registers and subscribes, the old AMF, AMF #1, may deregister and unsubscribe. After deregistration, AMF #1 is free of responsibility for mobility management of the UE.

At 1040, AMF #2 retrieves access and mobility (AM) policies from the PCF. As an example, the AMF #2 may provide subscription data of the UE to the PCF. The PCF may determine access and mobility policies for the UE based on the subscription data, network operator data, current network conditions, and/or other suitable information. For example, the owner of a first UE may purchase a higher level of service than the owner of a second UE. The PCF may provide the rules associated with the different levels of service. Based on the subscription data of the respective UEs, the network may apply different policies which facilitate different levels of service.

For example, access and mobility policies may relate to service area restrictions, RAT/frequency selection priority (RFSP, where RAT stands for radio access technology), authorization and prioritization of access type (e.g., LTE versus NR), and/or selection of non-3GPP access (e.g., Access Network Discovery and Selection Policy (ANDSP)). The service area restrictions may comprise a list of tracking areas where the UE is allowed to be served (or forbidden from being served). The access and mobility policies may include a UE route selection policy (URSP)) that influences routing to an established PDU session or a new PDU session. As noted above, different policies may be obtained and/or enforced based on subscription data of the UE, location of the UE (i.e., location of the AN and/or AMF), or other suitable factors.

At 1050, AMF #2 may update a context of a PDU session. For example, if the UE has an existing PDU session, the AMF #2 may coordinate with an SMF to activate a user plane connection associated with the existing PDU session. The SMF may update and/or release a session management context of the PDU session (Nsmf_PDUSession_UpdateSMContext, Nsmf_PDUSession_ReleaseSMContext).

At 1060, AMF #2 sends a registration accept message to the AN, which forwards the registration accept message to the UE. The registration accept message may include a new UE identifier and/or a new configured slice identifier. The UE may transmit a registration complete message to the AN, which forwards the registration complete message to the AMF #2. The registration complete message may acknowledge receipt of the new UE identifier and/or new configured slice identifier.

At 1070, AMF #2 may obtain UE policy control information from the PCF. The PCF may provide an access network discovery and selection policy (ANDSP) to facilitate non-3GPP access. The PCF may provide a UE route selection policy (URSP) to facilitate mapping of particular data traffic to particular PDU session connectivity parameters. As an example, the URSP may indicate that data traffic associated with a particular application should be mapped to a particular SSC mode, network slice, PDU session type, or preferred access type (3GPP or non-3GPP).

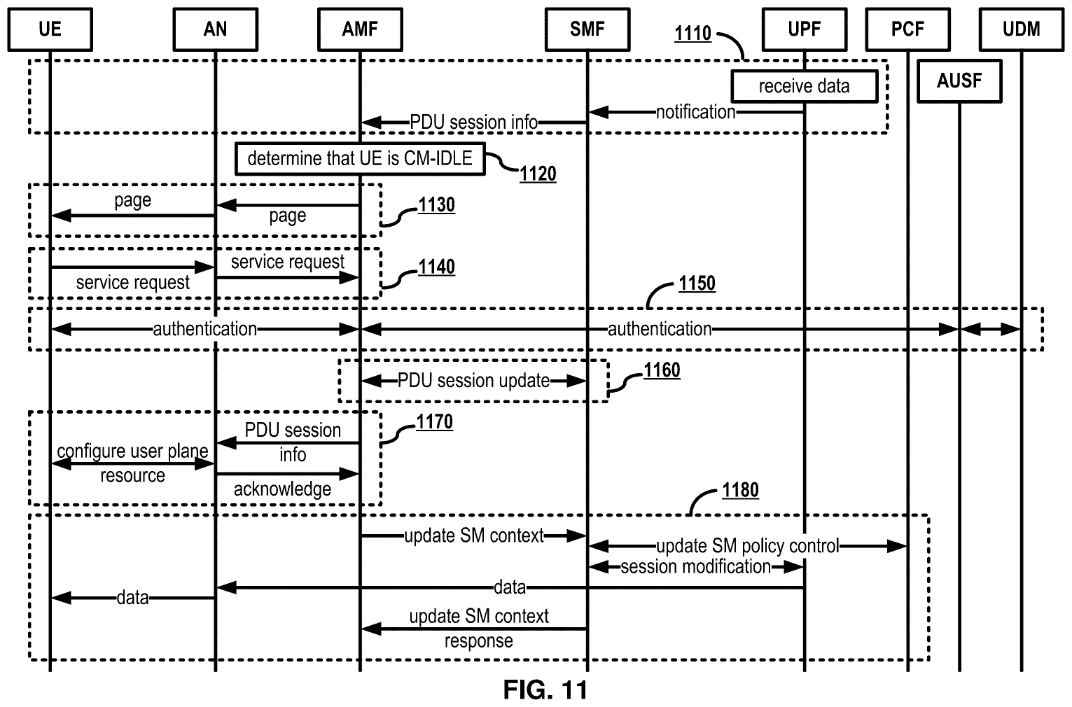

FIG. 11 illustrates an example of a service request procedure for a wireless device (e.g., a UE). The service request procedure depicted in FIG. 11 is a network-triggered service request procedure for a UE in a CM-IDLE state. However, other service request procedures (e.g., a UE-triggered service request procedure) may also be understood by reference to FIG. 11, as will be discussed in greater detail below.

At 1110, a UPF receives data. The data may be downlink data for transmission to a UE. The data may be associated with an existing PDU session between the UE and a DN. The data may be received, for example, from a DN and/or another UPF. The UPF may buffer the received data. In response to the receiving of the data, the UPF may notify an SMF of the received data. The identity of the SMF to be notified may be determined based on the received data. The notification may be, for example, an N4 session report. The notification may indicate that the UPF has received data associated with the UE and/or a particular PDU session associated with the UE. In response to receiving the notification, the SMF may send PDU session information to an AMF. The PDU session information may be sent in an N1N2 message transfer for forwarding to an AN. The PDU session information may include, for example, UPF tunnel endpoint information and/or QoS information.

At 1120, the AMF determines that the UE is in a CM-IDLE state. The determining at 1120 may be in response to the receiving of the PDU session information. Based on the determination that the UE is CM-IDLE, the service request procedure may proceed to 1130 and 1140, as depicted in FIG. 11. However, if the UE is not CM-IDLE (e.g., the UE is CM-CONNECTED), then 1130 and 1140 may be skipped, and the service request procedure may proceed directly to 1150.

At 1130, the AMF pages the UE. The paging at 1130 may be performed based on the UE being CM-IDLE. To perform the paging, the AMF may send a page to the AN. The page may be referred to as a paging or a paging message. The page may be an N2 request message. The AN may be one of a plurality of ANs in a RAN notification area of the UE. The AN may send a page to the UE. The UE may be in a coverage area of the AN and may receive the page.

At 1140, the UE may request service. The UE may transmit a service request to the AMF via the AN. As depicted in FIG. 11, the UE may request service at 1140 in response to receiving the paging at 1130. However, as noted above, this is for the specific case of a network-triggered service request procedure. In some scenarios (for example, if uplink data becomes available at the UE), then the UE may commence a UE-triggered service request procedure. The UE-triggered service request procedure may commence starting at 1140.

At 1150, the network may authenticate the UE. Authentication may require participation of the UE, an AUSF, and/or a UDM, for example, similar to authentication described elsewhere in the present disclosure. In some cases (for example, if the UE has recently been authenticated), the authentication at 1150 may be skipped.

At 1160, the AMF and SMF may perform a PDU session update. As part of the PDU session update, the SMF may provide the AMF with one or more UPF tunnel endpoint identifiers. In some cases (not shown in FIG. 11), it may be necessary for the SMF to coordinate with one or more other SMFs and/or one or more other UPFs to set up a user plane.

At 1170, the AMF may send PDU session information to the AN. The PDU session information may be included in an N2 request message. Based on the PDU session information, the AN may configure a user plane resource for the UE. To configure the user plane resource, the AN may, for example, perform an RRC reconfiguration of the UE. The AN may acknowledge to the AMF that the PDU session information has been received. The AN may notify the AMF that the user plane resource has been configured, and/or provide information relating to the user plane resource configuration.

In the case of a UE-triggered service request procedure, the UE may receive, at 1170, a NAS service accept message from the AMF via the AN. After the user plane resource is configured, the UE may transmit uplink data (for example, the uplink data that caused the UE to trigger the service request procedure).

At 1180, the AMF may update a session management (SM) context of the PDU session. For example, the AMF may notify the SMF (and/or one or more other associated SMFs) that the user plane resource has been configured, and/or provide information relating to the user plane resource configuration. The AMF may provide the SMF (and/or one or more other associated SMFs) with one or more AN tunnel endpoint identifiers of the AN. After the SM context update is complete, the SMF may send an update SM context response message to the AMF.

Based on the update of the session management context, the SMF may update a PCF for purposes of policy control. For example, if a location of the UE has changed, the SMF may notify the PCF of the UE's a new location.

Based on the update of the session management context, the SMF and UPF may perform a session modification. The session modification may be performed using N4 session modification messages. After the session modification is complete, the UPF may transmit downlink data (for example, the downlink data that caused the UPF to trigger the network-triggered service request procedure) to the UE. The transmitting of the downlink data may be based on the one or more AN tunnel endpoint identifiers of the AN.

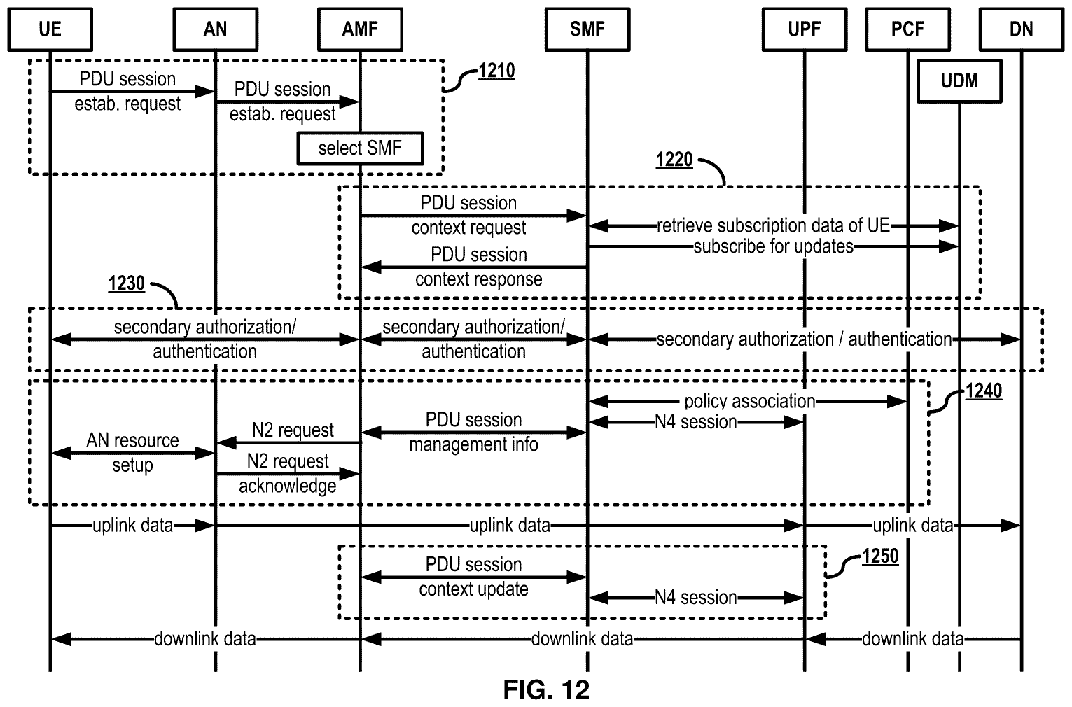

FIG. 12 illustrates an example of a protocol data unit (PDU) session establishment procedure for a wireless device (e.g., a UE). The UE may determine to transmit the PDU session establishment request to create a new PDU session, to hand over an existing PDU session to a 3GPP network, or for any other suitable reason.

At 1210, the UE initiates PDU session establishment. The UE may transmit a PDU session establishment request to an AMF via an AN. The PDU session establishment request may be a NAS message. The PDU session establishment request may indicate: a PDU session ID; a requested PDU session type (new or existing); a requested DN (DNN); a requested network slice (S-NSSAI); a requested SSC mode; and/or any other suitable information. The PDU session ID may be generated by the UE. The PDU session type may be, for example, an Internet Protocol (IP)-based type (e.g., IPv4, IPv6, or dual stack IPv4/IPv6), an Ethernet type, or an unstructured type.

The AMF may select an SMF based on the PDU session establishment request. In some scenarios, the requested PDU session may already be associated with a particular SMF. For example, the AMF may store a UE context of the UE, and the UE context may indicate that the PDU session ID of the requested PDU session is already associated with the particular SMF. In some scenarios, the AMF may select the SMF based on a determination that the SMF is prepared to handle the requested PDU session. For example, the requested PDU session may be associated with a particular DNN and/or S-NSSAI, and the SMF may be selected based on a determination that the SMF can manage a PDU session associated with the particular DNN and/or S-NSSAI.

At 1220, the network manages a context of the PDU session. After selecting the SMF at 1210, the AMF sends a PDU session context request to the SMF. The PDU session context request may include the PDU session establishment request received from the UE at 1210. The PDU session context request may be a Nsmf_PDUSession_CreateSMContext Request and/or a Nsmf_PDUSession_UpdateSMContext Request. The PDU session context request may indicate identifiers of the UE; the requested DN; and/or the requested network slice. Based on the PDU session context request, the SMF may retrieve subscription data from a UDM. The subscription data may be session management subscription data of the UE. The SMF may subscribe for updates to the subscription data, so that the PCF will send new information if the subscription data of the UE changes. After the subscription data of the UE is obtained, the SMF may transmit a PDU session context response to the AMG. The PDU session context response may be a Nsmf_PDUSession_CreateSMContext Response and/or a Nsmf_PDUSession_UpdateSMContext Response. The PDU session context response may include a session management context ID.

At 1230, secondary authorization/authentication may be performed, if necessary. The secondary authorization/authentication may involve the UE, the AMF, the SMF, and the DN. The SMF may access the DN via a Data Network Authentication, Authorization and Accounting (DN AAA) server.

At 1240, the network sets up a data path for uplink data associated with the PDU session. The SMF may select a PCF and establish a session management policy association. Based on the association, the PCF may provide an initial set of policy control and charging rules (PCC rules) for the PDU session. When targeting a particular PDU session, the PCF may indicate, to the SMF, a method for allocating an IP address to the PDU Session, a default charging method for the PDU session, an address of the corresponding charging entity, triggers for requesting new policies, etc. The PCF may also target a service data flow (SDF) comprising one or more PDU sessions. When targeting an SDF, the PCF may indicate, to the SMF, policies for applying QoS requirements, monitoring traffic (e.g., for charging purposes), and/or steering traffic (e.g., by using one or more particular N6 interfaces).

The SMF may determine and/or allocate an IP address for the PDU session. The SMF may select one or more UPFs (a single UPF in the example of FIG. 12) to handle the PDU session. The SMF may send an N4 session message to the selected UPF. The N4 session message may be an N4 Session Establishment Request and/or an N4 Session Modification Request. The N4 session message may include packet detection, enforcement, and reporting rules associated with the PDU session. In response, the UPF may acknowledge by sending an N4 session establishment response and/or an N4 session modification response.

The SMF may send PDU session management information to the AMF. The PDU session management information may be a Namf_Communication_N1N2MessageTransfer message. The PDU session management information may include the PDU session ID. The PDU session management information may be a NAS message. The PDU session management information may include N1 session management information and/or N2 session management information. The N1 session management information may include a PDU Session Establishment accept message. The PDU Session Establishment accept message may include tunneling endpoint information of the UPF and quality of service (QoS) information associated with the PDU session.

The AMF may send an N2 request to the AN. The N2 request may include the PDU Session Establishment accept message. Based on the N2 request, the AN may determine AN resources for the UE. The AN resources may be used by the UE to establish the PDU session, via the AN, with the DN. The AN may determine resources to be used for the PDU session and indicate the determined resources to the UE. The AN may send the PDU Session Establishment accept message to the UE. For example, the AN may perform an RRC reconfiguration of the UE. After the AN resources are set up, the AN may send an N2 request acknowledge to the AMF. The N2 request acknowledge may include N2 session management information, for example, the PDU session ID and tunneling endpoint information of the AN.

After the data path for uplink data is set up at 1240, the UE may optionally send uplink data associated with the PDU session. As shown in FIG. 12, the uplink data may be sent to a DN associated with the PDU session via the AN and the UPF.

At 1250, the network may update the PDU session context. The AMF may transmit a PDU session context update request to the SMF. The PDU session context update request may be a Nsmf_PDUSession_UpdateSMContext Request. The PDU session context update request may include the N2 session management information received from the AN. The SMF may acknowledge the PDU session context update. The acknowledgement may be a Nsmf_PDUSession_UpdateSMContext Response. The acknowledgement may include a subscription requesting that the SMF be notified of any UE mobility event. Based on the PDU session context update request, the SMF may send an N4 session message to the UPF. The N4 session message may be an N4 Session Modification Request. The N4 session message may include tunneling endpoint information of the AN. The N4 session message may include forwarding rules associated with the PDU session. In response, the UPF may acknowledge by sending an N4 session modification response.

After the UPF receives the tunneling endpoint information of the AN, the UPF may relay downlink data associated with the PDU session. As shown in FIG. 12, the downlink data may be received from a DN associated with the PDU session via the AN and the UPF.

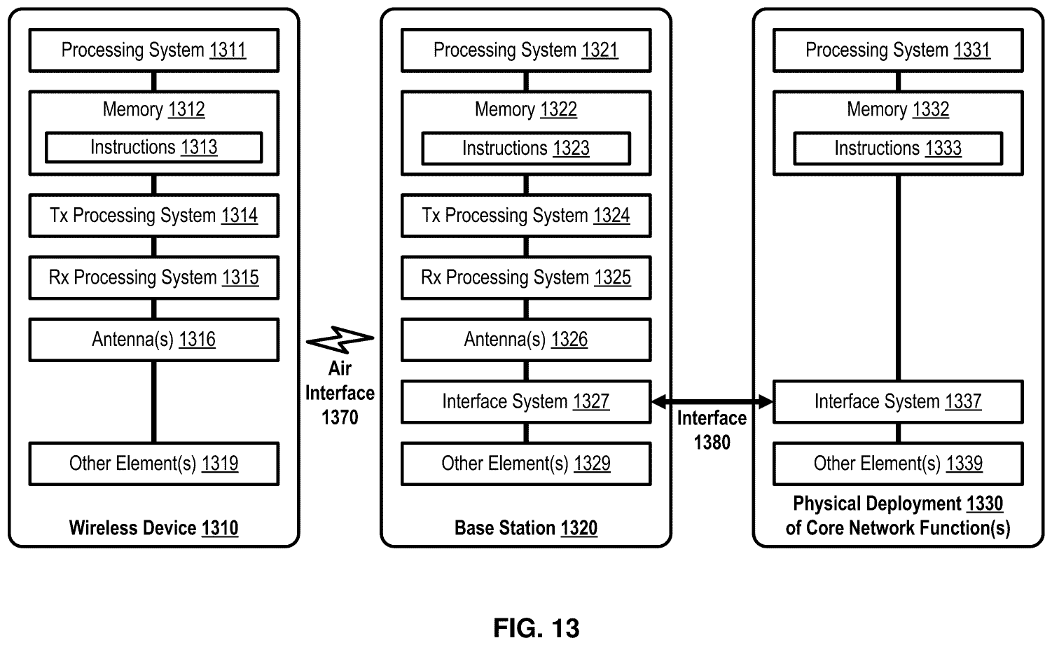

FIG. 13 illustrates examples of components of the elements in a communications network. FIG. 13 includes a wireless device 1310, a base station 1320, and a physical deployment of one or more network functions 1330 (henceforth “deployment 1330”). Any wireless device described in the present disclosure may have similar components and may be implemented in a similar manner as the wireless device 1310. Any other base station described in the present disclosure (or any portion thereof, depending on the architecture of the base station) may have similar components and may be implemented in a similar manner as the base station 1320. Any physical core network deployment in the present disclosure (or any portion thereof, depending on the architecture of the base station) may have similar components and may be implemented in a similar manner as the deployment 1330.

The wireless device 1310 may communicate with base station 1320 over an air interface 1370. The communication direction from wireless device 1310 to base station 1320 over air interface 1370 is known as uplink, and the communication direction from base station 1320 to wireless device 1310 over air interface 1370 is known as downlink. Downlink transmissions may be separated from uplink transmissions using FDD, TDD, and/or some combination of duplexing techniques. FIG. 13 shows a single wireless device 1310 and a single base station 1320, but it will be understood that wireless device 1310 may communicate with any number of base stations or other access network components over air interface 1370, and that base station 1320 may communicate with any number of wireless devices over air interface 1370.

The wireless device 1310 may comprise a processing system 1311 and a memory 1312. The memory 1312 may comprise one or more computer-readable media, for example, one or more non-transitory computer readable media. The memory 1312 may include instructions 1313. The processing system 1311 may process and/or execute instructions 1313. Processing and/or execution of instructions 1313 may cause wireless device 1310 and/or processing system 1311 to perform one or more functions or activities. The memory 1312 may include data (not shown). One of the functions or activities performed by processing system 1311 may be to store data in memory 1312 and/or retrieve previously-stored data from memory 1312. In an example, downlink data received from base station 1320 may be stored in memory 1312, and uplink data for transmission to base station 1320 may be retrieved from memory 1312. As illustrated in FIG. 13, the wireless device 1310 may communicate with base station 1320 using a transmission processing system 1314 and/or a reception processing system 1315. Alternatively, transmission processing system 1314 and reception processing system 1315 may be implemented as a single processing system, or both may be omitted and all processing in the wireless device 1310 may be performed by the processing system 1311. Although not shown in FIG. 13, transmission processing system 1314 and/or reception processing system 1315 may be coupled to a dedicated memory that is analogous to but separate from memory 1312, and comprises instructions that may be processed and/or executed to carry out one or more of their respective functionalities. The wireless device 1310 may comprise one or more antennas 1316 to access air interface 1370.

The wireless device 1310 may comprise one or more other elements 1319. The one or more other elements 1319 may comprise software and/or hardware that provide features and/or functionalities, for example, a speaker, a microphone, a keypad, a display, a touchpad, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, a global positioning sensor (GPS) and/or the like). The wireless device 1310 may receive user input data from and/or provide user output data to the one or more one or more other elements 1319. The one or more other elements 1319 may comprise a power source. The wireless device 1310 may receive power from the power source and may be configured to distribute the power to the other components in wireless device 1310. The power source may comprise one or more sources of power, for example, a battery, a solar cell, a fuel cell, or any combination thereof.

The wireless device 1310 may transmit uplink data to and/or receive downlink data from base station 1320 via air interface 1370. To perform the transmission and/or reception, one or more of the processing system 1311, transmission processing system 1314, and/or reception system 1315 may implement open systems interconnection (OSI) functionality. As an example, transmission processing system 1314 and/or reception system 1315 may perform layer 1 OSI functionality, and processing system 1311 may perform higher layer functionality. The wireless device 1310 may transmit and/or receive data over air interface 1370 using one or more antennas 1316. For scenarios where the one or more antennas 1316 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise a processing system 1321 and a memory 1322. The memory 1322 may comprise one or more computer-readable media, for example, one or more non-transitory computer readable media. The memory 1322 may include instructions 1323. The processing system 1321 may process and/or execute instructions 1323. Processing and/or execution of instructions 1323 may cause base station 1320 and/or processing system 1321 to perform one or more functions or activities. The memory 1322 may include data (not shown). One of the functions or activities performed by processing system 1321 may be to store data in memory 1322 and/or retrieve previously-stored data from memory 1322. The base station 1320 may communicate with wireless device 1310 using a transmission processing system 1324 and a reception processing system 1325. Although not shown in FIG. 13, transmission processing system 1324 and/or reception processing system 1325 may be coupled to a dedicated memory that is analogous to but separate from memory 1322, and comprises instructions that may be processed and/or executed to carry out one or more of their respective functionalities. The wireless device 1320 may comprise one or more antennas 1326 to access air interface 1370.

The base station 1320 may transmit downlink data to and/or receive uplink data from wireless device 1310 via air interface 1370. To perform the transmission and/or reception, one or more of the processing system 1321, transmission processing system 1324, and/or reception system 1325 may implement OSI functionality. As an example, transmission processing system 1324 and/or reception system 1325 may perform layer 1 OSI functionality, and processing system 1321 may perform higher layer functionality. The base station 1320 may transmit and/or receive data over air interface 1370 using one or more antennas 1326. For scenarios where the one or more antennas 1326 include multiple antennas, the multiple antennas may be used to perform one or more multi-antenna techniques, such as spatial multiplexing (e.g., single-user multiple-input multiple output (MIMO) or multi-user MIMO), transmit/receive diversity, and/or beamforming.

The base station 1320 may comprise an interface system 1327. The interface system 1327 may communicate with one or more base stations and/or one or more elements of the core network via an interface 1380. The interface 1380 may be wired and/or wireless and interface system 1327 may include one or more components suitable for communicating via interface 1380. In FIG. 13, interface 1380 connects base station 1320 to a single deployment 1330, but it will be understood that wireless device 1310 may communicate with any number of base stations and/or CN deployments over interface 1380, and that deployment 1330 may communicate with any number of base stations and/or other CN deployments over interface 1380. The base station 1320 may comprise one or more other elements 1329 analogous to one or more of the one or more other elements 1319.

The deployment 1330 may comprise any number of portions of any number of instances of one or more network functions (NFs). The deployment 1330 may comprise a processing system 1331 and a memory 1332. The memory 1332 may comprise one or more computer-readable media, for example, one or more non-transitory computer readable media. The memory 1332 may include instructions 1333. The processing system 1331 may process and/or execute instructions 1333. Processing and/or execution of instructions 1333 may cause the deployment 1330 and/or processing system 1331 to perform one or more functions or activities. The memory 1332 may include data (not shown). One of the functions or activities performed by processing system 1331 may be to store data in memory 1332 and/or retrieve previously-stored data from memory 1332. The deployment 1330 may access the interface 1380 using an interface system 1337. The deployment 1330 may comprise one or more other elements 1339 analogous to one or more of the one or more other elements 1319.

One or more of the systems 1311, 1314, 1315, 1321, 1324, 1325, and/or 1331 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. One or more of the systems 1311, 1314, 1315, 1321, 1324, 1325, and/or 1331 may perform signal coding/processing, data processing, power control, input/output processing, and/or any other functionality that m ay enable wireless device 1310, base station 1320, and/or deployment 1330 to operate in a mobile communications system.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise computers, microcontrollers, microprocessors, DSPs, ASICs, FPGAs, and complex programmable logic devices (CPLDs). Computers, microcontrollers and microprocessors may be programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

The wireless device 1310, base station 1320, and/or deployment 1330 may implement timers and/or counters. A timer/counter may start at an initial value. As used herein, starting may comprise restarting. Once started, the timer/counter may run. Running of the timer/counter may be associated with an occurrence. When the occurrence occurs, the value of the timer/counter may change (for example, increment or decrement). The occurrence may be, for example, an exogenous event (for example, a reception of a signal, a measurement of a condition, etc.), an endogenous event (for example, a transmission of a signal, a calculation, a comparison, a performance of an action or a decision to so perform, etc.), or any combination thereof. In the case of a timer, the occurrence may be the passage of a particular amount of time. However, it will be understood that a timer may be described and/or implemented as a counter that counts the passage of a particular unit of time. A timer/counter may run in a direction of a final value until it reaches the final value. The reaching of the final value may be referred to as expiration of the timer/counter. The final value may be referred to as a threshold. A timer/counter may be paused, wherein the present value of the timer/counter is held, maintained, and/or carried over, even upon the occurrence of one or more occurrences that would otherwise cause the value of the timer/counter to change. The timer/counter may be un-paused or continued, wherein the value that was held, maintained, and/or carried over begins changing again when the one or more occurrence occur. A timer/counter may be set and/or reset. As used herein, setting may comprise resetting. When the timer/counter sets and/or resets, the value of the timer/counter may be set to the initial value. A timer/counter may be started and/or restarted. As used herein, starting may comprise restarting. In some embodiments, when the timer/counter restarts, the value of the timer/counter may be set to the initial value and the timer/counter may begin to run.

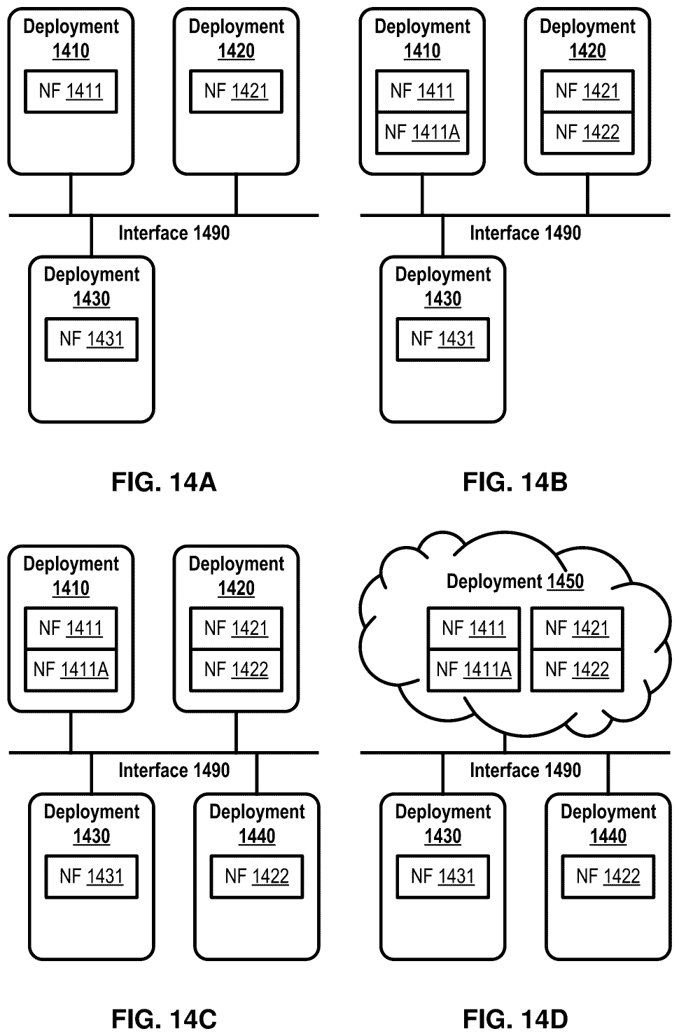

FIGS. 14A, 14B, 14C, and 14D illustrate various example arrangements of physical core network deployments, each having one or more network functions or portions thereof. The core network deployments comprise a deployment 1410, a deployment 1420, a deployment 1430, a deployment 1440, and/or a deployment 1450. Each deployment may be analogous to, for example, the deployment 1330 depicted in FIG. 13. In particular, each deployment may comprise a processing system for performing one or more functions or activities, memory for storing data and/or instructions, and an interface system for communicating with other network elements (for example, other core network deployments). Each deployment may comprise one or more network functions (NFs). The term NF may refer to a particular set of functionalities and/or one or more physical elements configured to perform those functionalities (e.g., a processing system and memory comprising instructions that, when executed by the processing system, cause the processing system to perform the functionalities). For example, in the present disclosure, when a network function is described as performing X, Y, and Z, it will be understood that this refers to the one or more physical elements configured to perform X, Y, and Z, no matter how or where the one or more physical elements are deployed. The term NF may refer to a network node, network element, and/or network device.

As will be discussed in greater detail below, there are many different types of NF and each type of NF may be associated with a different set of functionalities. A plurality of different NFs may be flexibly deployed at different locations (for example, in different physical core network deployments) or in a same location (for example, co-located in a same deployment). A single NF may be flexibly deployed at different locations (implemented using different physical core network deployments) or in a same location. Moreover, physical core network deployments may also implement one or more base stations, application functions (AFs), data networks (DNs), or any portions thereof. NFs may be implemented in many ways, including as network elements on dedicated or shared hardware, as software instances running on dedicated or shared hardware, or as virtualized functions instantiated on a platform (e.g., a cloud-based platform).

FIG. 14A illustrates an example arrangement of core network deployments in which each deployment comprises one network function. A deployment 1410 comprises an NF 1411, a deployment 1420 comprises an NF 1421, and a deployment 1430 comprises an NF 1431. The deployments 1410, 1420, 1430 communicate via an interface 1490. The deployments 1410, 1420, 1430 may have different physical locations with different signal propagation delays relative to other network elements. The diversity of physical locations of deployments 1410, 1420, 1430 may enable provision of services to a wide area with improved speed, coverage, security, and/or efficiency.

FIG. 14B illustrates an example arrangement wherein a single deployment comprises more than one NF. Unlike FIG. 14A, where each NF is deployed in a separate deployment, FIG. 14B illustrates multiple NFs in deployments 1410, 1420. In an example, deployments 1410, 1420 may implement a software-defined network (SDN) and/or a network function virtualization (NFV).

For example, deployment 1410 comprises an additional network function, NF 1411A. The NFs 1411, 1411A may consist of multiple instances of the same NF type, co-located at a same physical location within the same deployment 1410. The NFs 1411, 1411A may be implemented independently from one another (e.g., isolated and/or independently controlled). For example, the NFs 1411, 1411A may be associated with different network slices. A processing system and memory associated with the deployment 1410 may perform all of the functionalities associated with the NF 1411 in addition to all of the functionalities associated with the NF 1411A. In an example, NFs 1411, 1411A may be associated with different PLMNs, but deployment 1410, which implements NFs 1411, 1411A, may be owned and/or operated by a single entity.

Elsewhere in FIG. 14B, deployment 1420 comprises NF 1421 and an additional network function, NF 1422. The NFs 1421, 1422 may be different NF types. Similar to NFs 1411, 1411A, the NFs 1421, 1422 may be co-located within the same deployment 1420, but separately implemented. As an example, a first PLMN may own and/or operate deployment 1420 having NFs 1421, 1422. As another example, the first PLMN may implement NF 1421 and a second PLMN may obtain from the first PLMN (e.g., rent, lease, procure, etc.) at least a portion of the capabilities of deployment 1420 (e.g., processing power, data storage, etc.) in order to implement NF 1422. As yet another example, the deployment may be owned and/or operated by one or more third parties, and the first PLMN and/or second PLMN may procure respective portions of the capabilities of the deployment 1420. When multiple NFs are provided at a single deployment, networks may operate with greater speed, coverage, security, and/or efficiency.

FIG. 14C illustrates an example arrangement of core network deployments in which a single instance of an NF is implemented using a plurality of different deployments. In particular, a single instance of NF 1422 is implemented at deployments 1420, 1440. As an example, the functionality provided by NF 1422 may be implemented as a bundle or sequence of subservices. Each subservice may be implemented independently, for example, at a different deployment. Each subservice may be implemented in a different physical location. By distributing implementation of subservices of a single NF across different physical locations, the mobile communications network may operate with greater speed, coverage, security, and/or efficiency.

FIG. 14D illustrates an example arrangement of core network deployments in which one or more network functions are implemented using a data processing service. In FIG. 14D, NFs 1411, 1411A, 1421, 1422 are included in a deployment 1450 that is implemented as a data processing service. The deployment 1450 may comprise, for example, a cloud network and/or data center. The deployment 1450 may be owned and/or operated by a PLMN or by a non-PLMN third party. The NFs 1411, 1411A, 1421, 1422 that are implemented using the deployment 1450 may belong to the same PLMN or to different PLMNs. The PLMN(s) may obtain (e.g., rent, lease, procure, etc.) at least a portion of the capabilities of the deployment 1450 (e.g., processing power, data storage, etc.). By providing one or more NFs using a data processing service, the mobile communications network may operate with greater speed, coverage, security, and/or efficiency.

As shown in the figures, different network elements (e.g., NFs) may be located in different physical deployments, or co-located in a single physical deployment. It will be understood that in the present disclosure, the sending and receiving of messages among different network elements is not limited to inter-deployment transmission or intra-deployment transmission, unless explicitly indicated.

In an example, a deployment may be a ‘black box’ that is preconfigured with one or more NFs and preconfigured to communicate, in a prescribed manner, with other ‘black box’ deployments (e.g., via the interface 1490). Additionally or alternatively, a deployment may be configured to operate in accordance with open-source instructions (e.g., software) designed to implement NFs and communicate with other deployments in a transparent manner. The deployment may operate in accordance with open RAN (O-RAN) standards.

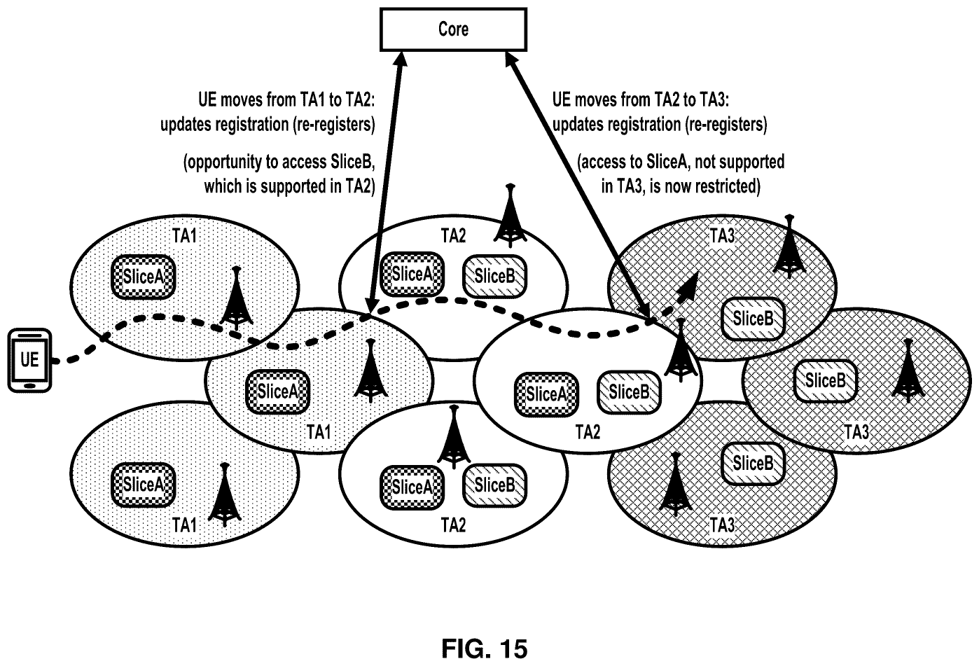

FIG. 15 illustrates the concept of wireless device tracking areas (TAs) and the possibility of different supports and/or restrictions among different TAs.

In the figure, a first tracking area TA1 includes one or more first cells, a second tracking area TA2 includes one or more second cells, and a third tracking area TA3 includes one or more third cells. A wireless device (e.g., UE) moves throughout the TAs.

The TAs in the figure have different restrictions and/or support. For example, the TAs may be associated with allowed/not allowed areas; specific closed subscriber groups (CSGs) and/or closed access groups (CAGs); specific network slices; etc.

In an allowed area, the UE may be allowed to transmit data or signaling with the base station (e.g., via a Uu interface with the base station), whereas in a non-allowed area, data transmission may not be allowed (e.g., only signaling is allowed via the Uu interface). In an example, one TA may be in an allowed area of the UE, whereas another TA may be in a not-allowed area of the UE.

The UE may have a subscription and/or access to a CSG or a CAG. The UE may be permitted to access the network via a particular CSG. The UE may be permitted to access the network via a particular CAG. The UE may not be permitted to access the network except via the particular CAG. In an example, one TA may support access to a particular CAG, whereas another TA does not.

There are many possible examples of supports and/or restrictions that may be specific to a tracking area. Accordingly, as the UE travels through different TAs, supports and/or restrictions may change. As an example of different supports and/or restrictions, the figure illustrates an example of differential support for various network slices, represented as sliceA and sliceB. In particular, TA1 supports sliceA (e.g., does not support sliceB), TA2 supports sliceA and sliceB, and TA3 supports sliceB (e.g., does not support sliceA).

Each cell may transmit (e.g., broadcast) tracking area information. For example, each cell may transmit (e.g., broadcast) a system information block (SIB) comprising at least one of a tracking area code (TAC), a tracking area identifier (TAI), a new radio cell global identifier (NCGI), etc.

A wireless device (e.g., UE) may receive the SIB. The cell may be in TA1, as shown in the figure, and the SIB may indicate (for example) a TAC of TA1. The UE may receive the SIB via the cell and register with the network via the cell. For example, the UE may send a registration request message to a core of the network (e.g., an AMF of the network). In response to the registration request message, the network may send a registration accept message. The registration accept message may indicate various supports and/or restrictions associated with TA1. For example, the network may indicate that sliceA is supported (and/or that sliceB is not supported). Slice support may be common to all cells in TA1. For example, all of the one or more first cells in TA1 may support sliceA (and/or not support sliceB). For example, in the figure, there are three cells associated with TA1. Each cell in TA1 may transmit (e.g., broadcast) SIBs indicating TA1. So long as SIBs indicating TA1 are received by the UE, the UE may recognize that it has not left TA1. So long as the UE has not left TA1, the UE may recognize that support and/or restrictions associated with TA1 (e.g., the network slice supports shown in the figure) have not changed.

The UE may later move into TA2. The UE may receive a SIB from a cell in TA2. The SIB may indicate a TAC of TA2. Based on the SIB indicating a different TAC, the UE may recognize that it has moved into a different tracking area. Based on moving into a different tracking area, the UE may recognize that it has moved into a different registration area. Based on moving into a different registration area, the UE may re-register with the network.

(It will be understood that a registration area may include more than one TA. Accordingly, not every move into a new TA will prompt re-registration with the network. If the new TA is in the same registration area as the old TA, then re-registration may not be necessary. However, in the present example, for simplicity, TA1, TA2, TA3 are understood to be in different registration areas.)

When the UE registers via the cell in TA2, the network (again) indicates supports and/or restrictions associated with the TA. In the present example, the network may indicate to the UE that slice A and slice B are supported. Accordingly, the UE may continue to use slice A (which was supported in TA1), and may now also use slice B (which had not been supported in TA1).

The UE may continue to use sliceA and sliceB for as long as the UE remains in TA2. However, the UE may later move into TA3. Based on moving into a different registration area, the UE may re-register with the network. In the figure, the network indicates that slice A is not supported in TA3. Accordingly, the UE can no longer use slice A.

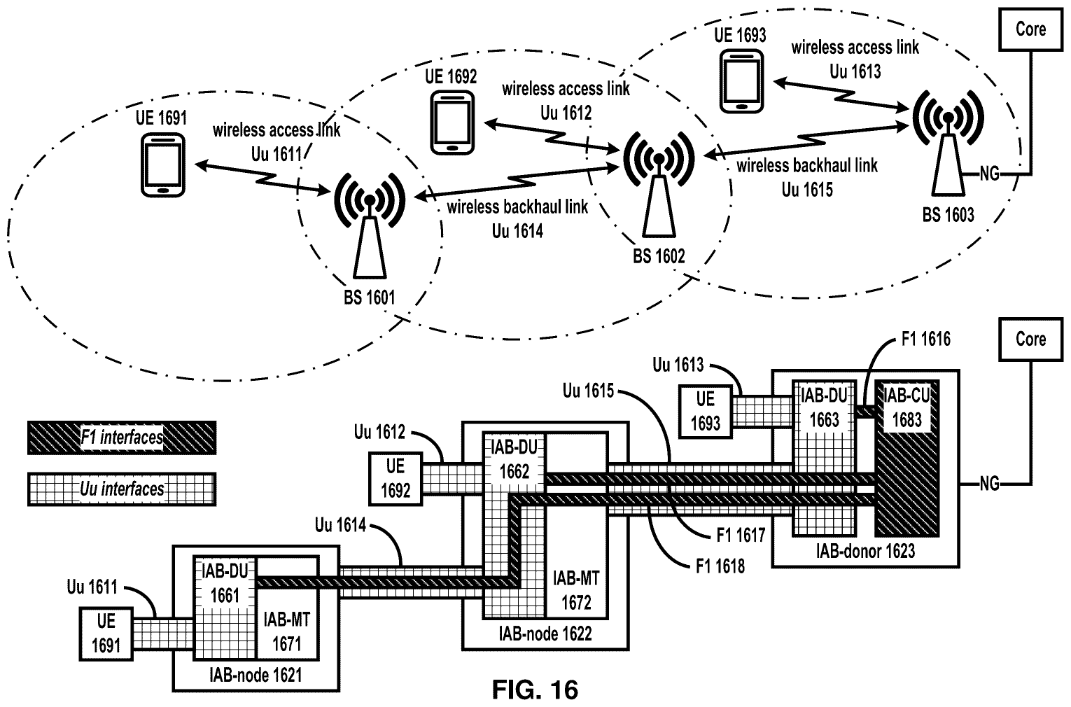

FIG. 16 illustrates an example of integrated access and backhaul (IAB). IAB functionality enables base stations (e.g., gNB, eNB, MeNB, SgNB, etc.) to act as relay nodes (e.g., wireless relay nodes).

In the example figure, several user equipment (UE 1691, UE 1692, UE 1693) access a network via wireless access links of several base stations (BS 1601, BS 1602, BS 1603). Each wireless access link between a UE and a BS may operate as a Uu interface. In particular, the UE 1691 accesses BS 1601 via Uu 1611, UE 1692 accesses the BS 1602 via Uu 1612, and UE 1693 accesses BS 1603 via Uu 1613.

As noted above, IAB functionality enables the BSs 1601-1603 to act as wireless relay nodes. The BSs 1601-1603 may communicate via wireless backhaul links. The wireless backhaul link between BSs may operate as a Uu interface. In particular, BS 1601 has Uu 1614 with BS 1602 and BS 1602 has Uu 1615 with BS 1603.

The BS 1603 has an interface with a core of the network. The interface may be an NG interface (as shown in the figure), an S1-U interface, etc.

In the example figure, BSs 1601-1603 have IAB functionality. At the bottom of the example figure, BS 1601 and BS 1602 are depicted in terms of IAB architecture. In particular, BS 1601 and BS 1602 are depicted as IAB-node 1621 and IAB-node 1622, respectively, and BS 1603 is depicted as IAB-donor 1623.

The IAB-nodes 1621-1622 have distributed unit (DU) functionality. The DU functionality of each IAB-node may be directed downstream (toward the left in the example figure). The DU functionality is illustrated as IAB-DU 1661 and IAB-DU 1662, respectively. The IAB-DUs 1661-1662 use the DU functionality to communicate downstream via a wireless access link (e.g., Uu interface). For example, IAB-node 1621 uses IAB-DU 1661 to communicate downstream to UE 1691 via Uu 1611. IAB-node 1622 uses IAB-DU 1662 to communicate downstream to UE 1692 via Uu 1612. As will be discussed in greater detail below, IAB-node 1622 also uses IAB-DU 1662 to communicate downstream to IAB-node 1621 via Uu 1614.

In addition to DU functionality (for communicating downstream in an IAB context, e.g., with one or more child nodes), each IAB-node may have mobile terminal (MT) functionality (for communicating upstream, e.g., with one or more parent nodes, or IAB-donor). The MT functionalities are illustrated as IAB-MT 1671 and IAB-MT 1672, respectively. The IAB-MTs 1671-1672 use the MT functionality to communicate upstream via a Uu interface. For example, IAB-node 1621 uses IAB-MT 1671 to communicate upstream to IAB-node 1622 via Uu 1614. IAB-node 1622 uses IAB-MT 1672 to communicate upstream to IAB-donor 1623 via Uu 1615.

The IAB-donor 1623 has central unit (CU) functionality. The CU functionality is illustrated as IAB-CU 1683. The IAB-donor 1623 uses the CU functionality to communicate upstream with the core of the network (e.g., via an NG interface, S1-U interface, etc.). Similar to the IAB-nodes 1621-1622, the IAB-donor 1623 may have DU functionality, illustrated as IAB-DU 1663. Similar to the IAB-nodes 1621-1622, the IAB-donor 1623 uses the DU functionality to communicate downstream via a Uu interface. For example, IAB-donor 1623 uses IAB-DU 1663 to communicate downstream to UE 1693 via Uu 1613. IAB-donor 1623 also uses IAB-DU 1663 to communicate downstream to IAB-node 1622 via Uu 1615.

From the perspective of the IAB-CU 1683 of the IAB-donor 1623, the IAB-node 1621 and IAB-node 1622 may be regarded as distributed units, similar to IAB-DU 1663. For example, BS 1603 may operate as a base station central unit with F1 interfaces to several base station distributed units. An F1 interface 1616 may be implemented within BS 1603 between IAB-CU 1683 and IAB-DU 1663. Another base station distributed unit may be implemented as DU functionality within BS 1602. An F1 interface 1617 may be implemented between IAB-CU 1683 and IAB-DU 1662, employing the wireless backhaul link Uu 1615. Yet another base station distributed unit may be implemented as DU functionality within BS 1601. An F1 interface 1618 may be implemented between IAB-CU 1683 and IAB-DU 1661, employing the series of wireless backhaul links Uu 1614-1615. It will be understood that a ‘multi-hop’ F1 interface may be implemented across any number of wireless backhaul links. In this manner, base stations configured with IAB functionality may act as IAB-nodes, enabling the base stations to act as communication relays.

In light of the foregoing example, it will be understood that IAB enables wireless relaying in NG-RAN. The relaying node, referred to as IAB-node, supports access and backhauling via 3GPP new radio (NR). The terminating node of NR backhauling on the network side may be referred to as the IAB-donor, which represents a base station (e.g., gNB) with additional functionality to support IAB. Backhauling can occur via a single hop or via multiple hops.

The IAB-node supports the gNB-DU functionality to terminate the NR access interface to UEs and next-hop IAB-nodes, and to terminate the F1 protocol to the gNB-CU functionality, on the IAB-donor. The gNB-DU functionality on the IAB-node may be referred to as IAB-DU.

In addition to the gNB-DU functionality, the IAB-node also supports a subset of the UE functionality referred to as IAB-MT, which includes, e.g., physical layer, layer-2, radio resource control (RRC) and non-access stratum (NAS) functionality to connect to the DU functionality of another IAB-node or the IAB-donor; to connect to the gNB-CU on the IAB-donor; and to connect to the core network.

In 4G systems, the IAB-node can access the network using standalone architecture (SA mode) or E-UTRA-NR dual connectivity (EN-DC). In EN-DC, the IAB-node connects via E-UTRA to a master eNB (MeNB), and the IAB-donor terminates an X2-C interface as a secondary gNB (SgNB).

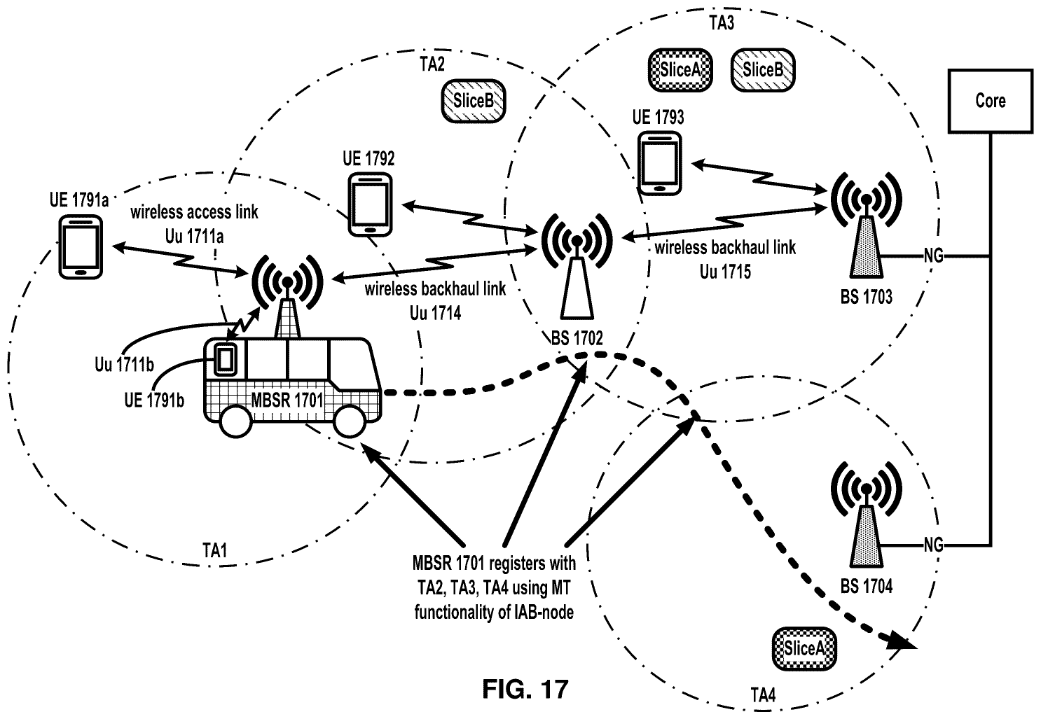

FIG. 17 illustrates an example of a mobile base station relay (MBSR). The figure illustrates an MBSR 1701. The MBSR 1701 may comprise IAB functionality, for example, similar to the BS 1601 and/or IAB-node 1621 illustrated in FIG. 16. As noted above, IAB functionality enables base stations (e.g., gNB, eNB, MeNB, SgNB, etc.) to act as relay nodes (e.g., wireless relay nodes). It will be understood that in some scenarios, the MBSR may be a VMR (vehicle mounted relay), a mobile IAB node, a mIAB node, a mobile base station, and/or the like.

In the example figure, several user equipment (UE 1791, UE 1792, UE 1793) access a network via wireless access links of several base stations (MBSR 1701, BS 1702, BS 1703, BS 1704). The MBSR 1701 is a mobile base station, for example, a base station that is configured and/or intended to move within the network. The MBSR 1701 is illustrated as a bus with an integrated base station, but it will be understood that base station mobility may be implemented in any suitable manner (train, boat, aerial drone, etc.). The UE 1791a is illustrated as being outside of the bus, whereas the UE 1791b is illustrated as being inside the bus (e.g., moving with and/or transported by the MBSR 1701).

As one use-case scenario for MBSRs, consider that the MBSR 1701 may be located (e.g., parked) at the edge of a coverage area of a non-mobile base station (e.g., BS 1702) to extend a coverage area of the network. Even if UE 1791a is at or beyond an edge of a coverage area of the BS 1702, the UE 1791a may access BS 1702 (and the upstream network) via MBSR 1701 (and/or a multi-hop chain of additional MBSRs, not illustrated). Accordingly, MBSRs may be advantageously or spontaneously deployed if coverage is needed in a remote area (an off-the-grid music festival, a rescue operation, etc.).

As another use-case scenario for MBSRs, consider that the MBSR 1701 may transport a plurality of users (e.g., UE 1791b plus several other passenger UEs) through various coverage areas (of BS 1702, BS 1703, BS 1704, etc.). If the MBSR 1701 lacked MBSR capabilities (i.e., if the MBSR 1701 was a normal bus), then each of the passenger UEs would re-register in each TA (TA2, TA3, TA4, etc.). This would predictably result in a sudden spike of control signaling in each base station's coverage area as the bus entered. A benefit of MBSR is that the need for control signaling can be reduced. For example, because MBSR 1701 has the DU functionality of an IAB-node, each of the users (UE 1791b, etc.) can remain in a coverage area of the MBSR 1701. From the perspective of the passenger UEs, MBSR 1701 remains “stationary”. In an example, only the MBSR 1701 itself re-registers in each tracking area (e.g., using its MT functionality), thereby reducing the amount of control signaling. MBSRs of this kind may be advantageously deployed along high-traffic corridors (e.g., on a bus or in a train car) to limit waves of registration requests.

As noted above, IAB functionality enables MBSR 1701/BSs 1702-1704 to act as wireless relay nodes. MBSR 1701 and BS 1702 may communicate upstream via wireless backhaul links (Uu 1714, Uu 1715). In the example figure, BS 1703 and BS 1704 have interfaces with a core of the network. In the example figure, MBSR 1701 and BSs 1702-1704 have IAB functionality.

MBSR 1701 and BS 1702 may operate as IAB-nodes. Accordingly, MBSR 1701 and BS 1702 may have DU functionality and MT functionality.

BS 1703 and BS 1704 may operate as IAB-donors. BSs 1703-1704 may have CU functionality and DU functionality.

Unlike the BS 1601 illustrated in FIG. 16, MBSR 1701 is mobile. Accordingly, MBSR 1701 may move through the coverage areas of BS 1702 and BS 1703, and may sometimes be regarded (due to its MT functionality), from an upstream perspective, as any other wireless device (e.g., UE).

MBSR 1701 and BSs 1702-1704 may belong to different tracking areas, respectively (TA1, TA2, TA3, TA4 in the illustration). Each may transmit (e.g., broadcast) a SIB indicating its tracking area. In an example, the respective TAs may be associated with different registration areas (e.g., a UE may re-register upon exiting and/or entering a TA).

Moreover, MBSR 1701 and BSs 1702-1704 may have different supports and/or restrictions. In the illustrated example, TA2 supports SliceA and SliceB, TA3 supports SliceB (e.g., does not support SliceA), and TA4 supports SliceA (e.g., does not support SliceB).

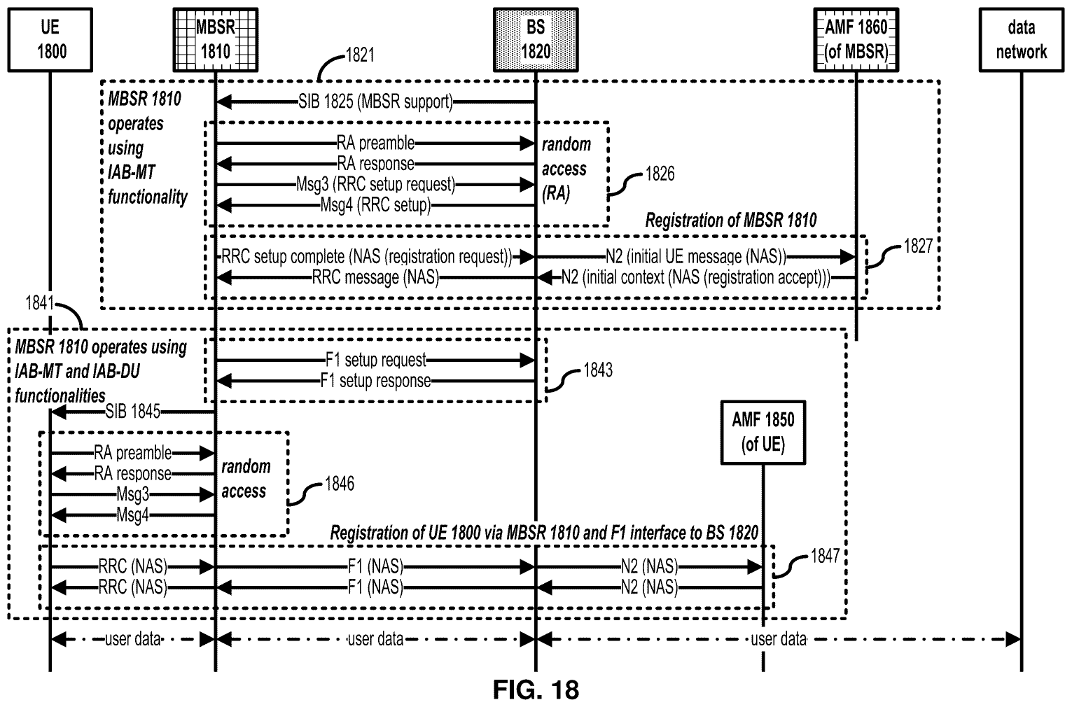

FIG. 18 illustrates an example of registration of an MBSR and a wireless device. For illustration purposes, the figure includes a UE 1800, an MBSR 1810, a BS 1820, an AMF 1850 (serving UE 1800), and an AMF 1860 (serving MBSR 1810).

BS 1820 may operate as an IAB-node (e.g., having DU functionality and MT functionality) or as an IAB-donor (e.g., having CU functionality and DU functionality). Although BS 1820 is illustrated as a single node, it will be understood that in some scenarios, BS 1820 may comprise one or more IAB-nodes and an IAB-donor (e.g., a chain of IAB-nodes and an IAB-donor, as shown in FIG. 16).

Although AMF 1850 and AMF 1860 are illustrated as different AMFs, it will be understood that in some scenarios, the same AMF may serve (e.g., be selected to serve) both UE 1800 and MBSR 1810.

At 1821, MBSR 1810 accesses the network, sets up an RRC connection, and registers. During 1821, MBSR 1810 may operate using IAB-MT functionality.

The MBSR 1810 receives a system information block (SIB) 1825 from BS 1820. The SIB 1825 may indicate (e.g., comprise an indicator) that BS 1820 supports MBSR operation (e.g., supports communication via a wireless backhaul link, supports communication with an IAB-node, supports mobile IAB-node, etc.). The SIB 1825 may comprise, for example, a network identifier associated with a network of BS 1820 (e.g., PLMN ID), a tracking area identifier associated with a tracking area of BS 1820 (e.g., tracking area code (TAC), tracking area identifier (TAI) etc.), a cell identifier associated with the cell of BS 1820 (e.g., new radio cell global identifier (NCGI), NR cell identity), etc.

At 1826, MBSR 1810 performs random access (RA). The RA in the figure is illustrated as four-step random access, but it will be understood that other types of RA may be implemented. The random access at 1826 may be based on receiving the SIB 1825. The random access at 1826 may be based on the SIB 1825 indicating MBSR support and/or based on that MBSR 1810 is configured to function as a MBSR.

In the figure, to perform random access at 1826, MBSR 1810 transmits an RA preamble to BS 1820. The BS 1820 transmits an RA response to MBSR 1810. The transmitting the RA response may be based on receiving the RA preamble. The MBSR 1810 transmits a Msg3 to BS 1820. The Msg3 may comprise an RRC setup request. The Msg3 may comprise a temporary identifier of MBSR 1810. The Msg3 may comprise an establishment cause value (e.g., an indication that RRC setup is for a mobile base station). The transmitting the Msg3 may be based on receiving the RA response. The BS 1820 transmits a Msg4 to MBSR 1810. The Msg4 may comprise an RRC setup message. The transmitting the Msg 4 may be based on receiving the Msg3.

At 1827, MBSR 1810 registers with the network. The registration is via BS 1820 (e.g., a distributed unit (DU) of BS 1820, a central unit (CU) of BS 1820, a cell of BS 1820, etc.). In the figure, MBSR 1810 sends a registration request to BS 1820. The registration request may be included in a NAS message.

The registration request and/or NAS message may be included in an RRC setup complete message. In an example, the RRC Setup complete message may comprise an indication that MBSR 1810 is an MBSR. After the RRC setup complete message is transmitted by MBSR 1810 and/or received by BS 1820, the MBSR 1810 may have an RRC connection with BS 1820.

The BS 1820 may select an AMF to serve the MBSR 1810. In the figure, AMF 1860 is the selected AMF. The BS 1820 sends a registration request (e.g., the registration request received from MBSR 1810) to the AMF 1860. The registration request may be included in a NAS message (e.g., the NAS message received from MBSR 1810). The registration request and/or the NAS message may be included in an N2 message and/or initial UE message. After receiving the registration request, the AMF 1860 may determine to accept the registration. The accepting may be based on, for example, subscription information of the MBSR 1810, etc. The AMF 1860 sends a registration accept to BS 1820. The registration accept may be included in a NAS message. The registration accept and/or the NAS message may be included in an N2 message and/or initial context setup message. The BS 1820 may send a registration accept (e.g., the registration accept received from AMF 1860) to the MBSR 1810. The registration accept may be included in a NAS message. The registration accept and/or the NAS message may be included in an RRC message.

MBSR 1810 may operate as an IAB-node (e.g., a mobile IAB-node). BS 1820 may operate as an IAB-node and/or an IAB-donor. Based on registration of MBSR 1810, a Uu interface may be set up between MBSR 1810 (e.g., an MT functionality of MBSR 1810) and BS 1820 (e.g., a DU functionality of BS 1820).

At 1841, MBSR 1810 may operate using IAB-MT functionality (e.g., when interacting with BS 1820 for Uu interface) and/or IAB-DU functionality (e.g., when interacting with UE 1800, or interacting with BS 1820 for F1 interface).

At 1843, an F1 interface is set up between MBSR 1810 and BS 1820. As discussed previously (e.g., FIG. 16), the F1 interface may be via a Uu interface and/or one or more wireless backhaul links. In the figure, MBSR 1810 sends an F1 setup request message to BS 1820. The BS 1820 sends an F1 setup response message to MBSR 1810.

The MBSR 1810 transmits a SIB 1845. The SIB 1845 may be broadcast (e.g., intermittently) in a coverage area of the MBSR 1810. The SIB 1845 may be received by the UE 1800.

At 1846, the UE 1800 performs random access. The RA in the figure is illustrated as four-step random access, but it will be understood that other types of RA may be implemented. The random access at 1846 may be based on receiving the SIB 1845. In the figure, to perform random access at 1846, UE 1800 transmits an RA preamble to MBSR 1810. The MBSR 1810 transmits an RA response to UE 1800. The transmitting the RA response may be based on receiving the RA preamble. The UE 1800 transmits a Msg3 to MBSR 1810. The Msg3 may comprise an RRC setup request. The transmitting the Msg3 may be based on receiving the RA response. The MBSR 1810 transmits a Msg4 to UE 1800. The Msg4 may comprise an RRC setup message. The transmitting the Msg 4 may be based on receiving the Msg3.

At 1847, UE 1800 registers with the network. The registration is via MBSR 1810 and BS 1820. In the figure, UE 1800 sends a registration request to MBSR 1810. The registration request may be included in a NAS message. The registration request and/or NAS message may be included in an RRC setup complete message. After the RRC setup complete message is transmitted by UE 1800 and/or received by BS 1820 via MBSR 1810, the UE 1800 may have an RRC connection with BS 1820 via MBSR 1810.

The BS 1820 may receive the registration request and/or NAS message from MBSR 1810. The registration request and/or NAS message may be included in an F1 message from MBSR 1810 to BS 1820. The registration request and/or NAS message may be included in an uplink RRC message transfer message. The registration request and/or NAS message may be included in an initial uplink RRC message transfer message.

The BS 1820 may select an AMF to serve the UE 1800. In the figure, AMF 1850 is the selected AMF. The BS 1820 sends a registration request (e.g., the registration request received from UE 1800) to the AMF 1850. The registration request may be included in a NAS message (e.g., the NAS message received from UE 1800). The registration request and/or the NAS message may be included in an N2 message and/or initial UE message.

After receiving the registration request, the AMF 1850 may determine to accept the registration. The accepting may be based on, for example, subscription information of the UE 1800, etc. For example, the subscription information of the UE may indicate that the UE is allowed to use a MBSR. The AMF 1850 sends a registration accept to BS 1820. The registration accept may be included in a NAS message. The registration accept and/or the NAS message may be included in an N2 message and/or initial context setup message.

The BS 1820 may send a registration accept (e.g., the registration accept received from AMF 1850) to the MBSR 1810. The registration accept may be included in a NAS message. The registration accept and/or the NAS message may be included in an F1 message. The registration accept and/or the NAS message may be included in a downlink RRC message transfer message.

The MBSR 1810 may send a registration accept (e.g., the registration accept received from BS 1820 and/or AMF 1850) to the UE 1800. The registration accept may be included in a NAS message. The registration accept and/or the NAS message may be included in an RRC message.

Based on, for example, the registration of MBSR 1810 via BS 1820 and the registration of UE 1800 via MBSR 1810/BS 1820, UE 1800 may exchange (e.g., send and/or receive) user data with a data network.

In existing technologies, a wireless device may reduce power consumption by transitioning to an idle/inactive state. If the network needs to communicate with the wireless device (e.g., to transmit control signaling or user data), then the network may attempt to send a paging message to the wireless device. The paging message may be sent via the last base station and/or cell to which the wireless device was connected (hereinafter cell #1). However, while the wireless device is idle/inactive, the wireless device may move. Accordingly, the wireless device may no longer be in a coverage area of cell #1 (e.g., may not receive the paging message). To increase the likelihood that the paging message is received by the wireless device, the network may send the paging message via cell #1 and one or more other base stations/cells (e.g., neighboring cells #2, #3, etc.). The group of base stations/cells used to transmit the paging message may be referred to as a tracking area (TA).

Once deployed, base stations/cells may have a particular geographic distribution. Networks can strategically determine which base stations/cells should be part of a particular TA. In a simple example, a TA may be a roughly circular group that includes a plurality of base stations/cells. However, more complex strategies are possible. For example, if there are multiple base stations distributed linearly along a north-south highway, then the network may determine to assign the linear base stations to a single north-south highway-shaped tracking area. If a wireless device is in a car when the wireless device transitions to idle/inactive, then it is more likely to travel north-south (i.e., stay within the TA) than east-west. To increase the likelihood that the wireless device receives the paging message, the network can define the tracking area along the highway, rather than in the suburbs or hinterlands to the east or west.

The introduction of mobile base stations (e.g., MBSR) further complicates the task of defining tracking areas. A mobile base station may not remain stationary. Accordingly,

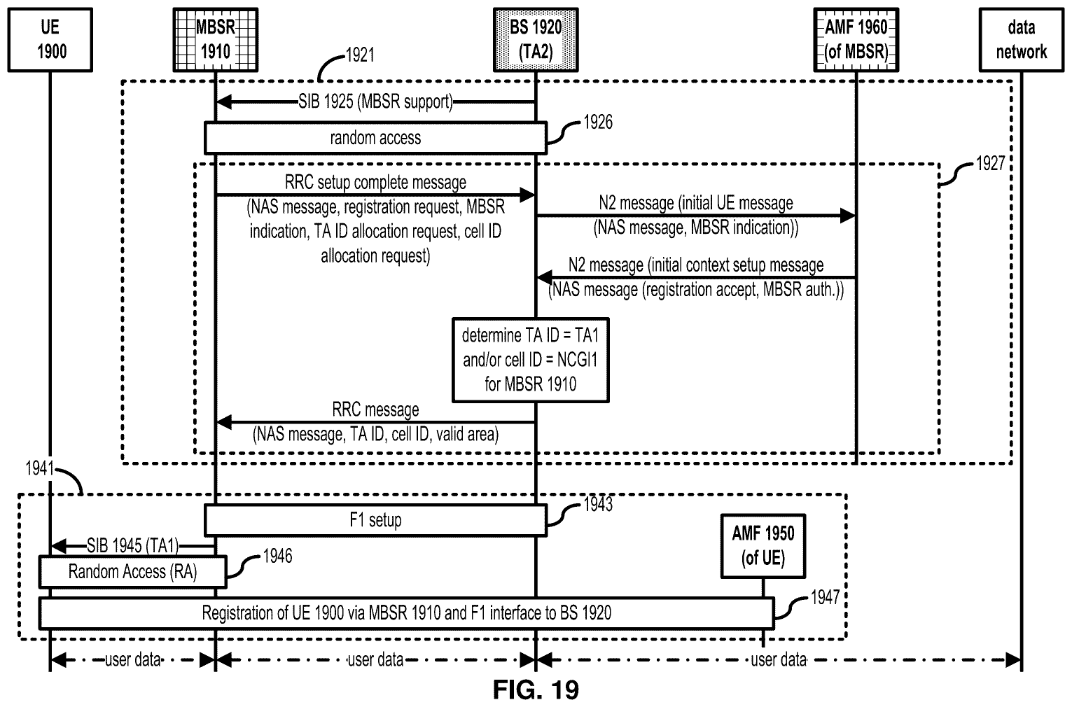

FIG. 19 illustrates an example of allocation of a tracking area identifier and/or a cell identifier in accordance with aspects of the disclosure. For illustration purposes, the figure includes a UE 1900, an MBSR 1910, a BS 1920, an AMF 1950 (serving UE 1900), and an AMF 1960 (serving MBSR 1910). These elements may be similar to the elements illustrated in previous figures; for brevity, redundant details will be omitted.

At 1921 in the figure, similar to the previous figure, MBSR 1910 receives a SIB 1925 from BS 1920. At 1926, MBSR 1910 performs random access. For brevity, redundant details will be omitted.

At 1927, MBSR 1910 registers with the network. The registration is via BS 1920 (e.g., a distributed unit (DU) of BS 1920, a central unit (CU) of BS 1920, a cell of BS 1920, etc.). In the figure, MBSR 1910 sends a registration request to BS 1920. The registration request may be included in a NAS message.

The registration request and/or the NAS message may comprise an MBSR indication (e.g., an indication that MBSR 1910 is a mobile base station). In the present disclosure, an MBSR indication may comprise an indication that a network entity is a mobile base station, MBSR, and/or mobile IAB-node. In an example, the MBSR indication may indicate that the sender of the MBSR indication (and/or a message including the MBSR indication) is a mobile base station, MBSR, and/or mobile IAB-node. In an example, the MBSR indication (and/or a message including the MBSR indication) may comprise and/or indicate an identifier of the network entity that is a mobile base station, MBS R, and/or mobile IAB-node. The identifier of the network entity may be, for example, a UE ID (e.g., SUPI, SUCI, TMSI, etc.).

The registration request and/or the NAS message may comprise a TA identifier allocation request (e.g., a request that the network allocate a tracking area identifier to a TA of the MBSR 1910). The sending of the TA identifier allocation request may be based on a determination, by MBSR 1910, that MBSR 1910 does not have an allocated tracking area identifier. Additionally or alternatively, the sending of the TA identifier allocation request may be based on the fact that MBSR 1910 being configured to use dynamic TA identifier allocation.

In the present disclosure, a tracking area identifier may comprise, for example, a tracking area code (TAC), tracking area identifier (TAI), or any combination thereof. The TAI may comprise, for example, a sequence of a network identifier (e.g., a public land mobile network ID) and the TAC.

The registration request and/or the NAS message may comprise a cell identifier allocation request (e.g., a request that the network allocate a cell identifier to a cell of the MBSR 1910). The sending of the cell identifier allocation request may be based on a determination, by MBSR 1910, that MBSR 1910 does not have a cell identifier for a cell of MBSR 1910. Additionally or alternatively, the sending of the cell identifier allocation request may be based on a determination, by MBSR 1910, that MBSR 1910 is configured to use dynamic cell identifier allocation.

In the present disclosure, cell identifier may comprise, for example, a new radio cell global identifier (NCGI), NR Cell identity, cell identity, etc. The NCGI may comprise, for example, a sequence of a network identifier (e.g., a public land mobile network ID), a base station identifier (e.g., a gNB identifier), a cell identity. Though in the description below NCGI is used, it will be understood that it can be NR Cell identity, cell identity, etc.

In the present disclosure, the TA identifier allocation request and the cell identifier allocation request are described as separate requests. However, in an example, a single allocation request may indicate requests for allocation of both a TA identifier and a cell identifier.

In the present disclosure, allocating may comprise determining, selecting, assigning, defining, identifying, indicating, and/or notifying. For example, an identifier allocation request may be a request that the receiver of the request determine, select, assign, and/or define an identifier. Additionally or alternatively, the identifier allocation request may be a request that the receiver of the request identify, indicate, and/or notify the requestee of the identifier.

The registration request and/or NAS message may be included in an RRC setup complete message. After the RRC setup complete message is transmitted by MBSR 1910 and/or received by BS 1920, the MBSR 1910 may have an RRC connection with BS 1920.

The BS 1920 may select an AMF to serve the MBSR 1910. In the figure, AMF 1960 is the selected AMF. The BS 1920 sends a registration request (e.g., the registration request received from MBSR 1910) to the AMF 1960. The registration request may be included in a NAS message (e.g., the NAS message received from MBSR 1910).

The BS 1920 sends an MBSR indication to the AMF 1960 (e.g., the MBSR indication received from MBSR 1910, the indication that the MBSR 1910 requests MBSR operation). The MBSR indication may be included in the NAS message or sent separately (e.g., in a different information element (IE)) from the NAS message. The registration request, MBSR indication, and/or NAS message may be included in an N2 message and/or initial UE message.

The AMF 1960 may determine to accept the registration. The accepting may be based on, for example, subscription information of the MBSR 1910, etc. For example, the subscription information may indicate that the MBSR may operate as a mobile base station. The AMF 1960 sends a registration accept to BS 1920. The registration accept may be included in a NAS message. The AMF 1960 sends an MBSR authorization (e.g., an indication that MBSR operation by MBSR 1910 is authorized and/or subscribed) to BS 1920. The MBSR authorization may be included in the NAS message or sent separately (e.g., in a different information element (IE)) from the NAS message. The registration accept, MBSR authorization, and/or NAS message may be included in an N2 message and/or initial context setup message.

The BS 1920 may determine a tracking area identifier of a tracking area of MBSR 1910. In the figure, the allocated TA identifier is TA1. The determining may be based on the receiving of the TA identifier allocation request from the MBSR 1910. Additionally or alternatively, the determining may be based on the MBSR indication received from the MBSR 1910. Additionally or alternatively, the determining may be based on the MBSR authorization received from the AMF 1960. Additionally or alternatively, the determining may be based on the location (or trajectory) of MBSR 1910.

In an example, the BS 1920 may be configured and/or preconfigured with one or more pools of TA identifiers. To determine the TA identifier for MBSR 1910 (e.g., TA1), BS 1920 may select TA1 from a pool of TA identifiers. The pool of TA identifiers may be associated with IAB-nodes, mobile base stations, MBSRs, etc. The pool of cell identifiers may be associated with mobile IAB-nodes in particular (e.g., mobile base stations, MBSR, etc., i.e., IAB-nodes that are not stationary). For example, based on MBSR 1910 being an MBSR, BS 1920 may select TA1 from the pool of TA identifiers associated with MBSR. By contrast, if MBSR 1910 were not an MBSR (e.g., if MBSR 1910 were a stationary IAB-node), then BS 1920 may have selected a different TA from a different pool of TA identifiers. Additionally or alternatively, if MBSR 1910 were not an MBSR, then BS 1920 may have rejected the TA identifier allocation request. Additionally or alternatively, if MBSR 1910 were not an MBSR, an operator of the network and/or MBSR 1910 may have pre-configured a static (or fixed) tracking area identifier.

In an example, the one or more pools of TA identifiers may be associated with different locations, areas, directions, trajectories, etc. For example, based on MBSR 1910 being in a first area and/or moving in a first direction, BS 1920 may assign a TA identifier from a first pool of TA identifiers. For example, based on MBSR 1910 being in a second area and/or moving in a second direction, BS 1920 may assign a TA identifier from a second pool TA identifiers.

In an example, the MBSR indication and location of MBSR 1910 may both be considered when allocating the TA identifier. For example, a pool associated with MBSR may be subdivided into sub-pools for MBSRs in different areas.

The BS 1920 may determine a cell identifier of a cell of MBSR 1910. In the figure, the allocated cell identifier is NCGI1. The determining may be based on the receiving of the cell identifier allocation request from the MBSR 1910. Additionally or alternatively, the determining may be based on the MBSR indication received from the MBSR 1910. Additionally or alternatively, the determining may be based on the MBSR authorization received from the AMF 1960. Additionally or alternatively, the determining may be based on the location (or trajectory) of MBSR 1910.

In an example, the BS 1920 may be configured and/or preconfigured with one or more pools of cell identifiers. In existing technologies, a cell identifier (e.g., NCGI) may comprise a base station identifier (e.g., gNB ID) and a cell identifier. (For example, cell #1 of base station #123 may have cell identifier #1231.) The network may select base station identifiers at the time of deployment and/or initialization of the base station. The network may select base station identifiers based on a grouping strategy. For example, the base station identifier may remain fixed and/or static throughout the life of the base station. The network may select a group of base stations (e.g., base stations in a same area, base stations with similar supports and/or restrictions, etc.) and assign base station identifiers that indicate the grouping. For example, base station #121, #122, and #123, having the format #12x may be part of a group of base stations having a same area, similar supports and/or restrictions, etc.

An MBSR may be mobile, which complicates the grouping strategies described above. The area of the MBSR may shift and/or the supports and/or restrictions associated with the MBSR may change. Moreover, in existing technologies, the base station identifier is generally associated with the CU functionality (e.g., layers associated with a base station central unit) of the base station. For IAB-nodes (e.g., mobile base stations, MBSRs), CU functionality may be absent. Accordingly, the network may not be able to rely on existing allocation mechanisms for a cell of an MBSR. This is because IAB-nodes may lack CU functionality.

In the figure, the BS 1920 (e.g., an IAB-donor) may allocate a cell identifier to a cell of MBSR 1910 (e.g., NCGI1). To perform the allocation, BS 1920 may select NCGI1 from a pool of cell identifiers. The pool of cell identifiers may be associated with IAB-nodes, mobile base stations, MBSR, etc. The pool of cell identifiers may be associated with mobile IAB-nodes in particular (e.g., mobile base stations, MBSR, etc., i.e., IAB-nodes that are not stationary). For example, based on MBSR 1910 being an MBSR, BS 1920 may select NCGI1 from the pool of cell identifiers associated with MBSR. By contrast, if MBSR 1910 were not an MBSR (e.g., if MBSR 1910 were a stationary IAB-node), then BS 1920 may have selected a different cell identifier from a different pool of cell identifiers. Additionally or alternatively, if MBSR 1910 were not an MBSR, then BS 1920 may have rejected the cell identifier allocation request. Additionally or alternatively, if MBSR 1910 were not an MBSR, an operator of the network and/or MBSR 1910 may have pre-configured a static (or fixed) cell identifier (e.g., based on a base station identifier of the base station).

In an example, the one or more pools of cell identifiers may be associated with different locations, areas, directions, trajectories, etc. For example, based on MBSR 1910 being in a first area and/or moving in a first direction, BS 1920 may assign a cell identifier from a first pool of cell identifiers. For example, based on MBSR 1910 being in a second area and/or moving in a second direction, BS 1920 may assign a cell identifier from a second pool of cell identifiers.

In an example, the MBSR indication and location of MBSR 1910 may both be considered when allocating the cell identifier. For example, a pool associated with MBSR may be subdivided into sub-pools for MBSRs in different areas.

In an example, the identity of the BS 1920 (e.g., gNB-CU identity) may be considered when allocating the cell identifier. For example, the cell identifier allocated to a cell of the MBSR 1910 may comprise a base station identifier (e.g., gNB-CU identifier) of BS 1920.

The BS 1920 may send a registration accept (e.g., the registration accept received from AMF 1960) to the MBSR 1910. The BS 1920 may send the allocated TA identifier and/or cell identifier to the MBSR 1910. The BS 1920 may indicate to the MBSR 1910 a valid area associated with the allocated TA identifier and/or a valid area associated with the cell identifier. The registration accept, TA identifier, cell identifier, and/or valid area(s) may be included in a NAS message or sent separately (e.g., in a different information element (IE)) from the NAS message. The registration accept and/or the NAS message may be included in an RRC message.

MBSR 1910 may operate as an IAB-node. BS 1920 may operate as an IAB-node and/or an IAB-donor. Based on registration of MBSR 1910, a Uu interface may be set up between MBSR 1910 (e.g., an MT functionality of MBSR 1910) and BS 1920 (e.g., a DU functionality of BS 1920).

At 1941, MBSR 1910 may operate using IAB-MT functionality (e.g., when interacting with BS 1920) and/or IAB-DU functionality (e.g., when interacting with UE 1900).

At 1943, similar to the previous figure, an F1 interface is set up between MBSR 1910 and BS 1920. The F1 setup request message sent by the MBSR 1910 may comprise the allocated TA identifier and/or the allocated cell identifier. For brevity, redundant details will be omitted.

In an example, the F1 setup at 1943 may not be performed. For example, BS 1920 may determine that MBSR 1910 is outside of the valid area for the allocated TA identifier and/or outside of the valid area for the allocated cell identifier. For example, BS 1920 may reject an F1 setup request received from MBSR 1910. For example, an F1 setup response message sent by BS 1920 to MBSR 1910 may indicate that F1 setup is rejected. For example, the F1 setup response message sent by BS 1920 to MBSR 1910 may indicate a cause value for the rejection (e.g., outside valid area, outside valid area for allocated TA identifier, outside valid area for allocated cell identifier, etc.).

The MBSR 1910 transmits a SIB 1945. The SIB 1945 comprises the allocated TA identifier (e.g., TA1) and/or the allocated cell identifier (e.g., NCGI1). The MBSR 1910 may be broadcast (e.g., intermittently) in a coverage area of the MBSR 1910. The transmitting of the SIB 1945 may be based on the MBSR 1910 being in the valid area of the TA identifier and/or the valid area of the cell identifier. The SIB 1945 may be received by the UE 1900.

At 1946, similar to the previous figure, the UE 1900 performs random access. At 1947, similar to the previous figure, the UE 1900 registers with AMF 1950. After registering with AMF 1950, similar to the previous figure, UE 1900 may communicate user data. For brevity, redundant details will be omitted.

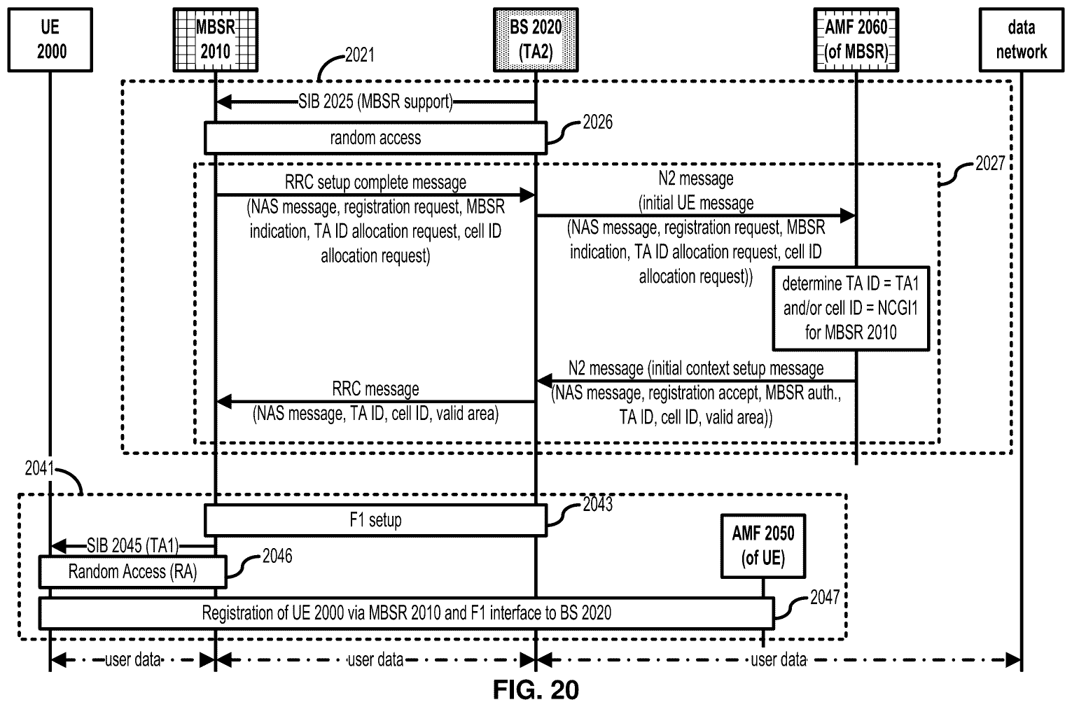

FIG. 20 illustrates an example of allocation of a tracking area identifier and/or a cell identifier in accordance with aspects of the disclosure. For illustration purposes, the figure includes a UE 2000, an MBSR 2010, a BS 2020, an AMF 2050 (serving UE 2000), and an AMF 2060 (serving MBSR 2010). These elements may be similar to the elements illustrated in previous figures; for brevity, redundant details will be omitted.

At 2021 in the figure, similar to the previous figure, MBSR 2010 receives a SIB 2025 from BS 2020. At 2026, MBSR 2010 performs random access. For brevity, redundant details will be omitted.

At 2027, MBSR 2010 registers with the network. The registration is via BS 2020 (e.g., a distributed unit (DU) of BS 2020, a central unit (CU) of BS 2020, a cell of BS 2020, etc.). In the figure, MBSR 2010 sends a registration request to BS 2020. The registration request may be included in a NAS message.

Similar to the previous figure, the registration request and/or the NAS message may comprise an MBSR indication, a TA identifier allocation request, and/or a cell identifier allocation request. For brevity, redundant details will be omitted.

The BS 2020 may select an AMF to serve the MBSR 2010. In the figure, AMF 2060 is the selected AMF. The BS 2020 sends a registration request (e.g., the registration request received from MBSR 2010) to the AMF 2060. The registration request may be included in a NAS message (e.g., the NAS message received from MBSR 2010).

The BS 2020 sends an MBSR indication, a TA identifier allocation request, and/or a cell identifier allocation request (e.g., the MBSR indication, TA identifier allocation request, and/or cell identifier allocation request received from MBSR 2010) to the AMF 2060. The MBSR indication, TA identifier allocation request, and/or cell identifier allocation request may be included in an N2 message (e.g., an initial UE message). The N2 message may include a NAS message. The MBSR indication, TA identifier allocation request, and/or cell identifier allocation request may be included in the NAS message or sent separately (e.g., in a different information element (IE)) (e.g., in a different information element (IE)) from the NAS message.

The AMF 2060 may determine to accept the registration. The accepting may be based on, for example, subscription information of the MBSR 2010, etc. For example, the subscription information may indicate that the MBSR may operate as a mobile base station.

The AMF 2060 may determine a tracking area identifier of a tracking area of MBSR 2010 and/or a cell identifier of a cell of MBSR 2010. The AMF 2060 may determine a valid area associated with the tracking area identifier and/or a valid area associated with the cell identifier. In the figure, the allocated TA identifier is TA1 and the allocated cell identifier is NCGI1. The determining performed by the BS 2220 may be based on receiving the registration request message. Additionally or alternatively, the determining performed by the AMF 2060 may be based on receiving the MBSR indication. Additionally or alternatively, the determining performed by the AMF 2060 may be based on MBSR 2010 being authorized to operate as an MBSR. Additionally or alternatively, the determining performed by the AMF 2060 may be based on determining to accept the registration. The determining performed by the AMF 2060 in FIG. 20 may be similar to the determining performed by the BS 1920 in FIG. 19. For brevity, redundant details will be omitted.

In an example, AMF 2060 may have a broader view of the overall network than a base station. While a BS 2020 may have information for a narrow area that the BS 2020 manages, AMF 2060 may be connected to one or more base stations so that the AMF 2060 may have information regarding overall use of TAs by the one or more base stations. The AMF 2060 may be able to allocate a TA for MBSR 2010 applicable in the area covered by several base stations. Alternatively or additionally, if MBSR 2010 moves through coverage areas of multiple base stations, the AMF may allocate a first range of TAs (e.g., TA 2000-2499), and for a MBSR moving within a specific base stations, the AMF may allocate a second rage of TAs (e.g., TA 2500-2999). In this case, when a UE accesses the AMF through the MBSR, based on the TA identifier, the AMF may be able to determine whether the UE may move in area of a base station or in area of several base stations.

The AMF 2060 may send a registration accept to BS 2020. The registration accept may be included in a NAS message. The AMF 2060 may send an MBSR authorization (e.g., an indication that MBSR operation by MBSR 2010 is authorized and/or subscribed) to BS 2020. The MBSR authorization may be included in the NAS message or sent separately (e.g., in a different information element (IE)) from the NAS message. The AMF 2060 may send the allocated TA identifier (e.g., TA1) and/or the allocated cell identifier (e.g., NCGI1). The BS 2020 may indicate to the MBSR 2010 a valid area associated with the allocated TA identifier and/or a valid area associated with the allocated cell identifier. The MBSR authorization, allocated TA identifier, allocated cell identifier, and/or valid area(s) may be included in the NAS message or sent separately (e.g., in a different information element (IF)) from the NAS message. The registration accept, NAS message, MBSR authorization, allocated TA identifier, allocated cell identifier, and/or valid area(s) may be included in an N2 message and/or initial context setup message.

Similar to the previous figure, the BS 2020 may send a registration accept to the MBSR 2010, MBSR 2010 may operate using IAB-MT functionality at 2041, an F1 interface is set up between MBSR 2010 and BS 2020 at 2043, the MBSR 2010 may transmit a SIB 2045, the UE 2000 may perform random access at 2046, UE 2000 may register with AMF 2050, and UE 2000 may communicate user data. For brevity, redundant details will be omitted.

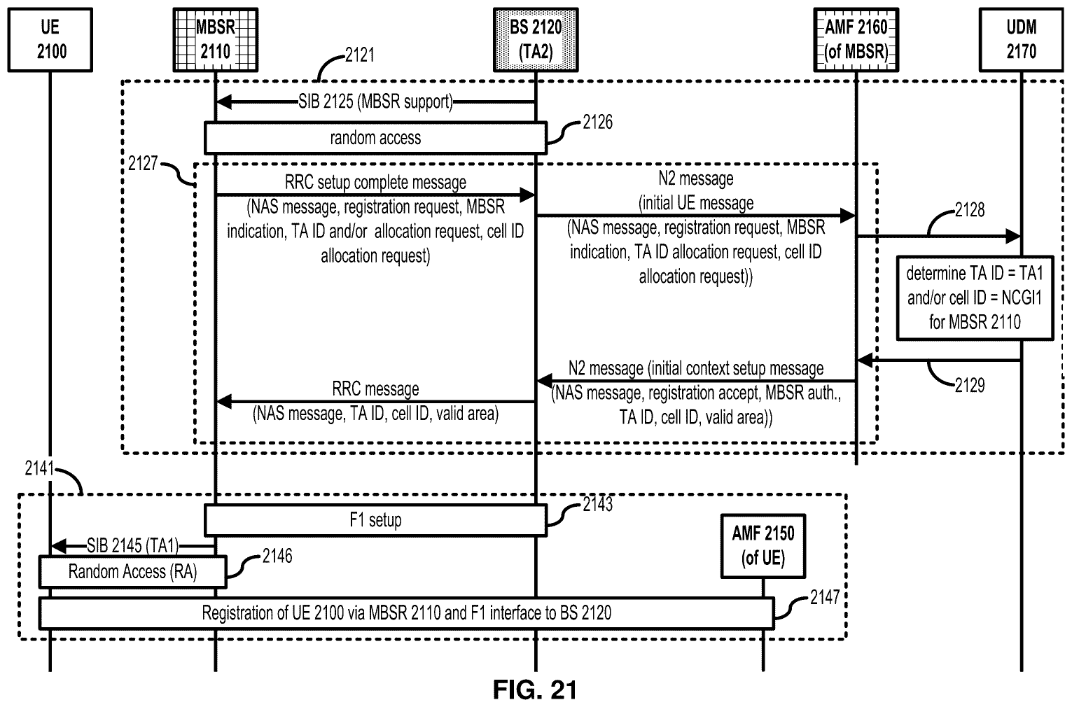

FIG. 21 illustrates an example of allocation of a tracking area identifier and/or a cell identifier in accordance with aspects of the disclosure. For illustration purposes, the figure includes a UE 2100, an MBSR 2110, a BS 2120, an AMF 2150 (serving UE 2100), and an AMF 2160 (serving MBSR 2110). These elements may be similar to the elements illustrated in previous figures; for brevity, redundant details will be omitted. FIG. 21 further illustrates a unified data management (UDM) 2170.

At 2121 in the figure, similar to the previous figure, MBSR 2110 receives a SIB 2125 from BS 2120. At 2126, MBSR 2110 performs random access. At 2127, MBSR 2110 registers with the network. For brevity, redundant details will be omitted.

In the figure, the AMF 2160 may indicate, request, and/or query another core network function to determine the TA identifier and/or cell identifier of the MBSR 2110. For example, AMF 2160 may send a message 2128 to the core network function. The AMF 2160 may indicate, request, and/or query based on determining to accept a registration of the MBSR 2110. The AMF 2160 may indicate, request, and/or query based on MBSR 2110 being authorized to operate as an MBSR. The message 2128 may comprise a wireless device identifier of the MBSR 2010 (e.g., UE ID), an MBSR indication (e.g., the MBSR indication received by AMF 2160 from BS 2120 and/or by BS 2120 from MBSR 2110), an indication of a location, area, direction, and/or trajectory of MBSR 2110, a TA identifier allocation request (e.g., a TAI information request), and/or a cell identifier allocation request (e.g., a cell information request).

The core network function may be, for example, UDM 2170 (as in the illustrated example). The message 2128 may be, for example, an Nudm_SDM_Get message (where SDM indicates a Subscriber Data Management service).

As another example (not illustrated), the core network function may be a policy control function (PCF). The message 2128 may be, for example, an Npcf_Policy_Get message.

As another example (not illustrated), the core network function may be an operation and maintenance (OAM). The message 2128 may be, for example, an OAM service request.

The core network function may determine a tracking area identifier of a tracking area of MBSR 2010 and/or a cell identifier of a cell of MBSR 2010. The core network function may determine a valid area associated with the tracking area and/or a valid area associated with the cell. In the figure, the allocated TA identifier is TA1 and the allocated cell identifier is NCGI1. The determining performed by the core network function may be based on receiving the message 2128. Additionally or alternatively, the determining performed by the core network function may be based on MBSR 2010 being authorized to operate as an MBSR. Additionally or alternatively, the determining performed by the core network function may be based on determining to accept the registration. The determining performed by the core network function in FIG. 21 may be similar to the determining described previously. For brevity, redundant details will be omitted.

In an example, a MBSR (e.g., MBSR 2110) may be provided by a third party (e.g., other than the operator/PLMN of the network). For example, an owner of a bus may mount the MBSR on the bus. The owner may register the MBSR and/or may subscribe to an MBSR service for the bus with the operator. In this case, the operator may want to assign a fixed and/or static TA identifier for the MBSR on the bus, as long as the bus/owner subscribes to services from the operator. This static TA identifier may be stored in the UDM 2170. In an example, whenever the MBSR operates (e.g., whenever the bus moves), the TA identifier may be retrieved from UDM 2170 for the use by the MBSR.

In the figure, the AMF 2160 may receive a message 2129 from the core network function. The message 2129 may comprise the wireless device identifier of the MBSR 2010 (e.g., UE ID), a TA identifier (e.g., TAI information, e.g., TA1), and/or a cell identifier (e.g., cell information, e.g., NCGI1). The message 2129 may be, for example, an Nudm_SDM_Get message (e.g., received from UDM 2170), an Npcf_Policy_Get message (e.g., received from the PCF), and/or an OAM service response (e.g., received from the OAM).

Similar to the previous figure, the BS 2120 may send a registration accept to the MBSR 2110, MBSR 2110 may operate using IAB-MT functionality at 2141, an F1 interface is set up between MBSR 2110 and BS 2120 at 2143, the MBSR 2110 may transmit a SIB 2145, the UE 2100 may perform random access at 2146, UE 2100 may register with AMF 2150, and UE 2100 may communicate user data. For brevity, redundant details will be omitted.

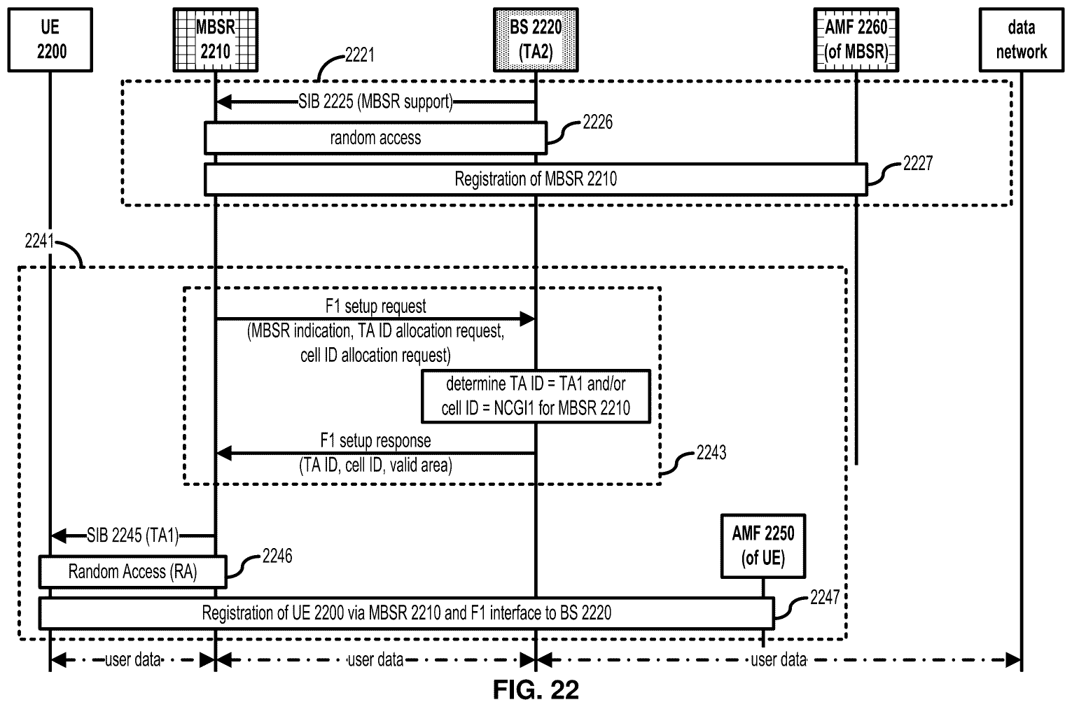

FIG. 22 illustrates an example of allocation of a tracking area identifier and/or a cell identifier in accordance with aspects of the disclosure. For illustration purposes, the figure includes a UE 2200, an MBSR 2210, a BS 2220, an AMF 2250 (serving UE 2200), and an AMF 2260 (serving MBSR 2210).

At 2221 in the figure, similar to the previous figure, MBSR 2210 receives a SIB 2225 from BS 2220. At 2226, MBSR 2210 performs random access. At 2227, MBSR 2210 registers with the network. For brevity, redundant details will be omitted.

At 2241 in the figure, similar to the previous figure, MBSR 2210 may operate using IAB-MT functionality and/or IAB-DU functionality. These elements may be similar to the elements illustrated in previous figures; for brevity, redundant details will be omitted.

At 2243, an F1 interface is set up between MBSR 2210 and BS 2220. As discussed previously, the F1 interface may be via a Uu interface and/or one or more wireless backhaul links.

In the figure, MBSR 2210 sends an F1 setup request message to BS 2220. The F1 setup request message comprises an MBSR indication, a TA identifier allocation request, and/or a cell identifier allocation request.

The BS 2220 may determine a tracking area identifier of a tracking area of MBSR 2210 and/or a cell identifier of a cell of MBSR 2210. The BS 2220 may determine a valid area associated with the tracking area and/or a valid area associated with the cell. In the figure, the allocated TA identifier is TA1 and the allocated cell identifier is NCGI1. The determining performed by the BS 2220 may be based on receiving the F1 setup request message. Additionally or alternatively, the determining performed by the BS 2220 may be based on receiving the MBSR indication. The determining performed by the BS 2220 in FIG. 22 may be similar to the determining described previously. For brevity, redundant details will be omitted.

The BS 2220 may determine one or more sets of (a tracking area identifier of a tracking area of MBSR 2210 and/or a cell identifier of a cell of MBSR 2210, and/or a valid area). The BS 2220 may determine a valid area associated with the tracking area and/or a valid area associated with the cell. In the figure, for a first area, the allocated TA identifier is TA1 and the allocated cell identifier is NCGI1. For a second area (not shown in the figure), the allocated TA identifier is TA2 and the allocated cell identifier is NCGI2. Based on whether MBSR 2210 is located and/or based on the valid area, MBSR determines TA identifier and/or cell identifier to use. For example, if the MBSR determines that MBSR 2210 is in the first area, the MBSR sends F1 setup request comprising TA 1 and/or NCGI 1 associated with the first area, and/or the MBSR broadcast TA1 and/or NCGI 1 over the SIB 2245. For example, if the MBSR determines that MBSR 2210 is in the second area, the MBSR sends F1 setup request comprising TA 2 and/or NCGI 2 associated with the second area, and/or the MBSR broadcast TA2 and/or NCGI 2 over the SIB 2245. Though FIG. 19/20/21 does not describe the valid area, it will be understood that similar mechanism (e.g., delivering of valid area and the use of valid area by the MBSR) may be applicable to the FIG. 19/20/21. The determining performed by the BS 2220 may be based on receiving the F1 setup request message. Additionally or alternatively, the determining performed by the BS 2220 may be based on receiving the MBSR indication. The determining performed by the BS 2220 in FIG. 22 may be similar to the determining described previously. For brevity, redundant details will be omitted. For example, the BS 2220 may comprise one or more cells and/or may cover a wider area. The MBSR may move the one or more cells of the BS 2220. If the BS 2220 wants to apply different TA identifies for different area, allocating several sets of TA identifier, cell identifier and/or valid area may reduce signaling between MBSR and the BS 2220.

In the figure, BS 2220 sends an F1 setup response message to MBSR 2210. The F1 setup response message comprises the allocated TA identifier (e.g., TA1) and/or the allocated cell identifier (e.g., NCGI1).

Similar to the previous figure, the MBSR 2210 may transmit a SIB 2245, the UE 2200 may perform random access at 2246, UE 2200 may register with AMF 2250, and UE 2200 may communicate user data. For brevity, redundant details will be omitted.

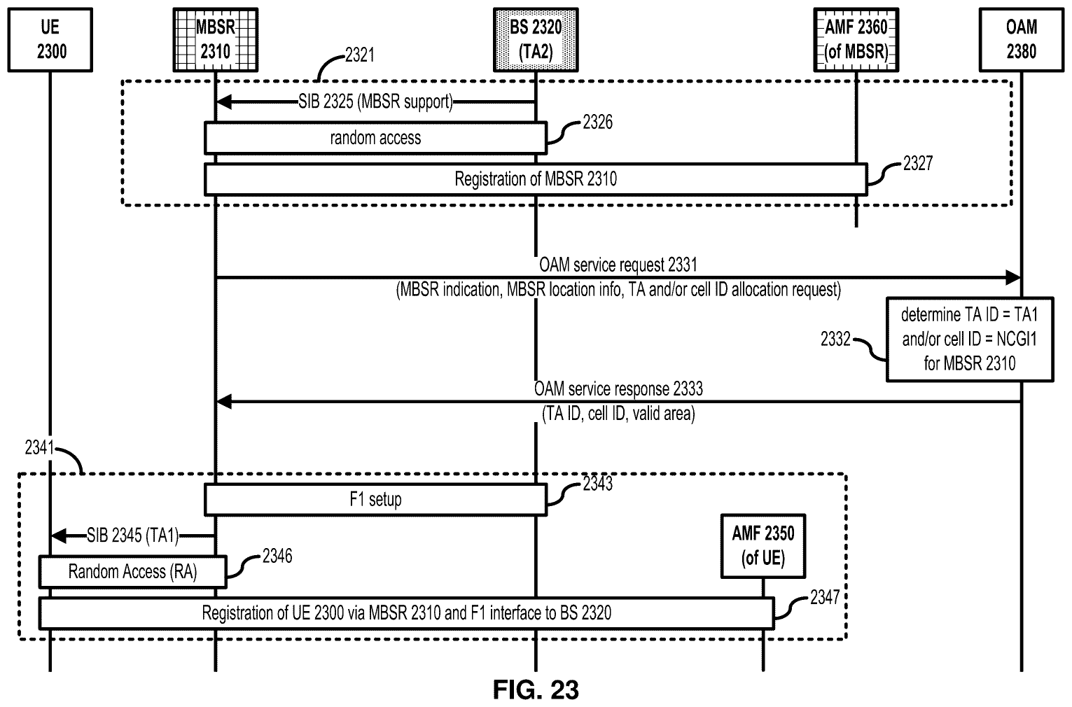

FIG. 23 illustrates an example of allocation of a tracking area identifier and/or a cell identifier in accordance with aspects of the disclosure. For illustration purposes, the figure includes a UE 2300, an MBSR 2310, a BS 2320, an AMF 2350 (serving UE 2300), and an AMF 2360 (serving MBSR 2310). These elements may be similar to the elements illustrated in previous figures; for brevity, redundant details will be omitted. The figure includes an operation and maintenance (OAM) 2380.

At 2321 in the figure, similar to the previous figure, MBSR 2310 receives a SIB 2325 from BS 2320. At 2326, MBSR 2310 performs random access. At 2327, MBSR 2310 registers with the network. For brevity, redundant details will be omitted.

In the figure, MBSR 2310 sends an OAM service request 2331 to OAM 2380. The OAM service request 2331 may comprise an MBSR indication, a TA identifier allocation request, and/or a cell identifier allocation request, identifier of the MBSR, information of location of the MBSR (e.g., current location (e.g., geographical coordinates) of the MBSR, the cell ID where the MBSR is connected to (e.g., cell ID of the BS 2320), a TA identifier where the MBSR is connected to (e.g., TA of BS 2320, e.g., TA2)), an identifier of BS 2320 (e.g., gNB identifier of BS 2320, gNB-CU identifier of BS 2320, doner-CU identifier of BS 2320, etc.).

In an example, MBSR 2310 may receive the identifier of BS 2320 via RRC message (e.g., RRC Setup, RRC reconfiguration, etc.) during 2310 (not shown in the figure). Alternatively, MBSR may receive the identifier of BS 2320 via F1 message (e.g., F1 setup response, etc.) during F1 procedure (not shown in the figure)

At 2332, OAM 2380 may determine a tracking area identifier of a tracking area of MBSR 2310 and/or a cell identifier of a cell of MBSR 2310. The OAM 2380 may determine a valid area associated with the tracking area and/or a valid area associated with the cell. In the figure, the allocated TA identifier is TA1 and the allocated cell identifier is NCGI1. The determining performed by the OAM 2380 may be based on receiving the OAM service request 2331. Additionally or alternatively, the determining performed by the OAM 2380 may be based on receiving the MBSR indication, the information of location of the MBSR, and/or the identifier of BS 2320. The determining performed by the BS 2320 in FIG. 23 may be similar to the determining described previously. For brevity, redundant details will be omitted.

In the figure, MBSR 2310 receives an OAM service response 2333 from OAM 2380. The OAM service response 2333 may comprise the allocated TA identifier (e.g., TA1) and/or the allocated cell identifier (e.g., NCGI1). The OAM service response 2333 may indicate a valid area associated with the allocated TA identifier and/or a valid area associated with the allocated cell identifier. For example, the OAM service response 2333 may indicate a list of TA identifier and/or cell identifiers per location.

Similar to the previous figures, an F1 interface is set up between MBSR 2310 and BS 2320 at 2343, the MBSR 2310 may transmit a SIB 2345, the UE 2300 may perform random access at 2346, UE 2300 may register with AMF 2350, and UE 2300 may communicate user data. For brevity, redundant details will be omitted.

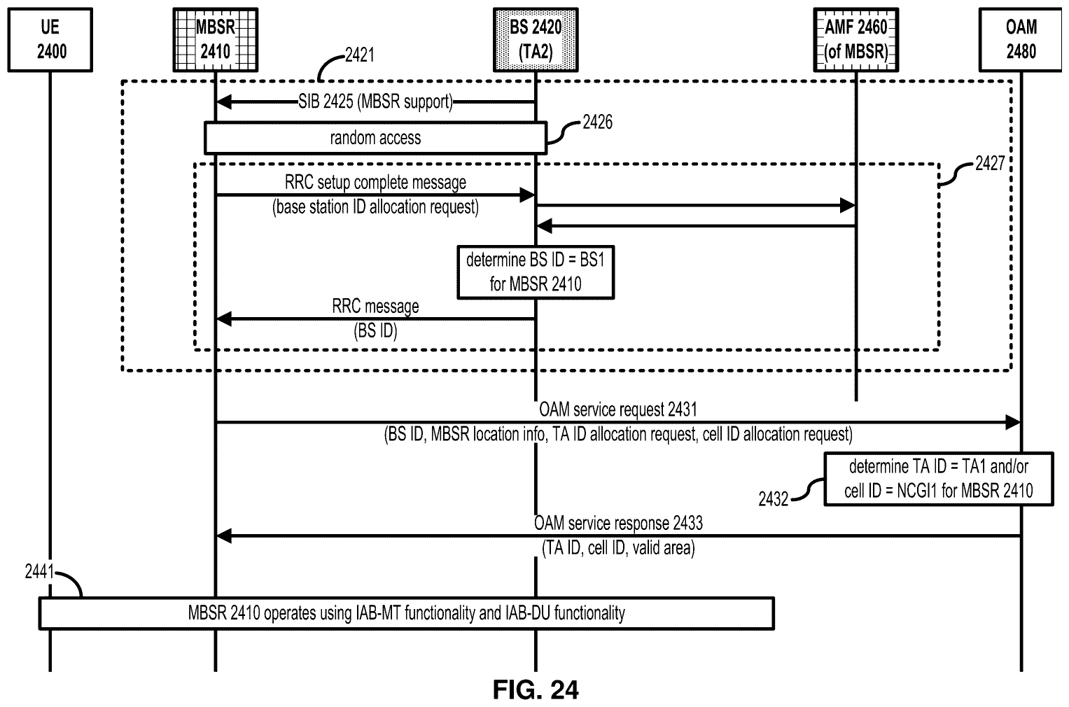

FIG. 24 illustrates an example of allocation of a tracking area identifier and/or a cell identifier in accordance with aspects of the disclosure. For illustration purposes, the figure includes a UE 2400, an MBSR 2410, a BS 2420, an AMF 2450 (serving UE 2400), an AMF 2460 (serving MBSR 2410), and an OAM 2480. These elements may be similar to the elements illustrated in previous figures; for brevity, redundant details will be omitted.

At 2421 in the figure, similar to the previous figure, MBSR 2410 receives a SIB 2425 from BS 2420. At 2426, MBSR 2410 performs random access. For brevity, redundant details will be omitted.

At 2427, MBSR 2410 registers with the network. The registration at 2427 may begin with sending, by MBS R 2410 to BS 2420, an RRC setup complete message (e.g., similar to previous figures). In the figure, the RRC setup complete message comprises a base station identifier allocation request. The base station identifier allocation request may be analogous to the TA identifier allocation request and the cell identifier allocation request, but may be for a base station identifier, rather than a TA identifier or cell identifier. It will be understood that the RRC setup complete message is one example, and other RRC message (e.g., UL information transfer, MBSR assistance Information Request, etc.) may be used.

The BS 2420 and AMF 2460 may exchange N2 messages (similar to previous figures).

The BS 2420 may determine a base station identifier for the MBSR 2410. The BS 2420 may determine a valid area associated with the base station identifier. In the figure, the allocated base station identifier is BS1. The determining may be based on receiving the RRC setup complete message comprising the base station ID allocation request. In an example, the base station identifier allocated by BS 2420 may be BS 2420's own identifier (e.g., BS1 may be the base station identifier of BS 2420). In another example, the base station identifier allocated by BS 2520 may be different from BS 2520's own identifier. The base station identifier may be, for example, a gNB ID, a gNB-CU identifier, IAB-donor identifier or any other suitable base station identifier. The base station identifier may, for example, be a component of a cell identifier.

In the figure, BS 2420 sends an RRC message to MBSR 2410 (e.g., similar to previous figures). The RRC message may comprise the allocated base station identifier (e.g., BS1).

In the figure, MBSR 2410 sends an OAM service request 2431 to OAM 2480. Similar to the previous figure, the OAM service request 2431 may comprise an MBSR indication, a TA identifier allocation request, and/or a cell identifier allocation request. The OAM service request 2431 may comprise a BS identifier (e.g., the BS identifier received from the BS 2420).

At 2432, OAM 2480 may determine a tracking area identifier of a tracking area of MBSR 2410 and/or a cell identifier of a cell of MBSR 2410. The OAM 2480 may determine a valid area associated with the tracking area and/or a valid area associated with the cell. In the figure, the allocated TA identifier is TA1 and the allocated cell identifier is NCGI1. The determining performed by the OAM 2480 may be based on receiving the OAM service request 2431. Additionally or alternatively, the determining performed by the OAM 2480 may be based on receiving the MBSR indication. Additionally or alternatively, the determining performed by the OAM 2480 may be based on the base station identifier. For example, the TA identifier and/or cell identifier may include the base station identifier. For example, the cell identifier may be different than other cell identifiers of one or more other cells associated with BS 2420. The determining performed by the OAM 2480 in FIG. 24 may be similar to the determining described previously. For brevity, redundant details will be omitted.

In the figure, MBSR 2410 receives an OAM service response 2433 from OAM 2480. The OAM service response 2433 may comprise the allocated TA identifier (e.g., TA1) and/or the allocated cell identifier (e.g., NCGI1). The OAM service response 2433 may indicate a valid area associated with the allocated TA identifier and/or a valid area associated with the allocated cell identifier. For example, the OAM service response 2433 may indicate a list of TA identifier and/or cell identifiers per location.

At 2441, similar to previous figures, MBSR 2410 operates using IAB-MT functionality and/or IAB-DU functionality. For brevity, redundant details will be omitted.

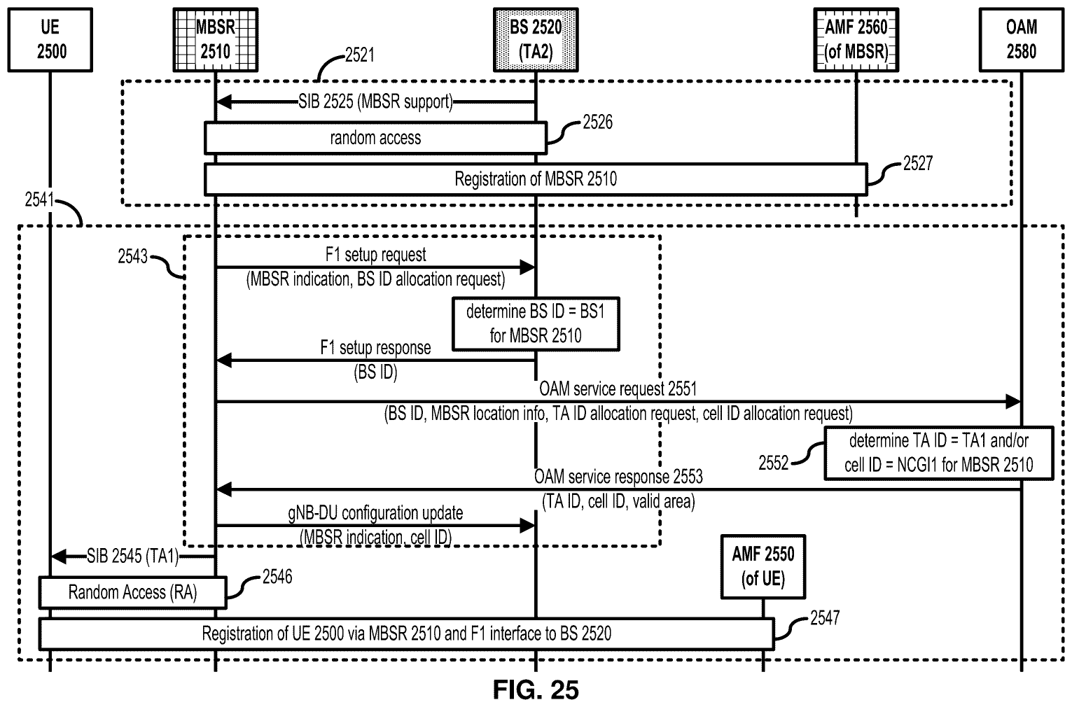

FIG. 25 illustrates an example of allocation of a tracking area identifier and/or a cell identifier in accordance with aspects of the disclosure. For illustration purposes, the figure includes a UE 2500, an MBSR 2510, a BS 2520, an AMF 2550 (serving UE 2500), an AMF 2560 (serving MBSR 2510), and an OAM 2580. These elements may be similar to the elements illustrated in previous figures; for brevity, redundant details will be omitted.

At 2521 in the figure, similar to the previous figure, MBSR 2510 receives a SIB 2525 from BS 2520. At 2526, MBSR 2510 performs random access. At 2527, MBSR 2510 registers with the network. For brevity, redundant details will be omitted.

At 2541 in the figure, similar to the previous figure, MBSR 2510 may operate using IAB-MT functionality and/or IAB-DU functionality.

At 2543, an F1 interface is set up between MBSR 2510 and BS 2520. As discussed previously, the F1 interface may be via a Uu interface and/or one or more wireless backhaul links. For example, MBSR 2510 sends an F1 setup request message to BS 2520 and MBSR 2510 receives an F1 setup response message from the MBSR 2510. For brevity, redundant details will be omitted.

In the figure, the F1 setup request message may comprise a base station identifier allocation request. The BS 2520 may determine a base station identifier for the MBSR 2510. The BS 2520 may determine a valid area associated with the base station identifier. The determining may be based on receiving the F1 setup request message comprising the base station identifier allocation request. In the figure, the allocated base station identifier is BS1. In an example, the base station identifier allocated by BS 2520 may be BS 2520's own identifier (e.g., BS1 may be the base station identifier of BS 2520). In another example, the base station identifier allocated by BS 2520 may be different from BS 2520's own identifier. The base station identifier may be, for example, a gNB ID, a gNB-CU identifier, or any other suitable base station identifier. The base station identifier may, for example, be a component of a cell identifier. The F1 setup response message may comprise the allocated base station identifier (e.g., BS1).

In the figure, MBSR 2510 sends an OAM service request 2551 to OAM 2580. The sending of the OAM service request 2551 may be based on MBSR 2510 determining the BS ID and/or receiving the F1 setup response message. Similar to the previous figure, the OAM service request 2551 may comprise an MBSR indication, a TA identifier allocation request, and/or a cell identifier allocation request. The OAM service request 2551 may comprise a BS identifier (e.g., the BS identifier received from the BS 2520).

At 2552, OAM 2580 may determine a tracking area identifier of a tracking area of MBSR 2510 and/or a cell identifier of a cell of MBSR 2510. The OAM 2580 may determine a valid area associated with the tracking area and/or a valid area associated with the cell. In the figure, the allocated TA identifier is TA1 and the allocated cell identifier is NCGI. The determining performed by the OAM 2580 may be based on receiving the OAM service request 2551. Additionally or alternatively, the determining performed by the OAM 2580 may be based on receiving the MBSR indication. Additionally or alternatively, the determining performed by the OAM 2580 may be based on the base station identifier. For example, the TA identifier and/or cell identifier may include the base station identifier. For example, the cell identifier may be different than other cell identifiers of one or more other cells associated with BS 2520. The determining performed by the OAM 2580 in FIG. 25 may be similar to the determining described previously. For brevity, redundant details will be omitted.

In the figure, MBSR 2510 receives an OAM service response 2553 from OAM 2580. The OAM service response 2553 may comprise the allocated TA identifier (e.g., TA1) and/or the allocated cell identifier (e.g., NCGH1). The OAM service response 2553 may indicate a valid area associated with the allocated TA identifier and/or a valid area associated with the allocated cell identifier. For example, the OAM service response 2553 may indicate a list of TA identifier and/or cell identifiers per location.

In the figure, MBSR 2510 sends the allocated TA identifier (e.g., TA1) and/or the allocated cell identifier (e.g., NCGI) to BS 2520. The allocated TA identifier and/or the allocated cell identifier may be sent in a gNB-DU configuration update. The gNB-DU configuration update may comprise an MBSR indication.

Similar to the previous figures, the MBSR 2510 may transmit a SIB 2545, the UE 2500 may perform random access at 2546, UE 2500 may register with AMF 2550, and UE 2500 may communicate user data. For brevity, redundant details will be omitted.

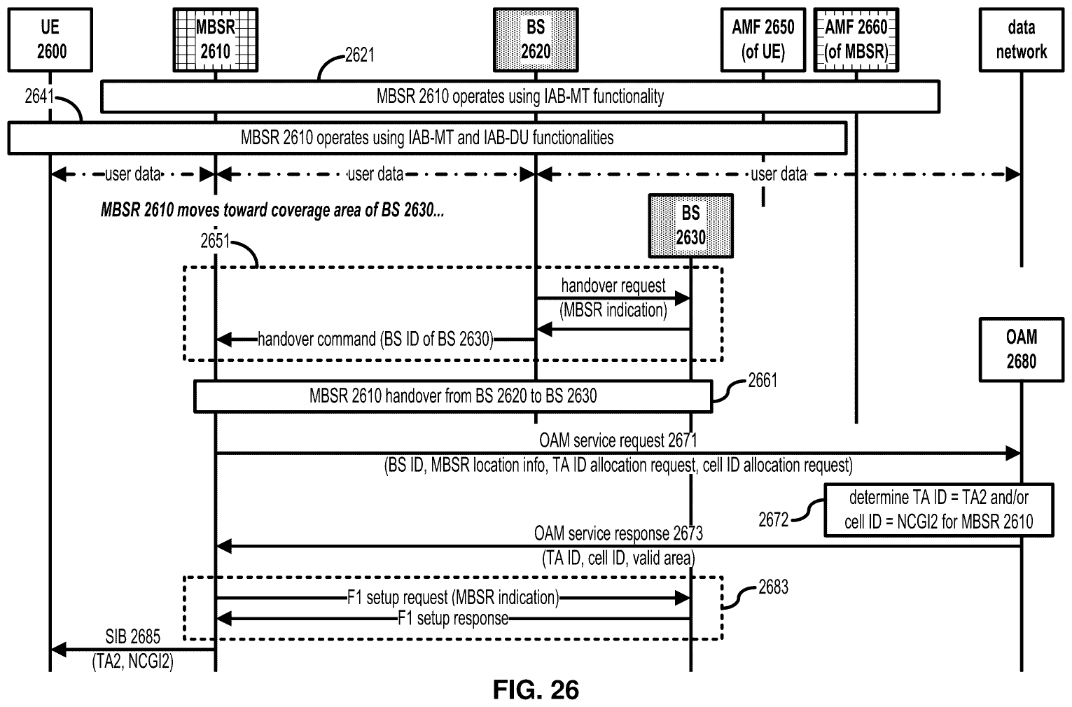

FIG. 26 illustrates an example of allocation and/or reallocation of a tracking area identifier and/or a cell identifier, in the context of MBSR handover, in accordance with aspects of the disclosure. For illustration purposes, the figure includes a UE 2600, an MBSR 2610, a BS 2620, an AMF 2650 (serving UE 2600), an AMF 2660 (serving MBS R 2610), and an OAM 2680. These elements may be similar to the elements illustrated in previous figures; for brevity, redundant details will be omitted. The figure illustrates another base station, BS 2630.

At 2621 in the figure, similar to the previous figure, MBSR 2610 receives a SIB 2625 from BS 2620. At 2626, MBSR 2610 performs random access. At 2641, similar to previous figures, MBSR 2610 operates using IAB-MT functionality and/or IAB-DU functionality. For brevity, redundant details will be omitted.

In the figure, MBSR 2610 moves toward a coverage area of BS 2630.

At 2651, BS 2620 determines handover of MBSR 2610. For example, BS 2620 may receive a measurement report from MBSR 2610 indicating a signal strength of BS 2630 (not illustrated). For example, based on one or more measurement results in the measurement report, BS 2620 may determine to request handover of MBSR 2610 to BS 2630 (not illustrated).

The BS 2620 may send a handover request to BS 2630. The handover request may comprise an MBSR indication and/or any other information suitable to a handover request. The BS 2620 may receive a handover message from BS 2630 (e.g., handover acknowledge, handover accept, etc.). The BS 2630 may send the handover message based on receiving the handover request and/or any other suitable information available to BS 2630. The BS 2620 may send a handover command to MBSR 2610. The handover command may comprise a base station identifier of BS 2630.

At 2661, the MBSR 2610 may hand over from BS 2620 to BS 2630. The handing over by MBSR 2610 may be based on receiving the handover command.

The MBSR 2610 may send an OAM service request 2671 to OAM 2680, the OAM 2680 may determine a tracking area identifier of a tracking area of MBSR 2610 and/or a cell identifier of a cell of MBSR 2610, and the MBSR 2610 may receive an OAM service response 2673 from OAM 2680. The OAM service request 2671, determining at 2672, and OAM service request 2673 may be analogous to, for example, similar behavior described previously (e.g., 2431 to 2433 and/or 2531 to 2533). For brevity, redundant details will be omitted.

At 2683, an F1 interface is set up between MBSR 2610 and BS 2630. As discussed previously, the F1 interface may be via a Uu interface and/or one or more wireless backhaul links. In the figure, MBSR 2610 sends an F1 setup request message to BS 2630. The F1 setup request message may comprise an MBSR indication. In the figure, MBSR 2610 receives an F1 setup response message from BS 2630. The F1 setup request message and F1 setup response message may be analogous to, for example, similar messages described previously (e.g., during F1 interface setup at 2243). For brevity, redundant details will be omitted.

In the figure, the OAM service request 2671 and response 2673 and the F1 interface setup at 2683 occur after the handover at 2661. In an example, one or more of the messages associated with 2671, 2673, 2683 may be sent or received prior to the handover at 2661.

Similar to the previous figures, the MBSR 2610 may transmit a SIB 2685, the UE 2600 may perform random access, UE 2600 may register with AMF 2650, and UE 2600 may communicate user data. For brevity, redundant details will be omitted.

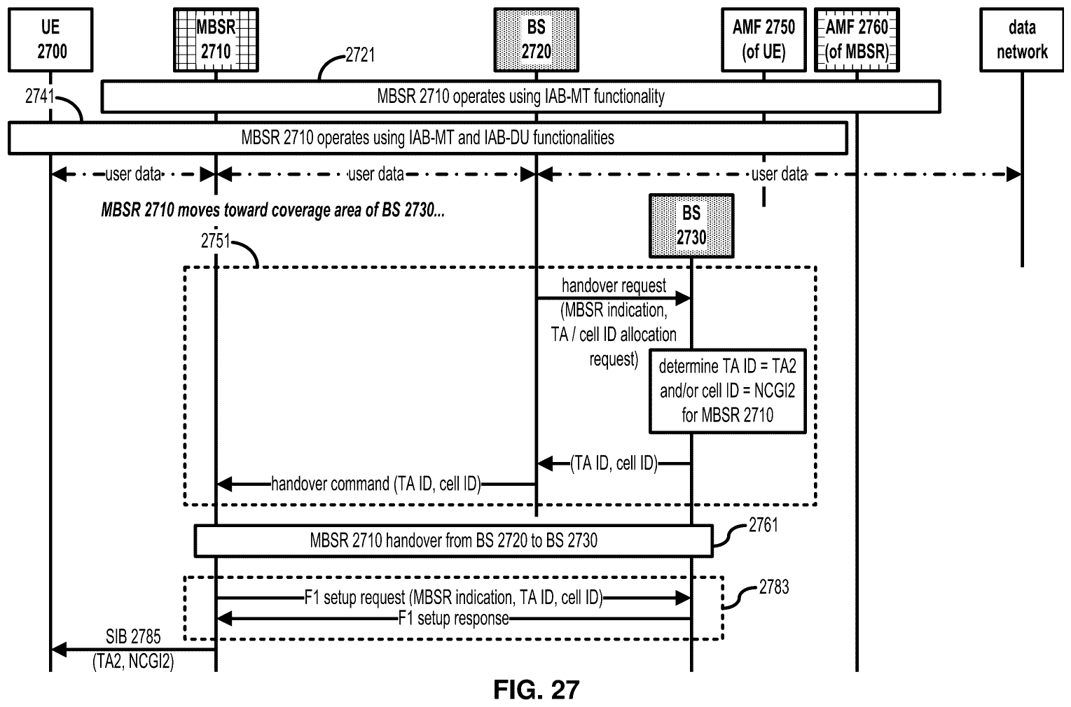

FIG. 27 illustrates an example of allocation and/or reallocation of a tracking area identifier and/or a cell identifier, in the context of MBSR handover, in accordance with aspects of the disclosure. For illustration purposes, the figure includes a UE 2700, an MBSR 2710, a BS 2720, a BS 2730, an AMF 2750 (serving UE 2700), and an AMF 2760 (serving MBSR 2710). These elements may be similar to the elements illustrated in previous figures; for brevity, redundant details will be omitted.

At 2721 in the figure, similar to the previous figure, MBSR 2710 receives a SIB 2725 from BS 2720. At 2726, MBSR 2710 performs random access. At 2741, similar to previous figures, MBSR 2710 operates using IAB-MT functionality and/or IAB-DU functionality. For brevity, redundant details will be omitted.

In the figure, MBSR 2710 moves toward a coverage area of BS 2730.

At 2751, BS 2720 determines handover of MBSR 2710. For example, BS 2720 may receive a measurement report from MBSR 2710 indicating a signal strength of BS 2730 (not illustrated). For example, based on one or more measurement results in the measurement report, BS 2720 may determine to request handover of MBSR 2710 to BS 2730 (not illustrated).

The BS 2720 may send a handover request to BS 2730. The handover request may comprise an MBSR indication and/or any other information suitable to a handover request. The handover request may comprise a TA identifier allocation request and/or a cell identifier allocation request. The BS 2730 may determine a TA ID and/or a cell ID. The determining may be similar to the determining described previously (e.g., similar to the determining by BS 1930 in FIG. 19). For brevity, redundant details will be omitted.

The BS 2720 may receive a handover message from BS 2730 (e.g., handover acknowledge, handover accept, etc.). The BS 2730 may send the handover message based on receiving the handover request and/or any other suitable information available to BS 2730. The handover message may comprise the TA ID and/or cell ID. The BS 2720 may send a handover command to MBSR 2710. The handover command may comprise the TA ID and/or cell ID.

At 2761, the MBSR 2710 may hand over from BS 2720 to BS 2730. The handing over by MBSR 2710 may be based on receiving the handover command.

At 2783, an F1 interface is set up between MBSR 2710 and BS 2730. As discussed previously, the F1 interface may be via a Uu interface and/or one or more wireless backhaul links. In the figure, MBSR 2710 sends an F1 setup request message to BS 2730. The F1 setup request message may comprise an MBSR indication. The F1 setup request message may comprise the TA identifier and/or the cell identifier. In the figure, MBSR 2710 receives an F1 setup response message from BS 2730. The F1 setup request message and F1 setup response message may be analogous to, for example, similar messages described previously (e.g., during F1 interface setup at 2243). For brevity, redundant details will be omitted.

In the figure, the F1 interface setup at 2783 occurs after the handover at 2761. In an example, one or more of the messages associated with 2783 may be sent or received prior to the handover at 2761. In the figure, BS 2720 sends TA/Cell ID allocation request to BS 2730. In an example, MBSR 2710 may send TA/Cell ID allocation request to BS 2730, BS2730 may send allocated TA identifier and/or allocated Cell ID to MBSR 2710. For example, example shown in FIG. 22 may be used.

Similar to the previous figures, the MBSR 2210 may transmit a SIB 2265, the UE 2200 may perform random access at 2246, UE 2200 may register with AMF 2250, and UE 2200 may communicate user data. For brevity, redundant details will be omitted.

In the previous figures, a MBSR may be configured with TA allocation mode or may receive from a network, the TA allocation mode. The TA allocation mode may indicate whether dynamically allocated TA identifier (e.g., dynamic allocation mode) is used for the MBSR, whether statically allocated (e.g., fixed, fixed allocation mode) TA identifier is used for the MBSR, whether TA identifier used by the MBSR changes, whether change of TA identifier is allowed, whether sending TA identifier allocation request is allowed, or whether the MBSR needs to send TA identifier allocation request for MBSR operation. If the MBSR is configured with indication that dynamically allocated TA identifier is used, that TA identifier used by the MBSR changes, that the MBSR needs to send TA identifier allocation request, or if the MBSR does not have any allocated TA identifier, the MBSR may send the TA identifier allocation request. Otherwise (e.g., if the MBSR is configured with indication that dynamically allocated TA identifier is not used, that statically allocated TA identifier is used, that TA identifier used by the MBSR does not change, or that the MBSR need not to send TA identifier allocation request, etc.), the MBSR may not send the TA identifier allocation request.

For example, a MBSR may be configured with Cell identifier allocation mode or may receive from a network, the Cell identifier allocation mode. The Cell identifier allocation mode may indicate whether dynamically allocated Cell identifier (e.g., dynamic allocation mode) is used for the MBSR, whether statically allocated (e.g., fixed, fixed allocation mode) Cell identifier is used for the MBSR, whether Cell identifier used by the MBSR changes, whether the MBSR needs to send Cell identifier allocation request for MBSR operation. If the MBSR is configured with indication that dynamically allocated Cell identifier is used, that Cell identifier used by the MBSR changes, that the MBSR needs to send Cell identifier allocation request, or if the MBSR does not have any allocated Cell identifier, the MB SR may send the Cell identifier allocation request. Otherwise (e.g., if the MBSR is configured with indication that dynamically allocated Cell identifier is not used, that statically allocated Cell identifier is used, that Cell identifier used by the MB SR does not change, or that the MBSR need not to send Cell identifier allocation request, etc.), the MBSR may not send the Cell identifier allocation request.

Depending on deployment scenario of a network operator, and/or depending on a number of UEs using a MBSR, different TA identifier allocation mode may be configured. In one example, for a MBSR (e.g., mounted on a train) serving many UEs, change of TA identifier used by the MBSR may cause the many UEs to perform registration update procedure, leading heavy signaling between the many UEs and an AMF via the MBSR. For this MBSR (e.g., mounted on a train), allocating a fixed TA identifier and/or not changing the TA identifier may help. In other example, for a MBSR (e.g., mounted on a taxi) serving a small number of UEs and/or for a MBSR used temporarily (e.g., a commuter vehicle), change of TA identifier used by the MBSR may marginally increase overall signaling in the network. Or, if the number of MBSRs are more than the number of TA identifiers that the network manages, allocating fixed TA identifiers for this temporary MBSR may bring shortage of TA identifiers. In this case, it may be beneficial for the MBSR to be allocated with a TA identifier when it operates as a MBSR. By configuring the MBSR with TA identifier allocation mode and/or cell identifier allocation mode, different deployment scenarios may be supported.

For example, the base station, the AMF, the UDM, the OAM may indicate to the MBSR whether it supports dynamic TA identifier allocation, static TA identifier allocation, change of TA allocated to a MBSR, dynamic cell identifier allocation, static cell identifier allocation, change of cell identifier. If the MBSR receives indication of support for dynamic TA identifier allocation, change of TA allocated to a MBSR, dynamic cell identifier allocation, or change of cell identifier allocated to a MBSR, the MBSR may send the TA identifier allocation request and/or the Cell identifier allocation request.

What is claimed is:

1. A method comprising:
sending, by a wireless device to a first base station (BS), a message indicating that the wireless device is a mobile integrated and backhaul node (mIAB), wherein the wireless device comprises:
mobile terminal unit; and
a BS distributed unit;
receiving, from the first BS, a radio resource control message comprising an identifier of a second BS;
sending, to an operations administration and management (OAM), a first message comprising an identifier of a cell associated with the identifier of the second BS;
receiving, from the OAM and based on mobility of the wireless device to the second BS, a second message comprising a second TAC associated with a location of the wireless device; and
based on the second message:
sending, to the second BS, an F1 setup message comprising the second TAC; and
sending, to the second wireless device, a SIB comprising the second TAC.

2. The method of claim 1, wherein the mobile terminal unit is configured to receive, from the first BS via a first Uu interface, a first system information block (SIB) indicating support for the mIAB.

3. The method of claim 1, wherein the BS distributed unit is configured to broadcast, to a second wireless device via a second Uu interface, a second SIB indicating a mIAB cell and a first tracking area code (TAC).

4. The method of claim 1, wherein the second message comprises one or more third TACs and one or more location information for which each third TAC of the one or more third TACs are valid.

5. The method of claim 4, further comprising determining, by the wireless device, and based on the one or more location information and current location of the wireless device, a third TAC, of the one or more third TACs, valid at the current location.

6. The method of claim 5, further comprising sending, by the wireless device to the second wireless device, a third SIB comprising the third TAC.

7. The method of claim 1, wherein the wireless device sends the message to the OAM, in response to mobility of the wireless device from the first BS to the second BS.

8. A wireless device comprising one or more processors and memory storing instructions that, when executed by the one or more processors, cause the wireless device at least to perform:
sending, to a first base station (BS), a message indicating that the wireless device is a mobile integrated and backhaul node (mIAB), wherein the wireless device comprises:
mobile terminal unit; and
a BS distributed unit;
receiving, from the first BS, a radio resource control message comprising an identifier of a second BS;
sending, to an operations administration and management (OAM), a first message comprising an identifier of a cell associated with the identifier of the second BS;
receiving, from the OAM and based on mobility of the wireless device to the second BS, a second message comprising a second TAC associated with a location of the wireless device; and
based on the second message:
sending, to the second BS, an F1 setup message comprising the second TAC; and
sending, to the second wireless device, a SIB comprising the second TAC.

9. The wireless device of claim 8, wherein the mobile terminal unit is configured to receive, from the first BS via a first Uu interface, a first system information block (SIB) indicating support for the mIAB.

10. The wireless device of claim 8, wherein the BS distributed unit is configured to broadcast, to a second wireless device via a second Uu interface, a second SIB indicating a mIAB cell and a first tracking area code (TAC).

11. The wireless device of claim 8, wherein the second message comprises one or more third TACs and one or more location information for which each third TAC of the one or more third TACs are valid.

12. The wireless device of claim 11, wherein the instructions further cause the wireless device at least to perform determining, based on the one or more location information and current location of the wireless device, a third TAC, of the one or more third TACs, valid at the current location.

13. The wireless device of claim 12, wherein the instructions further cause the wireless device at least to perform sending, to the second wireless device, a third SIB comprising the third TAC.

14. The wireless device of claim 8, wherein the wireless device is configured to send the message to the OAM, in response to mobility of the wireless device from the first BS to the second BS.

15. A non-transitory computer-readable medium comprising instructions that, when executed by one or more processors of a wireless device, cause the wireless device to perform:
sending, to a first base station (BS), a message indicating that the wireless device is a mobile integrated and backhaul node (mIAB), wherein the wireless device comprises:
mobile terminal unit; and
a BS distributed unit;
receiving, from the first BS, a radio resource control message comprising an identifier of a second BS;
sending, to an operations administration and management (OAM), a first message comprising an identifier of a cell associated with the identifier of the second BS;
receiving, from the OAM and based on mobility of the wireless device to the second BS, a second message comprising a second TAC associated with a location of the wireless device; and
based on the second message:
sending, to the second BS, an F1 setup message comprising the second TAC; and
sending, to the second wireless device, a SIB comprising the second TAC.

16. The non-transitory computer-readable medium of claim 15, wherein the second message comprises one or more third TACs and one or more location information for which each third TAC of the one or more third TACs are valid.

17. The non-transitory computer-readable medium of claim 16, wherein the instructions further cause the wireless device to perform determining, by the wireless device, and based on the one or more location information and current location of the wireless device, a third TAC, of the one or more third TACs, valid at the current location.

18. The non-transitory computer-readable medium of claim 17, wherein the instructions further cause the wireless device to perform sending, by the wireless device to the second wireless device, a third SIB comprising the third TAC.

19. The non-transitory computer-readable medium of claim 15, wherein the instructions further cause the wireless device to perform the sending the message to the OAM, in response to mobility of the wireless device from the first BS to the second BS.

20. The non-transitory computer-readable medium of claim 15, wherein
the mobile terminal unit is configured to receive, from the first BS via a first Uu interface, a first system information block (SIB) indicating support for the mIAB; and
the BS distributed unit is configured to broadcast, to a second wireless device via a second Uu interface, a second SIB indicating a mIAB cell and a first tracking area code (TAC).
